(19) United States
(12) Patent Application Publication
(10) Pub. No.: US 2016/0269440 A1
(43) Pub. Date: Sep. 15, 2016

(54) SYSTEM AND METHOD FOR MANAGING EMAIL AND EMAIL SECURITY

(71) Applicant: Robert HARTMAN, Villanova, PA (US)

(72) Inventor: Robert HARTMAN, Villanova, PA (US)

(21) Appl. No.: 15/165,000

(22) Filed: May 26, 2016

Related U.S. Application Data
(63) Continuation of application No. 11/217,460, filed on Sep. 2, 2005, now abandoned.

(51) Int. Cl. H04L 29/06; H04L 9/30; H04L 9/32; H04L 9/14; H04L 12/58; H04L 29/08

(52) U.S. Cl. CPC H04L 63/1483; H04L 51/12; H04L 51/22; H04L 51/30; H04L 67/02; H04L 67/28; H04L 67/42; H04L 63/06; H04L 63/0823; H04L 63/0428; H04L 63/10; H04L 9/3263; H04L 9/14; H04L 9/30

(57) ABSTRACT

A recipient-centric gateway sits at the corporate network perimeter, retaining all outgoing e-mail, organizing the e-mail by recipient so that senders or other designated individuals can view the retained mail from the perspective of the recipient. A login retry limit is based on password strength. A system that guarantees the sender that the recipient is not phished with e-mail fraudulently purported to be from the sender's domain. A system that, without communicating certificates or publishing certificates to third parties and without requiring any workflow changes, enables the transparent two way sending of secure e-mail. A system that, based on feedback and usage, optimizes mailbox responsiveness across the network.

### FIELD OF THE INVENTION

The present invention relates generally to retention and management of e-mail, password management, anti-fraud and security provisions for e-mail, and mailbox management.

### BACKGROUND OF THE INVENTION

An e-mail system consists of at least one SMTP server that services one or more mail clients at company (A) and at least one SMTP server that services one or more mail clients at company (B). Each mail client may have a digital certificate, the digital certificate holding both a public and private key. After a certificate exchange, the sender may use the recipient's public key to encrypt mail for the recipient, and may use the sender's private key to sign e-mail that can be verified by the recipient as having come from the sender. The SMTP server communicates with a mail store that retains incoming mail until it is picked up by the mail client, and for some protocols (IMAP4, Exchange, etc.), continues to keep the mail so that other mail clients installed elsewhere may retrieve the mail. The mail client pushes outbound mail to the local SMTP server and the mail client pulls inbound mail at intervals from the local mail store. The SMTP server accepts inbound mail from other SMTP servers, the local SMTP server pushes outbound mail to other SMTP servers.

In order to mitigate the acceptance of fraudulent (i.e. “phished”) mail, a certificate that provides a public decrypting key for the sender's organization is stored at the DNS, with the private encrypting key residing at the sender's mail servers. At the outbound server, a hash of the message is computed and is encrypted with the private key and is appended to the message. Where the recipient mail server has been set up to utilize the checking procedure, the recipient server uses the public key published at the DNS to decrypt the hash and validate it against the computed hash of the received message. The message is rejected if there is no match.

Incoming mail can be stored in a single group mailbox accessible to subscribed recipients [2002/0087646]. Sender and recipient can share a mailbox brackets and require permission from each other to perform mailbox functions [U.S. Pat. No. 6,769,012]. Automatic synchronized revision of sent documents can be based on subscription to a workgroup maintained at the server using the workgroup list [U.S. Pat. No. 6,662,212]. Systems synchronize message revisions in mailbox automatically [U.S. Pat. No. 6,662,212]. Senders can cc mail to others within their group to make the others aware of what is communicated to the recipient.

Appending of sequential numbers to data for the purpose of the recipient checking that all data has been received, the data retained for the purpose of resending in the event that the recipient requests unreceived data is described [2005/0114461 paragraph 89].

For authentication, a smart card that presents its client certificate after unlocking it through entry of a PIN can be used. A RSA SecurID that generates a number that, in combination with a user selected PIN, authenticates the user can be used. A strong password with or without a retry lockout (after a certain number of retries, a password reset is required) can be used. A weak password with or without a retry lockout can be used.

A system that reinforces the password in the memory of the user by offering a hint when a retry limit is exceeded is described [2005/0114679 paragraph 0037]

A fast method of booting a computer where specifying an incorrect password causes a retry to occur, failing after a limited number of retries is described [2005/0044348 paragraph 0071]

A system of transmitting notifications to remote users or devices associated with those users, whereby the system forces the client or device to re-send authentication information at constant or variable intervals is described [2005/0230661 paragraph 0063].

An authentication system that includes a feature whereby when a timeout occurs, a user is requested to re-enter the authentication parameters is described [2005/0204610 paragraph 0038]

A BHO (browser helper object) can sit in the browser process and communicate with a server that stores the URIs of known illegitimate emulation sites, the BHO subsequently blocking the browser from accessing the illegitimate site.

A monitoring of the communications protocol stack or message handler to retrieve and execute one or more separate actions embedded in an e-mail message, the e-mail message neither modified in transit by the method nor producing a different direct result at the e-mail client is described [U.S. Pat. No. 6,151,623 col. 6 line 46 through col. 7 line 2].

A POP3 server that sits between the mail client and the mail store and indicates to the mail client that no new mail exists for an intermediate time period, checking with the mail store subsequent to that period, and that at low network traffic periods obtains a copy of the e-mail message, subsequently instructing the mail store via the POP3 protocol to delete the message, it having been retrieved by the mail client from the added POP3 server is described [2005/0138196 paragraphs 15 and 92].

A proxy server sits between the e-mail client and the mail server, accepting and caching all outbound mail and determining the schedule to send the cached mail to the mail server based on size of the mail message is described [2005/0086306 paragraph 17].

A mail client plug-in that processes messages placed in the outbox and disallows the sending of the message based on a rule set is described [2004/0177271 paragraph 29].

A system whereby as a result of a trigger message from an anti-virus service provider or other source, the file system is placed into a mode where files normally accessible become inaccessible is described [2003/0023866 paragraph 46].

To support secure mail, a gateway system holds mail and sends a substitution message with a URI which points to a secure mailbox login. Another method is to use two gateways, one at the corporate boundary of the sender and one at corporate boundary of the recipient, both gateways using the S/MIME or PGP protocols. Another method is to use an add-on control installed on the individual mail client that decrypts encrypted mail and displays it in a POP3 mailbox, and with the press of a send button encrypts mail. This method typically uses digital certificates or a proprietary method that is used in combination with an encrypting/decrypting gateway at the sender's corporate boundary. Another method is for the sender and recipient to agree on a password and the sender encrypts the document using an encryption product and sends it to the recipient who uses the same product to decrypt the message (i.e. Microsoft Word, winzip, etc.). Another method is to use the TLS over SMTP enabled at both the sender and recipient mail servers.

It is possible to generate a digital ID from a user ID and location, store it in a table with a word, and provide the word to the sender for inclusion in subsequent messages [U.S. Pat. No. 6,615,348]. Another method is to use a PGP server that dynamically issues certificates, mail plug-ins or software clients to local users [2004/133774]. Another method is where encrypted messages with a digital signature are sent to a server where the encrypted message is decrypted and virus scanned, and the server repackages the message and sends the message to the client. The receiving client uses an “overlay” program that interacts with the existing e-mail client and enables it to receive messages [2002/0007453].

Another method is to use a two party dedicated system pair that eliminates encrypted e-mail that is unsuitable for sending/receiving. Keys are stored on a directory server and the system looks them up before encrypting and sending the message along or gets them for validating signatures. The server associates an encryption key with a particular machine rather than an e-mail address, and sends the message to the connected machine. A server gets an encrypted e-mail message, the message is decrypted, the signature is extracted, the server verifies the signature through a verification server and the e-mail message is subsequently verified. [2002/0169954].

A remote control of a recipient computer via an agent that proxies network instructions, the agent authorized to perform network functions on the receiving computer, the agent extracts these instructions from monitored mail messages. Monitoring agents not communicating with a local mail server may retrieve embedded instructions in mail messages directly from the sending mail server [2002/0002581]. A system is described that stores agents for subsequent restart on interruption, or so that an optimal execution on one of a plurality of agent systems can be initiated [U.S. Pat. No. 6,334,139]. A messaging server that must emulate the messaging server for the protocol in use, as a proxy, routes local IM messages to users behind the firewall [2003/0131061]. A mail server is described that sends mail to the client machine with only a part of the message and the recipient at the terminal can request the rest of the message or delete it [2003/0187941]. A linking of two or more digital certificates that relate to each other together by forming a digital verification certificate with evidence that the certificates are related, and then signs the certificate is described [2003/0149872].

A system is described where a client machine with a digital certificate (or a password and user ID) authenticates into a network, obtains a list of allowed applications for the user and generates a cookie, the cookie subsequently used to map the request to a server with an allowed application [U.S. Pat. No. 6,510,464].

A proxy obtains the body of the message from the mail store on demand and inserts a link into the message pointing to the attachment, which is separately downloaded and stored locally is described [2004/0204610]

A system that forwards message headers for messages through Exchange servers to a central database to perform message flow analytics is described [2004/0059789]. A system is described where interpreted code, placed in a web browser with frames, reloads at specific intervals, to determine whether access-controlled content security is enforced [U.S. Pat. No. 6,151,599]. An invention that proxies requests through multiple back-end servers using a content-request-to-server translation table (catalog) with the advantage over direct linking that content can be moved without invalidating the user cache, thus eliminating the subsequent increase in bandwidth requirement for static content for previous visitors is described. [U.S. Pat. No. 6,823,391]. A system that examines data exiting the server either as proxy or on a machine running site, and insures validity using digital signatures for the purpose of validating that the data is in its original form is described [U.S. Pat. No. 6,804,778]. A proxy pair used to transform and untransform data, with discovery as to what role each proxy plays is described. The proxy communicates data with another proxy that would be incompatible with the protocol, so the proxy eliminates that data back to the client. Both proxies may be combined into one device [2004/0243703]. A system that performs a backup of data according to line speed and buffer size [2003/0131068] is described. A system that updates and reports on systems running on ftp servers [2004/0249919] is described. A system that reuses independent transaction processors in client applications without reprogramming for the purpose of executing global database transactions is described [U.S. Pat. No. 5,586,312].

A system is described where, through interaction with a website, a user causes a thread to be created, either at a server or on a local machine, with the results to be reported upon at a later time [U.S. Pat. No. 5,877,759]. A system is described where a mail server separates the message body from the attachment, and stores the attachment and sends the body to the recipient only with an indication that the attachment exists. The attachment may be automatically deleted after a time [U.S. Pat. No. 6,505,236]. A system is described that keeps messages at an intermediate server possibly because of size, sending a reference to the message to the recipient instead. Optionally the system can scan the object pointed to by the reference to determine whether it will be made available to the recipient (i.e. virus or content scan) [2003/0260775].

A drawback is that there is no mechanism whereby the sender can obtain a view of recipient mail from the recipient perspective as sent by all senders at the domain. In other words, in the event that a disgruntled customer calls with a complaint driven at least in part by e-mail communication with the company, there is no known direct mechanism whereby the supervisor with limited authorization handling the complaint can immediately review the e-mail correspondence from the customer perspective to determine why it is that the customer is irate. A typical example that might motivate such a customer response would be where subordinate customer service personnel indicated via e-mail that “they have known about that problem for a year”. Although under certain circumstances it may be possible to search for that specific term in a database provided by an archiving solution, or even to authenticate into an archiving database to search for the recipient's address within an e-mail message (or for all messages to the recipient), these are unwieldy solutions to this problem, typically providing too much authorization to the individual performing the search, and requiring processes that must be manually repeated for every incident, and for every recipient.

Another drawback is that existing authentication systems unnecessarily expend resources in administration of password resets. In other words, given that there is a high cost associated with manually resetting a password, and given that longer passwords incur more password resets, and given that shorter passwords are typically more prone to hacking, it is not cost effective to set the password retry limit identically regardless of password strength.

Another drawback is that a sender cannot guarantee that a recipient is not phished with e-mail purported to be sent from the sender. Under existing systems, the recipient may receive e-mail attributed to a sender but not actually from the sender, and the sender has no control over whether this is occurring among recipients. In other words, a recipient can determine whether a signed message is valid by performing a procedure of checking the signature and deleting or ignoring unsigned or invalidly signed messages from the sender, but a sender cannot guarantee that the recipient is executing that procedure and is not receiving fraudulent messages. Although a sending entity may sign its mail, it is not reasonable for the sender to believe that all recipients receiving signed mail from the sender will, for every e-mail, always determine that the sender's signature exists (and is valid), thus the sender cannot in fact know that recipients are not receiving phished e-mail attributed to the sender.

Another drawback is that for secure e-mail systems changing workflow is undesirable, as it requires retraining users. It is a drawback if a custom plug-in must be developed for each mail client and mail client version, and maintained as such. It is a drawback to require users to exchange passwords. It is a drawback if the secure mail system cannot display secure mail in the normal mail client at multiple recipient computers from one account, regardless of the mail client receiving protocol. For many recipients, it is a drawback to use client-side certificates, as they must be renewed. Another drawback is where the certificate must first be obtained from the intended recipient, as it requires the recipient to provide the certificate to the intended sender. Another drawback is where the certificate must be obtained from a third party directory, because the directory cannot always be trusted to have valid data. Another drawback is where a gateway must be installed at the recipient's corporate network, as it is often unreasonable for the sender to require the recipient to install a gateway on the recipient's network, and it precludes sending to a general plurality of recipients because not all recipient networks will have such a gateway.

Another drawback is that the mailbox response is not optimized for users. In other words, the mailbox is typically stored is where it is first created and any subsequent moving process does not consider the responsiveness of the mailbox to the user and the physical location where the mailbox would be best suited given the overall resources of the mailbox system.

### SUMMARY OF THE INVENTION

The first object of the invention is to provide a recipient-centric view of one or more recipients' mailboxes, to authorized sender(s) (and possibly other recipients), so that correspondence can be viewed from the recipient perspective.

The second object of the invention is to allow the use of simplistic passwords without substantially degrading system security.

The third object of the invention is to provide for message retrieval only when the mail is guaranteed to have come from the sender's domain, and not for other mail purportedly sent from the sender's domain.

The fourth object of the invention is to provide for bi-directional, secure e-mail to and from the recipient's existing client mailbox where the recipient communicates securely with a plurality of senders and where a single mailbox view at one or more recipient systems is provided and where none of the following are needed: workflow changes, the use of digital certificates, ongoing user entry of passwords, third party public key publishing or an encrypting/decrypting gateway at the recipient's network boundary.

The fifth object of the invention is to automatically optimize mailbox responsiveness from the end-user perspective.

The sixth objective of the invention is to provide a recipient-centric view so that correspondence can be viewed from the recipient perspective while maximizing responsiveness of the system.

The seventh objective of the invention is to lower password reset costs while providing a recipient-centric view so that correspondence can be viewed from the recipient perspective while maximizing the responsiveness of the system.

The eighth objective of the invention is to guarantee senders that recipients are not receiving phished mail from the sending domain, to provide a recipient-centric view so that correspondence can be viewed from the recipient perspective, to increase the responsiveness of the system, and to lower password reset costs.

The ninth objective of the invention is to provide recipients secure e-mail to the existing inbox without requiring the use of digital certificates or third party publication of certificates or keys or the ongoing use of passwords or recipient workflow changes, and to provide a recipient-centric view so that correspondence can be viewed from the recipient perspective, and to increase the responsiveness of the system, and to lower the incidence of password resets.

The first object is achieved by the provision of a recipient-centric gateway that retains copies of all outgoing mail messages and organizes them by recipient.

The recipient-centric gateway may be used with an installer that obtains the administrative and encryption passwords.

The recipient-centric gateway may be used with an assignment capability that can assign administrative capability to users.

The recipient-centric gateway may be used with an enabler capability, where an administrator can enable sender or recipient accounts.

The recipient-centric gateway may be used with an assignment capability that allows the assignment of a user ID to the sender or recipient, in lieu of e-mail address.

The recipient-centric gateway may be used with an assignment capability that allows adding a new sender or recipient.

The recipient-centric gateway may be used with an assignment capability that allows the password to be assigned by the sender or recipient.

The recipient-centric gateway may be used with a user capability of the user's own assignment of the password.

The recipient-centric gateway may be used with an administrator assignment capability that allows the assignment of users into one or more groups.

The recipient-centric gateway may be used with an administrative assignment to a group, the ability to access a recipient-centric mailbox.

The recipient-centric gateway may be used with group member access to multiple recipient-centric mailboxes, where the current account defaults to the login account at login.

The recipient-centric gateway may be used with a process of sending a message to a group member, to indicate that one or more new messages are available in a recipient account, the message indicating a procedure for acquiring the message.

The recipient-centric gateway may be used with a process of sending the message conventionally signed.

The recipient-centric gateway may be used with a downloadable BHO that analyzes the HTML of the login message, determining whether the reference points to an authentic server reference, disallowing the reference if inauthentic, and clearing the cache at end of the transaction.

The recipient-centric gateway may be used with a process of sending a login message to group member(s), to indicate that new messages of interest are available in subscribed recipient accounts, based on template.

The recipient-centric gateway may be used with a process of sending login messages to group member(s), to indicate that new messages of interest are available in subscribed recipient accounts based on matching fixed strings.

The recipient-centric gateway may be used with a process of sending of login messages to group member(s), to indicate that new messages of interest are available in subscribed recipient accounts based on an externally programmed analysis.

The recipient-centric gateway may be used with a process whereby a group member may access a message, even though it was deleted by the recipient.

The recipient-centric gateway may be used with a process whereby the sender can edit a message if not yet read by the recipient.

The recipient-centric gateway may be used with a process whereby the recipient can reply to a message through the recipient-centric gateway.

The recipient-centric gateway may be used with a process whereby the recipient can send a message to a third party via the recipient-centric gateway.

The recipient-centric gateway may operate with a plurality of recipient-centric message gateways, where one recipient-centric message gateway performs a lookup into a master directory to determine where messages for a particular recipient reside, authenticates into that recipient-centric message gateway, and provides messages to that recipient-centric message gateway for storage.

The recipient-centric gateway may be a master recipient-centric message gateway, wherein information is retained and is available as to which server stores the messages for any particular recipient.

The recipient-centric gateway may be used to produce a unified presentation to the recipient and/or sender where part of a multiple recipient-centric gateway network.

The recipient-centric gateway may be used on existing mail server hardware.

The recipient-centric gateway may be used where the mail message database is that of the existing mail server.

The recipient-centric gateway may be used as a proxy, where outgoing mail is routed from the mail clients to the recipient-centric gateway that then routes mail to the mail server.

The recipient-centric gateway may be used as an IMAP4 or Exchange protocol provider, where recipient messages and folders are provided to group member(s) through IMAP4, Exchange or other similar protocol.

The recipient-centric gateway may be used as an Application Service Provider solution, where only the mail forwarding options on the corporate mail system serviced by the recipient-centric message gateway are changed, where authentication parameters are required to connect to the recipient-centric message gateway, and where SMTP over TLS is optionally used as the mail transfer protocol to the recipient-centric message gateway.

The second object is achieved by the provision of a method of determining the retry count based on the strength of the password.

The retry count based on password strength may be used as part of a lockout process.

The retry count based on password strength may be used as part of a system that establishes a password by the recipient.

The third object is achieved by the provision of an anti-phish proxy that sits between the recipient's mail client and the mail server and guarantees the sender that a recipient is not phished with the sender's e-mail address. The proxy is embedded and downloaded with the recipient account name and/or GUID and password and sender's domain, where a trigger message causes the proxy to retrieve new messages from the sending server, and which discards any other message claimed to be from the sender's domain.

The anti-phish proxy may be used with a specially constructed trigger message.

The anti-phish proxy may be used with a system of displaying new message headers within an existing mailbox for protocols where the message is retained at the mail store.

The anti-phish proxy may be used with a system of presenting a single mailbox view to the mail client by combining messages with existing mailbox messages for protocols where messages are retained at the mail store.

The anti-phish proxy may be used with a firewall traversing protocol.

The anti-phish proxy may be used with a system where access to additional sending servers is added and managed subsequent to the initial download and proxy installation.

The anti-phish proxy may adopt a timeout period when messages aren't available and may then establish a queue for later retrieval.

The anti-phish capability may be compiled into the code of an existing mail client, so that mail sent from certain domains other than mail signed by the actual sender is rejected, and so that the existing mail client can maintain a list of sending systems that interoperate with the anti-phish capability.

The anti-phish proxy may be used with a gateway that retains messages and provides them to the authenticated, retrieving anti-phish proxy. The gateway obtains the record of which recipient downloaded the proxy and accordingly sends the trigger message instead of the actual message.

The anti-phish proxy may delete any message purportedly from the sender but not signed by the sender.

The anti-phish proxy at the recipient may interoperate with the gateway at the corporate sender.

The anti-phish proxy system may be used with a recipient-centric gateway.

The anti-phish proxy system with a recipient-centric gateway may use a specially constructed trigger message.

The fourth object is achieved by the provision of a secure e-mail proxy that is downloaded with the recipient's account name and/or GUID and password used to authenticate into sending server, where a trigger message causes the secure e-mail proxy to attempt to retrieve new messages from the sending system via a secure protocol and where the secure e-mail proxy sits between the recipient's mail client and the recipient's mail server.

The secure e-mail proxy may be downloaded with a GUID and a key pair, where a trigger message causes the secure e-mail proxy to attempt to retrieve new messages from the sending server.

The secure e-mail proxy may be used with a specially constructed trigger message.

The secure e-mail proxy may enable the mail client to display new message headers within an existing mailbox for protocols where the message is retained at the mail store.

The secure e-mail proxy may combine secure messages into an existing mailbox for various protocols.

The secure e-mail proxy may retrieve mail using a firewall traversing protocol.

The secure e-mail proxy may manage and access additional sending servers as they are added, even if they are added subsequent to the initial download and secure e-mail proxy installation.

The secure e-mail proxy may be used with a timeout when one or more messages aren't available and may establish a queue for later retrieval.

The secure e-mail proxy may be used with a gateway that retains messages for the account where the secure e-mail proxy has been downloaded, sending a trigger message instead, and using a secure protocol makes available the original message to the secure e-mail proxy when authenticated.

The secure e-mail proxy may be used with a gateway that retains messages for the account where a tag is provided in the e-mail, sending a trigger message instead, and using a secure protocol makes available the original message to the secure e-mail proxy when authenticated, and via the trigger message through the existing mail client may display the web login where the secure e-mail proxy may be downloaded.

The secure e-mail proxy may be used with a gateway that retains messages for the account where a matching template is found in the e-mail or attachment(s), sending a trigger message instead, and using a secure protocol makes available the original message to the secure e-mail proxy when authenticated, and via the trigger message through the existing mail client may display the web login where the secure e-mail proxy may be downloaded.

The secure e-mail proxy may be used with a gateway that retains messages for the account where matching fixed strings are found in the e-mail or attachment(s), sending a trigger message instead, and using a secure protocol makes available the original message to the secure e-mail proxy when authenticated, and via the trigger message through the existing mail client may display the web login where the secure e-mail proxy may be downloaded.

The secure e-mail proxy may be used with a gateway that retains messages for the account where external custom programmed analysis that operates on the message and attachment(s) indicates that the message should be sent securely, sending a trigger message instead, and using a secure protocol makes available the original message to the secure e-mail proxy when authenticated, and via the trigger message through the existing mail client, may display the web login where the secure e-mail proxy may be downloaded.

The secure e-mail proxy may provide messages to a gateway that accepts messages from an authenticated secure e-mail proxy.

The secure e-mail proxy may send outgoing messages to the domain serviced by the gateway directly to the gateway, authenticating to the gateway to provide messages using a secure protocol.

The secure e-mail proxy may provide messages to a secure e-mail gateway where the messages are encrypted with an encrypting key, and where the gateway decrypts the messages with the corresponding decrypting key.

The secure e-mail proxy may be used with an interface to the secure e-mail proxy that enables the recipient to see which messages were transmitted securely.

The secure e-mail proxy may send outgoing messages to the domain serviced by the gateway directly to the gateway, where messages are encrypted through the use of an encrypting key for this gateway, provided with the secure e-mail proxy download.

The secure e-mail proxy system may be used with a gateway that provides directory services to indicate whether a particular recipient has downloaded the secure e-mail proxy.

The secure e-mail proxy system may be used with gateway components separated to two different networks for the purpose of maximizing the available resources of the existing mail server infrastructure.

A trigger proxy may sit at the mail server and examine all outbound requests, and may direct to the mail server those outbound transactions that do not require the trigger message, and may direct to the gateway those outbound transactions that do require the trigger message

The secure e-mail proxy may be downloaded with recipient account name, key pair, and sender's domain, which combines incoming messages into an existing mailbox and decrypts any message sent from the sending domain, and which encrypts any message sent to the sending domain, where the message is constructed to show a link if obtained not using the proxy.

The secure e-mail proxy may be used with a gateway that accepts inbound mail as encrypted and sent by the proxy and that decrypts messages before passing them to the local mail server for local delivery.

The secure e-mail proxy may be used with the recipient-centric gateway.

The secure e-mail proxy may be used with a specially constructed trigger message designed for use with both the secure e-mail proxy with the recipient-centric gateway.

The secure e-mail proxy may combine secure and mail store messages to show a single mailbox view across multiple machines, despite installation on different machines at different times.

A gateway may support the secure e-mail proxy that can combine secure and mail store messages to show a single mailbox view across multiple machines.

Another embodiment of a secure e-mail proxy may combine secure and mail store messages to show a single mailbox view across multiple machines, despite installation on different machines at different times and that can receive secure messages.

Another embodiment of a gateway may support a secure e-mail proxy that can combine secure and mail store messages to show a single mailbox view across multiple machines.

A gateway may support a secure e-mail proxy that can combine secure and mail store messages to show a single mailbox view across multiple machines, despite installation on different machines at different times and that can receive secure messages, and the gateway may receive secure messages via SMTP and pass them to the local mail server for delivery.

The fifth object is achieved by the provision of a mailbox response profile definition where the mailbox profile is defined based on client pull usage, i.e. duration for every timed paged pull with storage for the page size and time and day of week.

The mailbox response profile definition may be used with an existing mail system.

The mailbox response profile may be populated through timing the differential between repeated successive page requests to obtain the duration to pull the first page from the requested server, or from a remote server.

The mailbox response profile may be populated through an interpreted program on a page used to obtain the duration to pull the page from the requested server, or from a remote server.

The mailbox response profile may be populated using a browser helper object (BHO) to obtain the duration to pull the page from the requested server, or from a remote server.

The mailbox response profile may be populated using client pull timing.

The mailbox response profile may be populated using a timing-proxy that pulls data down using typical protocols (HTTP/S, IMAP4, POP3, etc.) and feeds back response information for a server that is currently used by the proxy to transfer information, or from a remote server.

The mailbox response profile may be populated using a proxy pull method.

The mailbox response profile may be used with an average resource profile per message store server, where the average profile resource usage (CPU usage, connection resources, etc.) of the server at the time of access to this mailbox is stored (resources in use) by time of day and date and optionally client IP address and/or service provider.

The mailbox response profile may be used with a process that determines multiple average resource profiles.

The fifth object of the invention is also achieved by the provisioning of a server that authenticates into a master directory server to indicate its presence as part of the network and to indicate the mailboxes for which it is responsible.

The server may be used with a master directory server that authenticates a server and adds its address to the list of computers in the network.

The server may be used with a process that initiates and presents an ‘ask’, i.e. a request from other servers to bid on a mailbox based on responsiveness, to a master directory.

The server may be used with a master directory server as it operates on the ‘ask’ queue, connecting to available servers to provide the ‘ask’ information, accepting the ‘bids’ from the servers, and supplying the best ‘bid’ from available servers and the agreed-upon time to execute the mailbox move.

The server may be equipped with a process whereby a determination is made as to whether to initiate an ‘ask’ process, the ‘ask’ process for the purpose of initiating a possible mailbox move.

The server may be equipped with a process whereby a determination is made as to whether to bid on accepting the mailbox, based on usage, time of day profiling, relative response time, client service provider, or availability of other servers.

The server may be equipped with a process that communicates a ‘bid’ to a master directory.

The server may be equipped with a process that accepts a ‘bid’ and initiates the subsequent mailbox moving procedure.

The fifth objective is also achieved by forwarding requests from a front-end server directly to a back-end server where the mailbox is stored, and where the front-end server obtains the authentication and passes credentials to the back-end server.

The server may be equipped with a process whereby a mailbox is retained after it is determined that the response is better on the new mailbox. The newer mailbox provides messages to the redundant mailbox.

The server may be equipped with a process where the mailbox is retained on the server where the mailbox is originally located until it is determined that the response is better on the new mailbox, the original mailbox subsequently deleted.

The server may be equipped with an archiver that can backup up the mailboxes present in the mailbox move system and where redundant mailboxes can be removed at the instruction of the archiver.

The front-end server may be equipped with a process whereby another server detects the availability of the front-end server, and if the primary server is not online redirects the request to a redundant mailbox.

The front-end server may be equipped with a DNS switcher for a downed front-end server.

The server may be equipped with a process whereby a determination is made that the mailbox usage is very low, and the ‘ask’ is for a ‘bid’ from a server with lesser resources but more disk space.

The sixth objective is achieved by combining the recipient-centric mailbox system with the mailbox move system.

The seventh objective is achieved by combining the recipient-centric mailbox system with the mailbox move system, and retry system based on password strength.

The eighth objective is achieved by combining the anti-phish proxy, mailbox move system, and retry system based on password strength.

The eighth objective is further achieved by combining a recipient-centric mailbox system with the anti-phish system, mailbox move system, and retry system based on password strength.

The ninth objective is achieved by combining the recipient-centric mailbox system with the secure e-mail proxy, mailbox move system, and retry system based on password strength.

The ninth objective is further achieved by combining a recipient-centric mailbox system with the secure e-mail system and two mailbox move systems, and the retry system based on password strength.

The invention describes a method of presenting received e-mail messages of a recipient for viewing by at least one user other than the recipient by providing a gateway in communication with a mail server and mail client that each service one or more senders of e-mails, by making and storing a copy of at least one outgoing e-mail message to a recipient that is derived from one or more senders on the gateway, and by authorizing one or more users to view the copy of the at least one outgoing e-mail message (i.e. the “recipient-centric gateway”). The method enables a user to access the gateway and to view all copies of all outgoing e-mail messages sent to the recipient regardless of the sender. The method allows a plurality of users to be authorized to view copies of outgoing e-mail messages. The method specifies that an alert can be provided to a user that the recipient has received a new message. The method provides that the alert may be digitally signed and also provides that the user can employ a browser helper object to verify that the alert is authentic. The method provides that the content of the outgoing e-mail message may be compared to a template, or compared to a fixed string, or analyzed using a program, any of these for the purposes of determining whether the alert should be sent. The method provides that the user can still view the message copy although the recipient has deleted a copy of a received outgoing e-mail message. The method provides that the sender may delete or alter an outgoing unread e-mail message. The method provides that a recipient may contact the sender of an outgoing message or a third party via the gateway and a mail server. The method provides for a plurality of gateways and a master directory of recipient addresses, each recipient linked to one of the plurality of gateways, where the method, using the master directory, determines on which gateway an outgoing e-mail message for a given recipient should be stored. The method provides for the use of the gateway as a proxy that services a number of user mail clients, outgoing e-mail messages being forwarded to the gateway proxy from the mail clients prior to being sent using the mail server. The method provides that the gateway service a number of user mail clients, outgoing e-mail messages from the user mail clients passing through a mail server and then to the gateway to the recipient, the gateway allowing the copy of the outgoing e-mail message to be viewed by the user mail clients. The method provides that wherein the outgoing e-mail message originates from a mail server, the gateway may be linked to that mail server via the internet.

The invention describes a system that presents a recipient's mailbox for viewing by a user other than the recipient comprising a gateway in communication with a mail server and mail client, each servicing one or more senders of e-mails, the gateway adapted to make and store a copy of an outgoing e-mail message sent by a sender to a recipient on the gateway, the gateway authorizing one or more users to view the copy of the outgoing e-mail message.

Besides the basic functionality described for the system for the recipient-centric gateway, each system can also function to achieve the various secondary, alternative or subordinate steps of its described methodology.

The invention also describes a method of improving security relating to entry of passwords to gain access to an account, comprising the steps of providing a table of passwords, providing a password strength algorithm, determining the strength of a password using either the table of passwords or the password strength algorithm, and assigning a retry count for an entered password based on the password strength (i.e. the “retries based on strength”). The retry count governs the number of times password entry can be attempted before the user is locked out of the account. The method provides for the receiving of a login password input by a user to access an account, each receipt of the login password establishing a count, where the method compares the login password or a hash thereof to either a stored password or a hash thereof or a stored blank password or a′hash thereof. Access to the account is allowed if the login password or the login password hash matches the stored password or the stored password hash. If the login password or hash thereof do not match the stored password or the stored password hash, the user is locked out when the number of counts exceeds the retry count, or if the login password matches the stored blank password or hash thereof allows the user to create a password for access to the account, or if the stored password is blank or is a hash thereof allows the user to create a login password for access to the account.

Besides the basic functionality described for the system for the “retries based on strength”, each system can also function to achieve the various secondary, alternative or subordinate steps of its described methodology.

The invention also describes a method of preventing an e-mail recipient from being phished with an e-mail message by providing an anti-phishing proxy that communicates with a recipient's mail client, providing at least one server on a network having a domain name where the server is capable of sending a trigger e-mail and a trigger related e-mail message, receiving an e-mail message at the anti-phishing proxy, using the anti-phishing proxy to check to determine whether the e-mail message is a trigger e-mail and if the e-mail message is a trigger e-mail, performing an authentication using the at least one server, and deleting the trigger e-mail and passing the trigger-related e-mail message to the recipient (i.e. the “anti-phishing proxy”). If the e-mail message is not a trigger e-mail and does not contain the domain name, the e-mail message is passed to the recipient. If the e-mail message is not a trigger e-mail and contains the domain name, the message is deleted. The method also provides that the trigger e-mail include a link to allow the recipient to obtain the anti-phishing proxy for the checking steps. The method also describes a process wherein e-mail messages received that are not trigger messages and not containing the domain name are grouped with e-mail containing the domain name for viewing together. The method also provides that the anti-phishing proxy is adapted to check e-mail messages from the plurality of servers. The method also provides that where a gateway on the server is provided, the gateway checks e-mail messages being sent from the server to determine if an e-mail message is destined for a recipient having the anti-phishing proxy, where the gateway either passes the e-mail message to recipients without the anti-phishing proxy, or stores the e-mail message and creates a trigger related message, and allows access by the recipient to the e-mail message upon authentication of the recipient's anti-phishing proxy. The method also provides that the anti-phishing proxy delete any e-mail messages that do not contain a validated signature where those email message contain the domain name. The method also provides that the gateway receives outgoing e-mails, the gateway adapted to make and store a copy of the outgoing e-mail messages sent by a sender to a recipient, the gateway authorizing one or more users to view the copy of the outgoing e-mail message.

The invention also describes a system for preventing an e-mail recipient from being phished where an anti-phishing proxy is disposed between a mail client and a mail server, the anti-phishing proxy is adapted to check incoming e-mail messages for a domain name and a trigger message from a server for the domain name, the anti-phishing proxy either accepting the e-mail if the domain name or trigger message is not present, or deleting the e-mail if the domain name is present without the trigger message, or performing an authentication and passing the trigger-related e-mail message to the recipient if the domain name is present.

In an alternative embodiment, the anti-phishing functionality can be obtained using an existing mail client and adding to or modifying its code rather than through the proxy that sits ahead of the mail client. In this mode, the existing mail client, after obtaining a message, would check to determine if the domain name in question is associated with the incoming e-mail. If so, the mail client would then check to see if the e-mail has a digital signature, and if so, use a decrypting key obtained from the sender to check the validity of the signature. If the signature is valid, the e-mail message can be made available for viewing.

Besides the basic functionality described for the system for the “anti-phishing proxy”, each system can also function to achieve the various secondary, alternative or subordinate steps of its described methodology.

The invention also describes a method of sending a secure e-mail to a recipient comprising the steps of providing a secure e-mail proxy ahead of a recipient's mail client, providing at least one server on a network where the server is capable of sending a trigger e-mail and a trigger-related e-mail message, receiving an e-mail message at the secure e-mail proxy, and using the secure e-mail proxy checking to determine whether the e-mail message is a trigger e-mail from the server (i.e. the “secure e-mail proxy”). If the e-mail message is a trigger e-mail, an authentication is performed using the at least one server, the trigger e-mail is deleted and the trigger related e-mail message is passed to the recipient using either a secure protocol or encryption. If the e-mail message is not a trigger e-mail, the e-mail message is passed to the recipient. The method also provides that the trigger e-mail includes a link to allow the recipient to obtain the secure e-mail proxy for the checking step. The method also provides that e-mail messages received that are not trigger messages are grouped with trigger-related e-mail. The method also specifies that wherein a plurality of servers are provided, the secure e-mail proxy is adapted to check e-mail messages from the plurality of servers. The method also specifies that wherein a gateway on the server is provided, the gateway checks e-mail messages being sent from the server to determine if an e-mail message has a predetermined condition, and the gateway passes the e-mail message to recipients if the predetermined condition is not met, or stores the e-mail message and creates the trigger related message if the predetermined condition is met, and allows access by the recipient to the e-mail message upon authentication of the recipient's secure e-mail proxy. The above predetermined condition may be that an e-mail message is for a recipient that has the secure e-mail proxy, that an e-mail message has a tag associated with it, that the content of the e-mail message matches a template, that the content of the e-mail message matches a fixed string, and/or that the content of the e-mail message meets criteria established by a programmed analysis. The method also describes that where a gateway associated with the secure e-mail proxy is provided, the gateway permits a recipient to send a reply e-mail to the sender of the e-mail message in a secure manner. The method also provides that the secure e-mail proxy authenticates to the gateway servicing the secure e-mail proxy prior to sending the reply. The method also provides that the secure e-mail proxy encrypts the reply e-mail, and the gateway determines that the reply e-mail is from a recipient assigned a secure e-mail proxy and uses a decrypting key associated with the assigned secure e-mail proxy to read the reply e-mail. The method also provides that e-mail messages securely received by the recipient and/or securely sent by the recipient are displayed to the recipient and/or sender. The method also provides that the recipient sends a reply e-mail to a sender of the e-mail message, and the secure e-mail proxy, after determining that the sender is part of the service providing the secure e-mail proxy, encrypts the reply e-mail, and the gateway decrypts the reply e-mail based on a decrypting key of the secure e-mail proxy of the recipient. The method also provides that the server comprises a mail server and a virtual server, the virtual server determining if the e-mail message should be either sent by the gateway or sent by the mail server. The method also provides that a trigger proxy is provided for a server, and the trigger proxy determines if the e-mail message should be either sent to the gateway or sent to the mail server. The method also provides that the gateway receives outgoing e-mails, the gateway is adapted to make and store a copy of the outgoing e-mail messages sent by a sender to a recipient, and the gateway authorizes one or more users to view the copy of the outgoing e-mail message. The method also provides for a maintaining of the same view of e-mail messages from each of the installed secure e-mail proxies, despite installation of a number of secure e-mail proxies at different locations. The method also provides for examining a record of the checking of e-mail messages and sending an encrypted trigger related e-mail message with the trigger e-mail based on the record examining step.

The invention also describes a system for sending secure e-mails to a recipient comprising a secure e-mail proxy disposed between a mail client and a mail server, the secure e-mail proxy adapted to check incoming e-mail messages for a trigger e-mail from a server, the secure e-mail proxy either accepting the e-mail message if the trigger e-mail is not present, or if the trigger e-mail is present, obtaining a trigger-related e-mail message from the server upon authentication.

In an alternative embodiment, the trigger proxy functionality can be obtained by rerouting e-mail to the trigger proxy, where the trigger proxy determines from another server whether any of the following parameters have changed: the tag(s), the external engine(s) for scanning, the template(s), or the fixed string(s), and re-loads those parameters that have changed. Outgoing messages are then routed to either a gateway or to a mail server, which may reside on the same hardware as the trigger proxy, the routing dependent upon the analysis of each outgoing e-mail message, the aforementioned parameters relevant to the analysis.

Besides the basic functionality described for the system for the “secure e-mail proxy”, each system can also function to achieve the various secondary, alternative or subordinate steps of its described methodology.

The invention also describes a method of managing mailbox locations on a plurality of mailbox servers on a network, each mailbox server containing at least one mailbox, the method comprising the steps of determining a mailbox response profile for each mailbox where the response profile contains data related to the mailbox that indicates a responsiveness of a mailbox from a mailbox user perspective, determining an average resource profile for each mailbox server where the average resource profile contains data related to the mailbox server and indicates the resource utilization of the mailbox server, identifying a candidate mailbox and server for moving a mailbox based on a level of the mailbox response profile and average resource profile, comparing the mailbox response profile and average resource profile of a candidate mailbox and server with the mailbox response profile and average resource profile of at least one other mailbox and server to determine if the other mailbox and server is best suited to receive the content of the candidate mailbox and transferring the content of the candidate mailbox to a recipient mailbox and server based on the comparing step (i.e. the “mailbox move management system”). The invention also describes a method wherein the candidate mailbox and server is compared to a threshold for the mailbox response and average resource profiles as part of the identifying step to determine whether to proceed with the comparing step. The invention also describes a method wherein the comparing step further comprises receiving bids to accept the candidate mailbox from one or more of the mailboxes and servers, and accepts one bid for the transferring step based on the comparing step. The method also describes the step of retaining the content of the candidate mailbox on the candidate mailbox to provide a redundant source of the content. The method also describes the determination as to whether the recipient mailbox should be transferred back to the candidate mailbox, based upon a comparison of the mailbox response profile and average resource profile of the candidate mailbox and its server and the mailbox response profile and average resource profiles of the one other mailbox. This comparison occurs after the mailbox is transferred. The method also provides that the identifying step is based on a candidate mailbox having overloaded resources or underutilized resources.

The invention also describes a system for moving mailboxes based on mailbox responsiveness and server resource utilization comprising a plurality of mailboxes, each mailbox located on a mail server, one or more databases for storing mailbox response profiles and server average resource profiles for each mailbox and mail server, where each server is adapted to seek a bidder for a mailbox or to bid on a mailbox and where the seeking or bidding is based on the mailbox response profiles and server average resource profile of the server, and where the contents of a mailbox is transferred to another server or is accepted from another server. The system can further comprise a recipient-centric system for presenting a recipient's mailbox for viewing by a user other than the recipient, the recipient-centric system comprising a gateway in communication with a mail server and mail client, each servicing one or more senders of e-mails, the gateway adapted to make and store a copy of an outgoing e-mail message sent by a sender to a recipient on the gateway, the gateway authorizing one or more users to view the copy of the outgoing e-mail message. The system can further comprise an anti-phishing proxy disposed between a mail client and a mail server, the anti-phishing proxy adapted to check incoming e-mail messages for a domain name and a trigger message from a server for the domain name, the anti-phishing proxy either accepting the e-mail if the domain name or trigger message is not present, or deleting the e-mail if the domain name is present without the trigger message, or performing an authentication and passing the trigger-related e-mail message to the recipient if the domain name is present. The system can further comprise a secure e-mail proxy disposed between a mail client and a mail server, the secure e-mail proxy adapted to check incoming e-mail messages for a trigger e-mail from a server, the secure e-mail proxy either accepting the e-mail message if the trigger e-mail is not present, or if the trigger e-mail is present, obtaining a trigger-related e-mail message from the server upon authentication.

Besides the basic functionality described for the system for the “mailbox move management system”, each system can also function to achieve the various secondary, alternative or subordinate steps of its described methodology.

### BRIEF DESCRIPTION OF THE DRAWINGS

The objects, features and advantages of the present invention will be apparent from the following description taken in conjunction with the accompanying drawings, in which:

FIG. 1 is a flow diagram of a gateway that retains copies of all outgoing mail messages and organizes them by recipient.

FIG. 2 is a flow diagram of general installation and authentication initialization for the recipient-centric message gateway system of FIG. 1.

FIG. 3 is a flow diagram of the process of assigning administrative capability to users, the assignment performed by an administrator.

FIG. 4 is a flow diagram of the process of enabling sender or recipient accounts, this action performed by an administrator.

FIG. 5 is a flow diagram of the process that assigns a user ID to the sender or recipient, in lieu of e-mail address, this process performed by an administrator.

FIG. 6 is a flow diagram of the process of adding a new sender or recipient by the administrator.

FIG. 7 is a flow diagram of the process of password assignment for the sender or recipient by an administrator.

FIG. 8 is a flow diagram of the process of password assignment for the sender or recipient by the sender or recipient.

FIG. 9 is a flow diagram of the establishment by an administrator of a group, certain recipient-centric mailboxes subsequently readable by a sender (or recipient) with access to the group.

FIG. 10 is a flow diagram of the process of assigning to a group the ability to access a recipient-centric mailbox.

FIG. 11 is a flow diagram of the process of access to multiple recipient-centric mailboxes as presented to a group member, where the current account defaults to the login account.

FIG. 12 is a flow diagram of sending a login message to a group member, to indicate that one or more new messages are available in a recipient account.

FIG. 13 is a flow diagram where the login message is sent in a conventionally signed manner.

FIG. 14 is a flow diagram of a downloadable BHO that analyzes the HTML of the login message, determining whether the reference points to an authentic recipient-centric server reference, removing inauthentic references, and clearing the cache upon process exit.

FIG. 15 is a flow diagram showing the sending of login messages to group member(s), to indicate that new messages of interest are available in subscribed recipient accounts, based on template.

FIG. 16 is a flow diagram showing the sending of login messages to group member(s), to indicate that new messages of interest are available in subscribed recipient accounts based on an exact match.

FIG. 17 is a flow diagram showing the sending of login messages to group member(s), to indicate that new messages of interest are available in subscribed recipient accounts based on an externally programmed analysis.

FIG. 18 is a flow diagram where a message is deleted by a recipient, but is nevertheless made available to the group member or administrator.

FIG. 19 is a flow diagram where a message can be edited by the sender if not yet read by the recipient.

FIG. 20 is a flow diagram where the recipient can reply to the sender through the recipient-centric gateway.

FIG. 21 is a flow diagram where the recipient can send a message to a third party through the recipient-centric gateway.

FIG. 22 is a flow diagram showing one of a plurality of recipient-centric message gateways, where the recipient-centric message gateway performs a lookup into the master directory to determine where messages for a particular recipient reside, authenticates into that recipient-centric message gateway, and provides the message to that recipient-centric message gateway for storage.

FIG. 23 is a flow diagram of the directory lookup component at a master recipient-centric message gateway, wherein information is available as to which server stores the messages for any particular recipient.

FIG. 24 is a general diagram where a unified presentation to the recipient and/or sender is provided in a multiple recipient-centric gateway environment.

FIG. 25 is a block diagram of the recipient-centric message gateway operating on existing mail server hardware.

FIG. 26 is a block diagram of the recipient-centric message gateway using an existing server, providing that the existing mail server can be configured to retain all outgoing mail in its own database.

FIG. 27 is a block diagram of a recipient-centric message proxy, where outgoing mail is routed via mail clients through the recipient-centric proxy that then routes mail to the corporate mail server.

FIG. 28 is a block diagram of the recipient-centric gateway where recipient messages and folders are provided to group member(s) through IMAP4, Exchange or other similar protocol.

FIG. 29 is a block diagram of the recipient recipient-centric message gateway as an Application Service Provider solution, where only the mail forwarding options on the corporate mail system serviced by the recipient-centric message gateway are changed, where authentication parameters are required to connect to the recipient-centric message gateway, and where SMTP over TLS is optionally used as the mail transfer protocol to the recipient-centric message gateway.

FIG. 30 is a general flow diagram showing a method of determining the retry count based on the strength of the password in a typical login scenario.

FIG. 31 is a flow diagram of a lockout process based on retry count as determined by password strength.

FIG. 32 is a flow diagram of a system that establishes a password by the recipient where the subsequent allowed retry count is determined by password strength.

FIG. 33 is a flow diagram of the anti-phish proxy that guarantees that a recipient is not phished with sender's e-mail address, downloaded with account name and/or GUID and password and sender's domain, where a trigger message causes the proxy to retrieve new messages from the sending server, and which discards any other message claimed to be from the sender's domain.

FIG. 34 is a diagram of the construction of the trigger message for the anti-phish proxy.

FIG. 35 is a flow diagram of the anti-phish proxy that enables the mail client to display new message headers within an existing mailbox for protocols where the message is retained at the mail store.

FIG. 36 is a flow diagram of the anti-phish proxy as it presents a single mailbox view to the mail client by combining messages with existing mailbox messages for protocols where the message is retained at the mail store.

FIG. 37 is a flow diagram of the anti-phish proxy that uses a firewall traversing protocol.

FIG. 38 is a flow diagram of the anti-phish proxy where access to additional sending servers is added and managed subsequent to the initial download and proxy installation and includes a flow diagram of the download and installation process.

FIG. 39 is a flow diagram of the anti-phish proxy that has a timeout period when messages aren't available and establishes a queue for later retrieval.

FIG. 40 is a flow diagram of the anti-phish proxy functionality embedded into an existing mail client, which rejects mail sent from the sending domain other than mail signed by the actual sender.

FIG. 41 is a flow diagram of a gateway that retains messages and provides them to the authenticated, retrieving anti-phish proxy. The gateway keeps a record of which recipient downloaded the proxy and accordingly sends the trigger message instead of the actual message.

FIG. 42 is a flow diagram of an anti-phish proxy that guarantees that a recipient is not phished with sender's e-mail address by deleting any message purportedly from the sender but not signed with the sender's signature.

FIG. 43 is a general diagram of the anti-phish proxy interoperating with the gateway at the sender.

FIG. 44 is a block diagram of the anti-phish system operating with a recipient-centric gateway.

FIG. 45 is a block diagram of the construction of the trigger message for the anti-phish proxy used in conjunction with the recipient-centric gateway.

FIG. 46 is a flow diagram of a secure e-mail proxy, downloaded with account name and/or GUID and password used to authenticate into the sending server, where a trigger message causes the secure e-mail proxy to attempt to retrieve new messages from the sending server via a secure protocol.

FIG. 47 is a flow diagram of a secure e-mail proxy, downloaded with GUID and key pair, where a trigger message causes the secure e-mail proxy to attempt to retrieve new messages from the sending server.

FIG. 48 is a diagram of the construction of the trigger message for the secure e-mail proxy.

FIG. 49 is a flow diagram of the secure e-mail proxy that enables the mail client to display new message headers within an existing mailbox for protocols where the message is retained at the mail store.

FIG. 50 is a flow diagram of the secure e-mail proxy that combines messages with an existing mailbox for various protocols.

FIG. 51 is a flow diagram of the secure e-mail proxy that uses a firewall traversing protocol.

FIG. 52 is a flow diagram of the secure e-mail proxy where access to additional sending servers is added and managed subsequent to the initial download and secure e-mail proxy installation.

FIG. 53 is a flow diagram of the secure e-mail proxy with timeout when message isn't available and establishes a queue for later retrieval.

FIG. 54 is a flow diagram of a gateway that retains messages for the account where the secure e-mail proxy has been downloaded, sending a trigger message instead, and using a secure protocol makes available the original message to the secure e-mail proxy when authenticated.

FIG. 55 is a flow diagram of a gateway that retains messages for the account where a tag is provided in the e-mail, sending a trigger message instead, and using a secure protocol makes available the original message to the secure e-mail proxy when authenticated, and via the trigger message can display a web login where the secure e-mail proxy may be downloaded.

FIG. 56 is a flow diagram of a gateway that retains messages for the account where a matching template is found in the e-mail, sending a trigger message instead, and using a secure protocol makes available the original message to the secure e-mail proxy when authenticated, and via the trigger message can display a web login where the secure e-mail proxy may be downloaded.

FIG. 57 is a flow diagram of a gateway that retains messages for the account where matching fixed strings are found in the e-mail, sending a trigger message instead, and using a secure protocol makes available the original message to the secure e-mail proxy when authenticated, and via the trigger message can display a web login where the secure e-mail proxy may be downloaded.

FIG. 58 is a flow diagram of a gateway that retains messages for the account where external custom programmed analysis indicates that the message should be sent securely, sending a trigger message instead, and using a secure protocol makes available the original message to the secure e-mail proxy when authenticated, and via the trigger message can display a web login where the secure e-mail proxy may be downloaded.

FIG. 59 is a flow diagram of a gateway that accepts messages from an authenticated secure e-mail proxy.

FIG. 60 is a flow diagram of the secure e-mail proxy that is configured prior to download to send outgoing messages to the domain serviced by the gateway directly to the gateway, authenticating to the gateway to provide a message using a secure protocol.

FIG. 61 is a flow diagram of a gateway that accepts messages from a secure e-mail proxy where the messages are encrypted with an encrypting key, and where the gateway decrypts the messages with the corresponding decrypting key.

FIG. 62 is a flow diagram that includes the interface to the secure e-mail proxy that enables the recipient to see which messages were retrieved securely.

FIG. 63 is a flow diagram of the secure e-mail proxy that is configured prior to download to send outgoing messages to the domain serviced by the gateway directly to the gateway, providing a message encrypted through the use of an encrypting key, provided with the secure e-mail proxy download.

FIG. 64 is a flow diagram of the gateway that provides directory services to indicate whether a particular recipient has downloaded the secure e-mail proxy.

FIG. 65 is a flow diagram of the gateway components separated to two separate networks for the purpose of maximizing the available resources of the existing mail server infrastructure.

FIG. 66 a flow diagram of a trigger proxy that sits at the mail server, forwarding all inbound requests for delivery to the mail server, and that examines all outbound requests, directing to the mail server those outbound transactions that do not require the trigger message, and directing to the gateway those outbound transactions that do require the trigger message

FIG. 67 is a flow diagram of a secure e-mail proxy, downloaded with account name, key pair, and sender's domain, which combines incoming messages into an existing mailbox and decrypts any message sent from the sending domain, and which encrypts any message sent to the sending domain, where the message is constructed to show a link if obtained not using the proxy.

FIG. 68 is a flow diagram of a gateway that accepts inbound mail as encrypted and sent by the proxy of FIG. 66, where the message is decrypted before it is passed to the local mail server for local delivery.

FIG. 69 is a general diagram of the secure e-mail proxy with the recipient-centric gateway.

FIG. 70 is a general diagram of the trigger message for the secure e-mail proxy with the recipient-centric gateway.

FIG. 71 is a flow diagram of a proxy that can combine secure and mail store messages to show a single mailbox view across multiple machines, despite installation on different machines at different times.

FIG. 72 is a flow diagram of a gateway that supports the proxy that can combine secure and mail store messages to show a single mailbox view across multiple machines, despite installation on different machines at different times.

FIG. 73 is a flow diagram of a proxy that can combine secure and mail store messages to show a single mailbox view across multiple machines, despite installation on different machines at different times and that can receive secure messages.

FIG. 74 is a flow diagram of a gateway that supports a proxy that can combine secure and mail store messages to show a single mailbox view across multiple machines, despite installation on different machines at different times and that can receive secure messages.

FIG. 75 is a flow diagram of a gateway that supports a proxy that can combine secure and mail store messages to show a single mailbox view across multiple machines, despite installation on different machines at different times and that can receive secure messages, where the gateway can receive secure messages via SMTP and pass them to the local mail server for delivery.

FIG. 76 is a mailbox response profile definition where the mailbox profile is defined based on client pull usage, i.e. access time for every page and size pulled and time and day of week.

FIG. 77 is a mailbox response profile definition for a mailbox in an existing mail system.

FIG. 78 is a flow diagram of server timing as it times the differential between successive page requests to obtain the server duration required to pull the page from the requested server, or from a remote server.

FIG. 79 is a flow diagram of an interpreted program on a web page that is used to obtain the client duration to pull the page from the requested server, or from a remote server.

FIG. 80 is a flow diagram of a browser helper object (BHO) that is used to obtain the client duration to pull the page from the requested server, or from a remote server.

FIG. 81 is a flow diagram of obtaining client pull timing used to build a mailbox response profile.

FIG. 82 is a flow diagram of a timing-proxy that pulls data down using typical protocols (HTTP/S, IMAP4, POP3, etc.) and feeds response information to a server.

FIG. 83 is a flow diagram of a proxy pull method of populating the mailbox response profile.

FIG. 84 is a definition of the average resource profile per message store server, where the average profile resource usage (CPU usage, connection resources, etc.) of the server at the time of access to this mailbox is stored (resources in use) by time of day and date.

FIG. 85 is a flow diagram of a process that determines multiple average resource profiles.

FIG. 86 is a flow diagram of a server that authenticates into a master directory server to indicate its presence as part of the network and to indicate the mailboxes for which it is responsible.

FIG. 87 is a flow diagram of a master directory server that authenticates a server and adds its address to the list of computers in the network.

FIG. 88 is a flow diagram of a server as it initiates and presents an ‘ask’, i.e. a request from other servers to bid on a mailbox based on responsiveness, to a master directory.

FIG. 89 is a flow diagram of the master directory server as it operates on the ‘ask’ queue, connecting to available servers to provide the ‘ask’ information, accepting the ‘bids’ from the servers, and supplying the best ‘bid’ from available servers.

FIG. 90 is a flow diagram of the determination of a server whether to start the process of sending an ‘ask’ request to the master directory.

FIG. 91 is a flow diagram of a server making a determination as to whether it will bid on accepting the mailbox, based on usage, time of day profiling, relative response time, client service provider, availability of other servers, and redundancy.

FIG. 92 is a flow diagram of a server as it communicates a ‘bid’ to a master directory.

FIG. 93 is a general diagram of a server making an accepted ‘bid’ and the subsequent mailbox moving process that the ‘bid’ initiates.

FIG. 94 is a general diagram of forwarding requests from front-end server directly to the back-end server where the mailbox is stored, and where the front-end server performs the authentication and passes it through to the back-end server.

FIG. 95 is a flow diagram of retaining the mailbox until even after it is determined that the response is better on the new mailbox. The newer mailbox provides messages to the redundant mailbox.

FIG. 96 is a flow diagram of retaining the mailbox on the server where the mailbox is originally located until it is determined that the response is better on the new mailbox, and shows the subsequent deletion process.

FIG. 97 is a general diagram of an archiver that can backup up the mailboxes present in the mailbox move system and a flow diagram of redundant mailboxes removed at the instruction of the archiver.

FIG. 98 is a flow diagram of the front-end server detecting the availability of the primary mailbox server, if the primary server is not online the front-end server redirects the client to the redundant mailbox.

FIG. 99 is a flow diagram of a DNS switcher used to circumvent a non-responsive front-end server.

FIG. 100 is a flow diagram where mailbox usage is very low, the ‘ask’ is therefore constructed for a ‘bid’ from a server with lesser resources but more disk space.

FIG. 101 is a general diagram of the recipient-centric mailbox system with the mailbox move system.

FIG. 102 is a general diagram of the recipient-centric mailbox system with the mailbox move system, and retry system based on password strength.

FIG. 103 is a general diagram of the recipient-centric mailbox system with the anti-phish proxy, mailbox move system, and retry system based on password strength.

FIG. 104 is a general diagram of the recipient-centric mailbox system with the anti-phish proxy, mailbox move system, and retry system based on password strength.

FIG. 105 is a general diagram of the recipient-centric mailbox system with the secure e-mail proxy, mailbox move system, and retry system based on password strength.

FIG. 106 is a general diagram of the recipient-centric mailbox system with the secure e-mail proxy and the mailbox move systems, and the retry system based on password strength.

### DETAIL DESCRIPTION OF THE EMBODIMENTS

Preferred embodiments of the system for managing e-mail and e-mail security according to the present invention are described with reference to drawings.

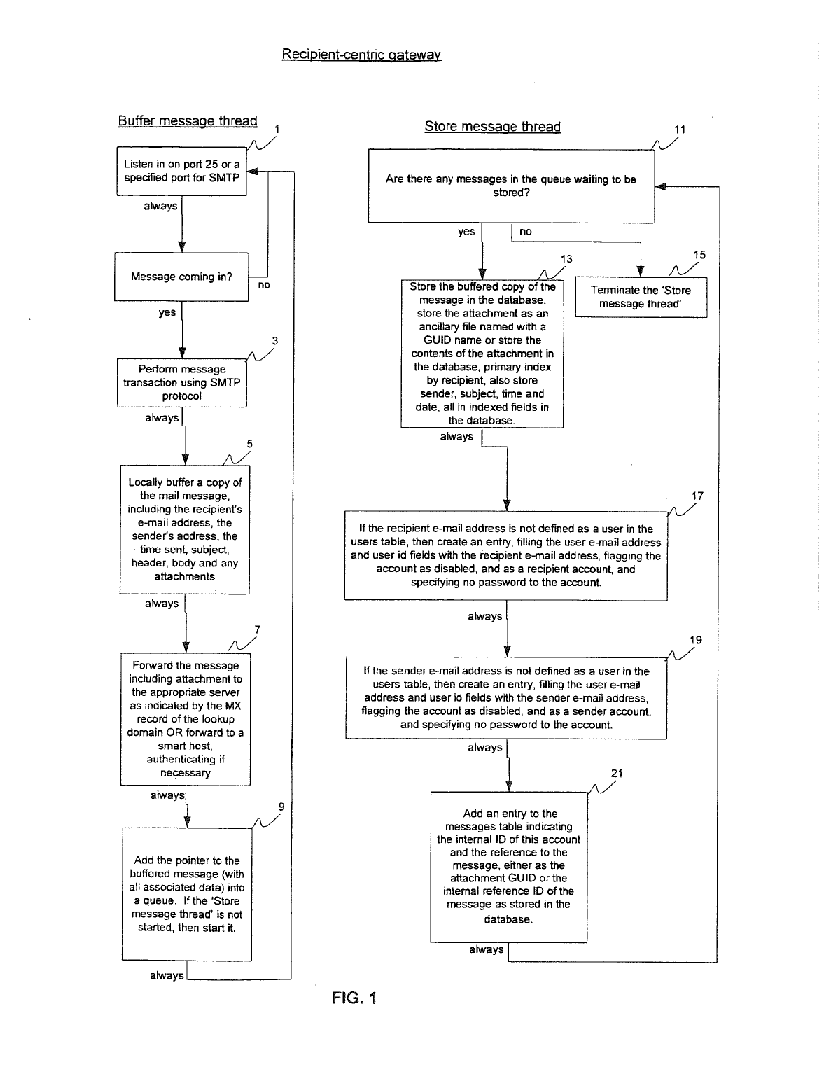

FIG. 1 is a flow diagram of a gateway that retains copies of all outgoing mail messages and organizes them by recipient, showing steps 1-21.

As shown in FIG. 1, the recipient-centric gateway accepts messages as forwarded from an existing mail server, and keeps each mail message, storing the mail message so that it is subsequently accessible to sender(s) or administrator(s) and is organized by recipient. The gateway either sends the message to a smart host, i.e. a server that will subsequently resolve DNS and forward the message onto the appropriate SMTP server for delivery, or sends the message directly to the mail server pointed to by the MX record of the recipient's domain. As shown in FIG. 1, if the recipient is not currently listed as a recipient, the system will create an entry for the recipient with an empty password, and will flag the recipient account as disabled. The attachment may be stored within the database, or within a file on the local file system, with a reference to that file in the database. The file may be stored separately for the following reasons: 1) the database does not accept large binary fields 2) the database becomes less manageable during archiving and backup as a result of the increase in database file size after filling many binary fields with large amounts of data 3) the resource requirements (i.e. speed) to store (or retrieve) the data in the binary field is greater than the resource requirements to store (or retrieve) the information in a file

As referenced in FIG. 1, two tables store user and message information and they are the ‘users’ table, and the ‘messages’ table. The users table at a minimum contains the following fields: user reference ID, user ID, administrator status (y/n), e-mail address, disabled (y/n), and password hash. The messages table at a minimum contains the following fields: message reference ID, user (recipient) reference ID, date/time message was sent, message body, message attachment or GUID pointing to a file with the message attachment, sender reference ID, and subject. Note that upon sending a mail message, both the recipient entry in the users table and the sender entry in the users table are added, if not already existing as entries in the table. Senders are assumed to be from the domain serviced by the recipient-centric gateway.

The above enables the system to store and subsequently present one or more recipient mailboxes to sender(s) or administrator(s) from a recipient-view, such that the sender(s) or administrator(s) can see all correspondence as viewed by recipients, as sent from the sender(s) behind the corporate firewall on which the recipient-centric gateway is installed.

The recipient view enables senders and others to obtain an immediate and accurate representation of the mailbox and electronic perspective of the recipient. For example, in an environment where an irate customer contacts an organization, it is highly desirable to determine what has angered the client, but it is ordinarily not possible to see what the client has seen, exactly as received by the recipient. One solution is for the individual desiring to examine the customer problem, i.e. desiring to examine the information transferred to the customer from the customer perspective, is to physically go to the individual mail client of each sender and to search for the correspondence on the mail client. This process is unwieldy.

Another solution is to enable journaling of all mail transactions to a database and to execute a series of manual steps. The steps include searching on the recipient's name or e-mail address, and sorting by date sent, where this process must be performed for each incident, and for every recipient of interest, on an ongoing basis, and where the individual performing the search typically must be provided access to the entire database. For instance, in an office environment where subordinates leave the office (vacation, etc.), it is desirable for managers to immediately have available what has been communicated to clients when the client subsequently corresponds with the company, from the client perspective. Managers should typically not be authorized to search an entire journal or mail store database, even if such managers were trained, capable and willing to perform such a procedure. The recipient-centric gateway provides that managers ordinarily have access to client mailboxes from a client recipient view.

The recipient-centric gateway enables an individual with limited authorization to directly obtain an immediate representation of what is seen by the recipient as received from all senders behind the corporate firewall, and where access to multiple recipients of interest is provided in a single view.

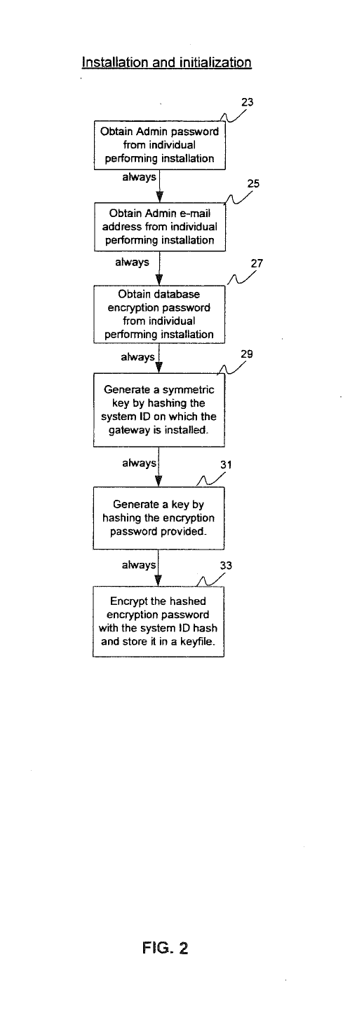

FIG. 2 is a flow diagram of general installation and authentication initialization for the recipient-centric message gateway system of FIG. 1, showing steps 23-33.

As shown in FIG. 2, the installation process of the recipient-centric gateway requires an ‘Admin’ account password, an Admin account e-mail address, and a database encryption password. As shown in FIG. 2, on systems where a unique system ID can be generated, or is made available by the operating system, it is possible to insure that the recipient-centric database and associated files are protected by an encryption scheme that enables ongoing access by the recipient-centric gateway to the information contained in the database, but which causes an unauthorized individual who copies the database and associated files to be unable to access the contents.

On many systems, a unique system ID is made available by the operating system, or can be generated from the specific combination of the serial number of the hard drive, a serial number embedded in the ROM bootstrap software, the type of CPU and speed, and other parameters that are accessible by software and ordinarily do not change. This ID can be generated so it appears similar to a GUID. As shown in FIG. 2, at installation the unique system ID for the machine on which the recipient-centric gateway is executing is hashed, forming a “system-id symmetric key”. The alphanumeric “encryption password” entered during installation is hashed, and this hash is the “encryption/decryption key for the database and associated files”. The “encryption/decryption key for the database and associated files” is encrypted with the “system-id symmetric key” and this value is stored in a keyfile on the recipient-centric gateway's file system. Because the recipient-centric gateway has access to the system ID at all times, the keyfile can be decrypted, to obtain the “encryption/decryption key for the database and associated file” which is needed to store or retrieve data. Because an outsider that copies the database and associated files will not have the system ID, that individual cannot decrypt the keyfile, and the database and associated files are therefore protected. This scheme also enables the individual who installed the system and who remembers the original installation password, to copy the files to another system (in the event of system failure), enter the original password, and the new instance of the recipient-centric gateway will have access to the original database and associated files.

The purpose of the above is so that messages can be stored and retrieved by the recipient-centric gateway but cannot be read by outside parties who obtain access to the recipient-centric gateway's file system. Under the above, if the message and user tables or database contents are moved to another machine, they will become unreadable, but will become readable upon reinstallation of the recipient-centric gateway with the original encryption password.

At installation, the Admin password is required because the Admin account provides for the maintenance of the recipient-centric gateway, including the establishment of groups permitted to review the mailboxes of recipients. The installer hashes the password of the Admin account and stores this in the users table described in FIG. 1. The e-mail address of the Admin account is required because every user account has an associated e-mail address.

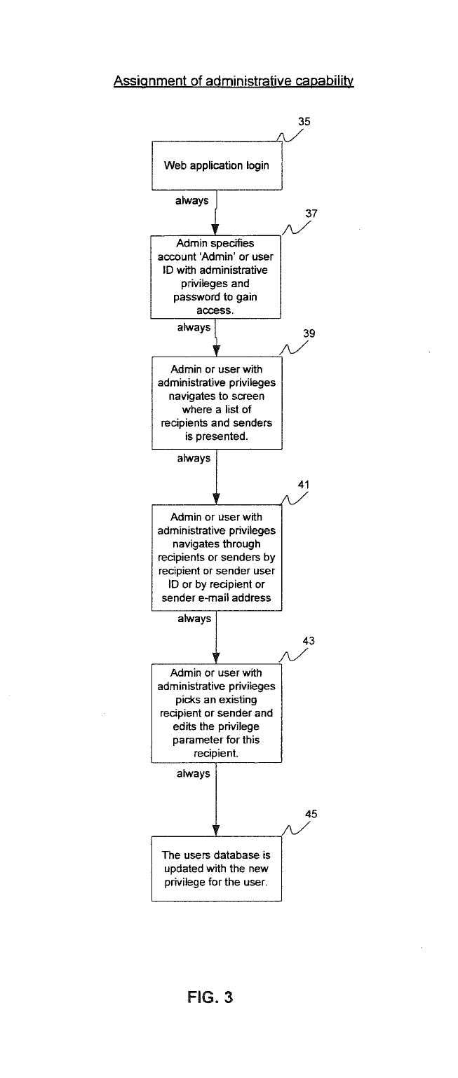

FIG. 3 is a flow diagram of the process of assigning administrative capability to users, the assignment performed by an administrator, showing steps 35-45.

As shown in FIG. 3, the Admin account (or a user account with administrative privileges) is provided a mechanism whereby an existing recipient or sender can be provided with the authority to perform administrative functions. In such cases, the administrator, through an interface, modifies the value of the ‘administrator status (y/n)’ field for the user account in the users table.

This functionality is provided because the Admin (or a user with administrative privileges) may want to delegate the task of establishing additional groups in order that designated individuals may have access to recipient-centric mailboxes.

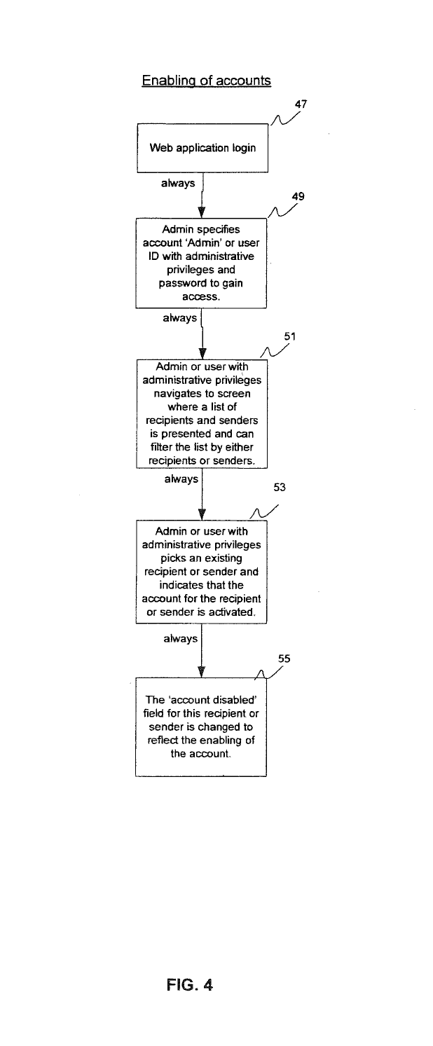

FIG. 4 is a flow diagram of the process of enabling sender or recipient accounts, this action performed by an administrator, showing steps 47-55.

As shown in FIG. 4, the Admin account (or a user account with administrative privileges) is provided with a mechanism whereby the ‘disabled (y/n)’ entry in the ‘users’ table may be updated such that the system will enable the recipient (or sender) to access recipient mail through an interface designed for this purpose.

The reason that the account is initially disabled is because the administrator (i.e. the Admin user) may not desire recipients or senders to obtain information stored by the system. The Admin (or a user with administrative privileges) may, for instance, want to alone monitor correspondence as seen by the recipient as sent from senders behind the corporate firewall, or provide that capability only to senior managers, customer services representatives responsible for QA/QC, or others, and not to all senders.

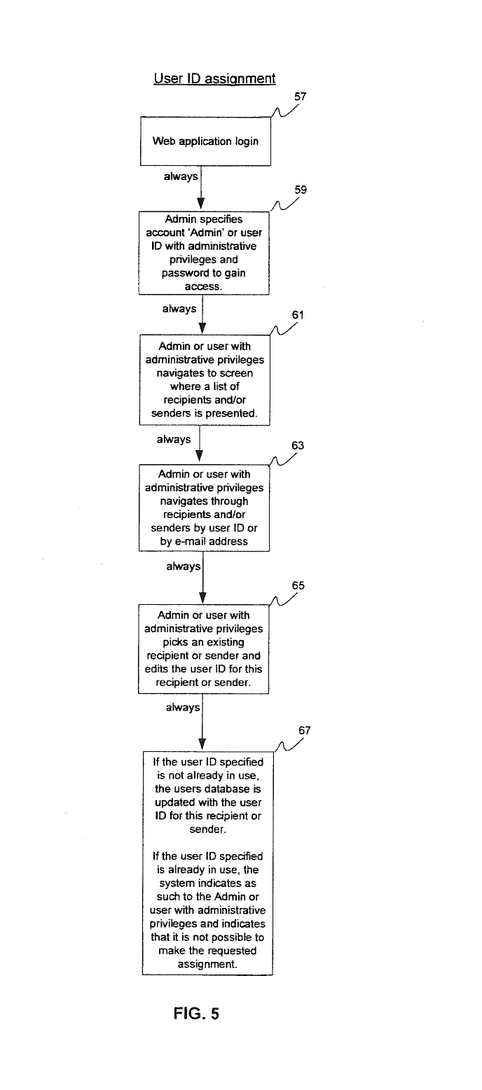

FIG. 5 is a flow diagram of the process that assigns a user ID to the sender or recipient, in lieu of e-mail address, this process performed by an administrator, showing steps 57-67.

As shown in FIG. 5, the Admin account (or a user account with administrative privileges) is provided with a mechanism whereby the user ID, which is populated with the e-mail address when a new record is added to the users table, can be assigned a different value.

This enables the use of an identifier that is easier to enter than an e-mail address as part of the process of accessing the recipient-centric mailboxes.

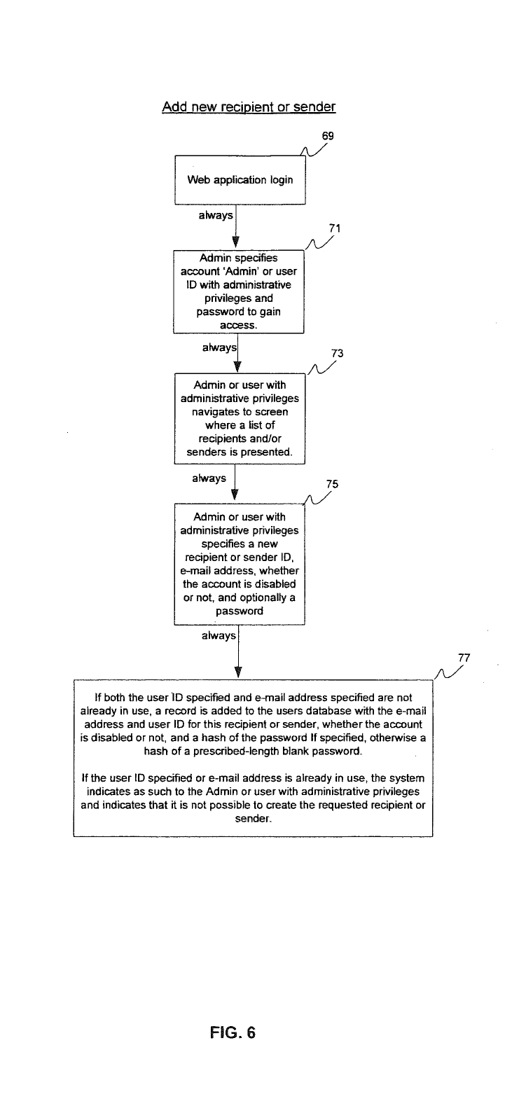

FIG. 6 is a flow diagram of the process of adding a new sender or recipient by the administrator, showing steps 69-77.

As shown in FIG. 6, the Admin account (or a user account with administrative privileges) is provided with a mechanism whereby a new recipient or sender may be created, such that this recipient or sender may be subsequently given access to recipient-centric mailboxes.

This provides an administrator the ability to enable a particular recipient or sender to access the system, without first requiring the sending of a message through the system to a recipient or sender.

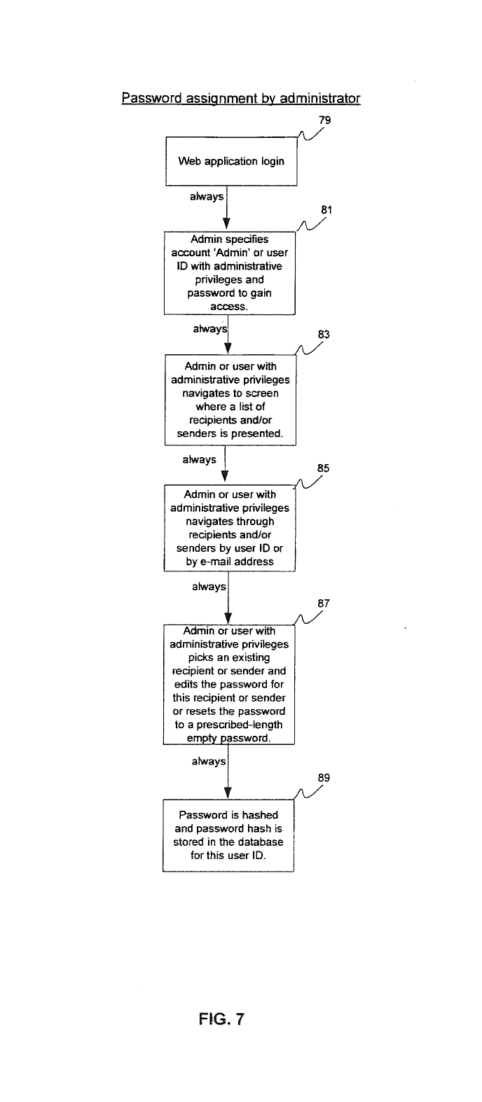

FIG. 7 is a flow diagram of the process of password assignment for the sender or recipient by an administrator, showing steps 79-89.

As shown in FIG. 7, the Admin account (or a user account with administrative privileges) is provided with a mechanism whereby an administrator can assign a password to a user account.

This enables the administrator to establish a password for the recipient or sender before first use, and enables the administrator to reset the account password, in the event that the password is lost, or must be changed, or a retry count has been exceeded.

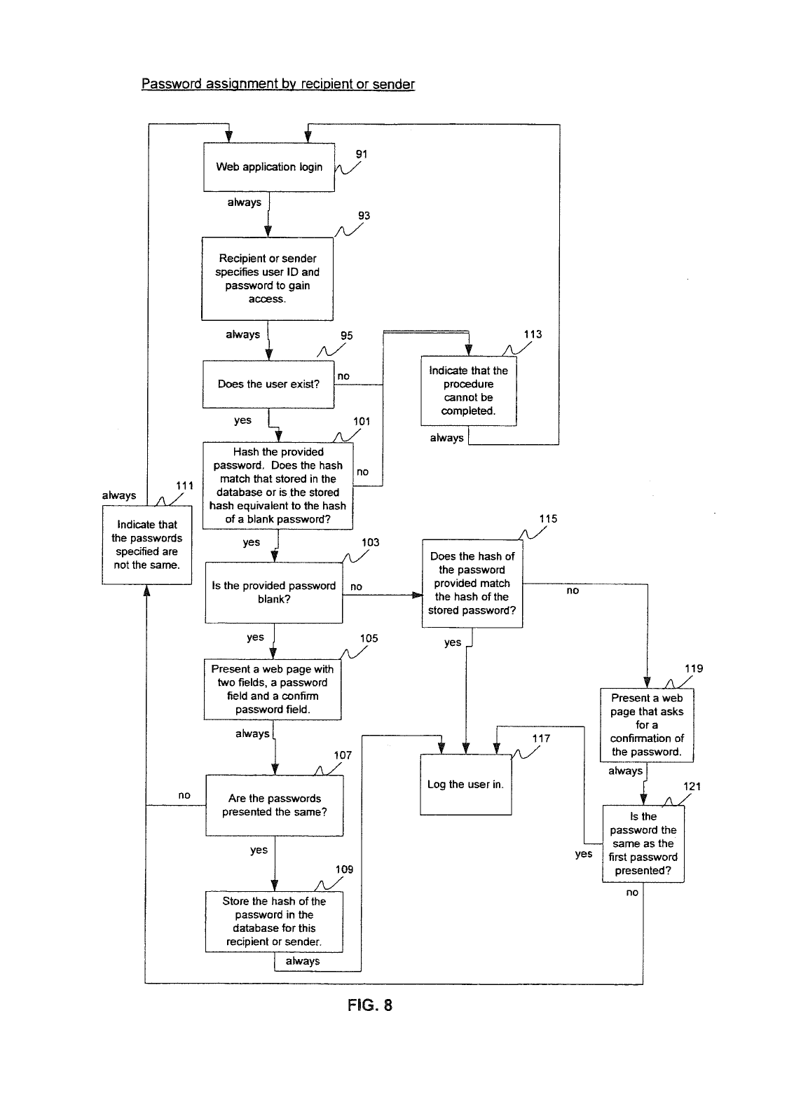

FIG. 8 is a flow diagram of the process of password assignment for the sender or recipient by the sender or recipient, showing steps 91-121.

As shown in FIG. 8, the recipient or sender can establish the password of a recipient-centric gateway account through a normal login process, in the event that the password is currently empty. As shown in FIG. 8, the recipient or sender logs through a web interface, and specifies the user ID, which ordinarily defaults to the recipient or sender's e-mail account, unless previously changed by the administrator. If the account exists but is disabled, the interface indicates as such. If the account does not exist, the interface indicates as such, otherwise the provided password is hashed and compared against the hash that is stored in the database. If the existing password is the equivalent of a hash of a blank password, and if the user specified a password, the specified password is hashed and stored in the users table, and the user is logged in. If the existing password is the equivalent of a hash of a blank password, and if the user specified a blank password, the user is subsequently asked to provide a password and to confirm it. If this password is non-blank then it is hashed and stored in the users table for this user and the user is logged in. If the stored password is not the equivalent of a hashed blank password, and if the stored password hash matches the hash of the password specified, then the user is logged in. If the stored password hash is not the equivalent of the hash of a blank password and if the hash of the provided password differs from the stored hash, then the user is routed back to the login page.

This eliminates the requirement that the administrator initialize every password of every recipient or sender.

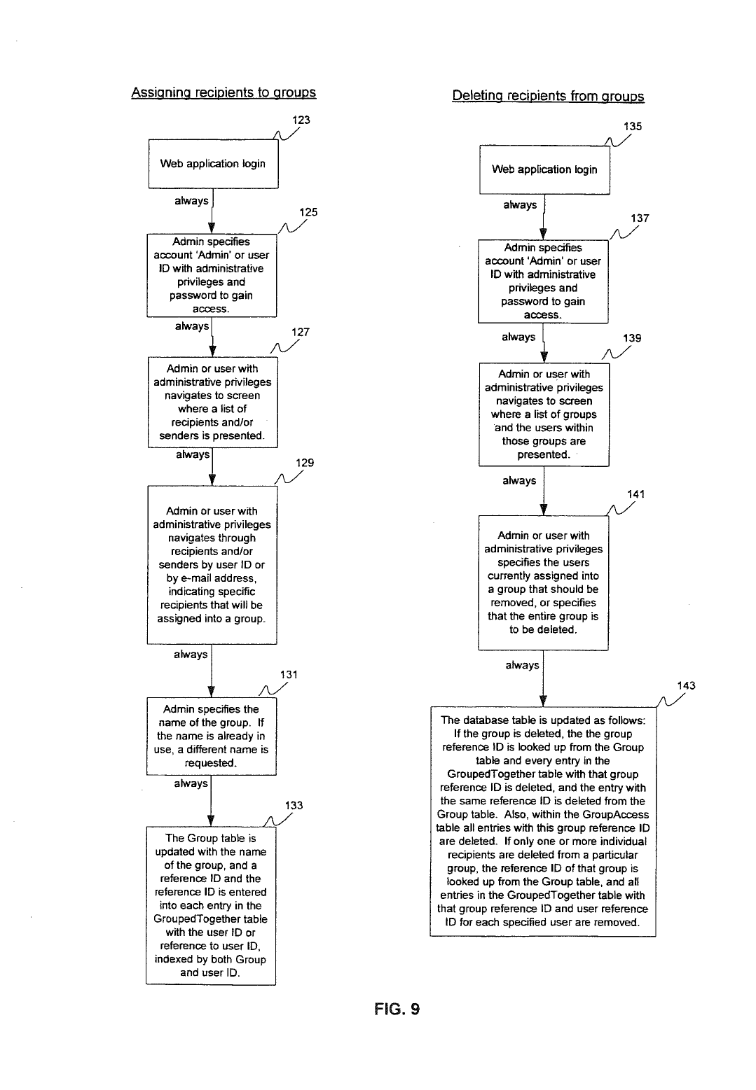

FIG. 9 is a flow diagram of the establishment by an administrator of a group, certain recipient-centric mailboxes subsequently readable by a sender (or recipient) with access to the group, showing steps 123-143.

As shown in FIG. 9, an administrator can establish a group, in order that users may be subsequently provided access to the recipient mailboxes of the users in that group. As shown in FIG. 9, an administrator organizes recipients into groups. In one embodiment, the defining reference tables are the Group, and GroupedTogether tables. At a minimum, the Group table contains the following fields: reference ID, and Group (i.e. name of the group). The GroupedTogether table contains at a minimum the following fields: reference ID, Group reference ID (refers to reference ID in Group table), and User reference ID (refers to reference ID in the users table).

In the event the administrator wants to establish a group, the administrator logs in and navigates to an interface where recipients are organized and sortable, and where senders are organized and sortable. The administrator clicks off the senders or recipients that will be grouped together, i.e. users who will be collectively given access to one or multiple recipient-centric mailboxes. The administrator specifies the name of the group, and the system looks up this name in the Group table to determine if it is already in use. If it is in use, then a different name is requested. If it is not in use, then a new reference ID is generated, and a new record is added to the Group table, with the reference ID field filled in with the new reference ID just generated, and the Group field filled in with the specified group name, and the GroupedTogether table filled in with one record per user specified, and the reference ID filled in with the next available reference number, and the Group reference ID filled in with the reference ID of the new group as specified in the Group table, and the reference ID for each user as obtained from the users table placed in each record for the user reference ID field.

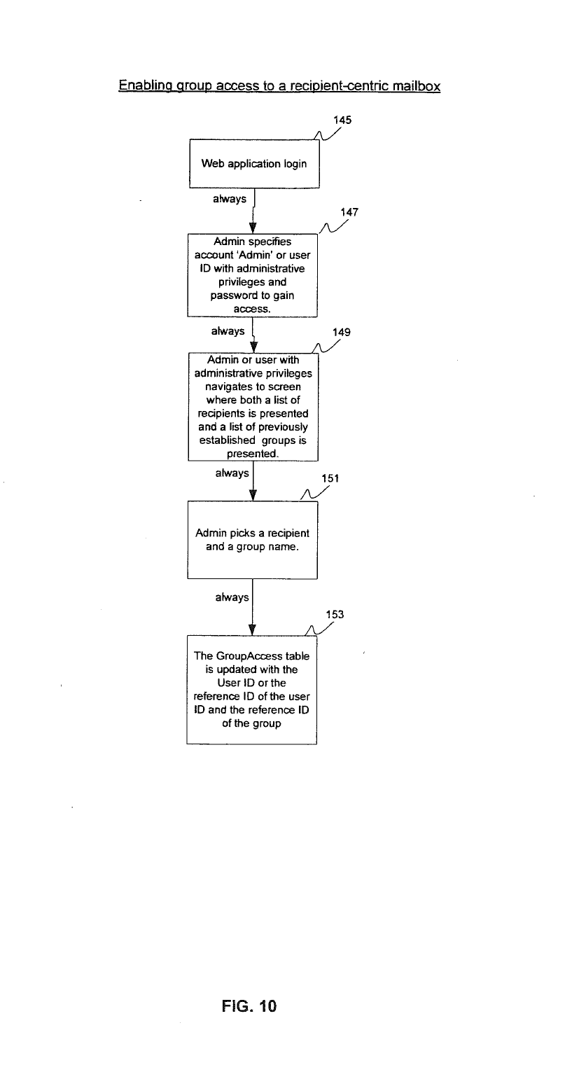

As shown in FIG. 9, a mechanism where a user may be removed from a group is provided, whereby the administrator picks a group and a recipient or sender within that group, alternately picking an entire group to be deleted. If only the recipient is deleted from the group, using the name of the group, the reference ID of the group is determined from the Group table, the GroupedTogether table is subsequently accessed and the records where both the reference ID for the group and the reference ID for the specified user(s) are found, those records then deleted. In the event that the entire group is specified as marked for deletion, the group reference ID from the Group table is determined from the group name, every entry in the GroupedTogether with that reference ID are deleted, and within the GroupAccess table (see FIG. 10), all records with the group reference ID are also deleted.

This enables the administrator to specify a set of senders (and recipients) who can be provided access to one or more recipient-centric mailboxes, such that additional assignments do not require adding access to each member of the group, rather all members of the group can be given access at the same time. For example, a set of five managers can be assigned into the group ‘Managers’, and, as shown in FIG. 10, can be given access to the recipient-centric mailbox of a user. If these managers also subsequently require access to another recipient-centric user mailbox, they can be assigned access in one step, instead of five separate steps.

FIG. 10 is a flow diagram of the process of assigning to a group the ability to access a recipient-centric mailbox, showing steps 145-153.

As shown in FIG. 10, an interface is provided to an administrator so that the administrator can specify that a group, i.e. all individuals within a particular group, may access a recipient's recipient-centric mailbox.

As shown in FIG. 10, the administrator accesses the system by specifying the administrative-capable account and password, is provided with an interface that shows a list of recipients, and a list of existing groups. The interface may show the list of users that are in the group by querying the Group table to obtain the Group reference ID, querying the GroupedTogether table to obtain the user reference ID for all records with the Group reference ID, and querying the users table to obtain the user ID and/or e-mail addresses of users. The GroupAccess table has at a minimum the following fields: Group reference ID, and user reference ID. Therefore, in order to give a group access to a recipient's recipient-centric mailbox, the Group reference ID of the group specified (can be obtained from the Group table) and the user reference ID for the recipient specified (can be obtained from the users table), are added in a new record, assuming that the combination does not already exist. If the combination does exist, the system indicates to the administrator that the group already has access to that recipient-centric mailbox. In the event that the administrator wants, to discontinue access to a recipient-centric mailbox for a group, the administrator is presented with the list of recipients whose recipient-centric mailboxes are accessible to the group, allowing the administrator to pick both a group and a recipient, and the corresponding reference ID of the group is obtained from the Group table, the corresponding user reference ID is obtained from the users table, and the record that contains both these matching values in the corresponding fields is deleted from the GroupAccess table.

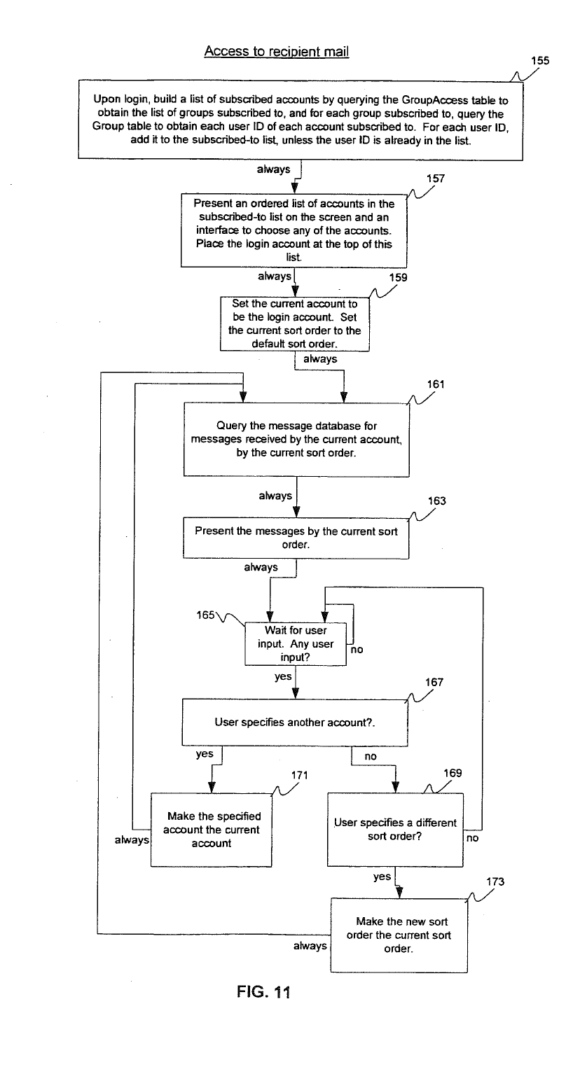

FIG. 11 is a flow diagram of the process of access to multiple recipient-centric mailboxes as presented to a group member, where the current account defaults to the login account, showing steps 155-173.

As shown in FIG. 11, the user that accesses the system is presented with both a list of recipient-centric mailboxes in all groups of which the user is a member, and is provided access to messages within those recipient-centric mailboxes. At initial authenticated access by a user, a list of recipient-centric mailboxes is obtained by obtaining the user reference ID for the authenticated user, querying the GroupedTogether table to obtain a list of group reference IDs for the authenticated user, and querying the Group table to obtain the user reference ID and user ID and/or e-mail account for each recipient-centric mailbox, and building a list by querying the GroupAccess table that contains no duplicates of access-authorized recipient-centric mailboxes. To build a list that does not have duplicate entries, the entry for the user reference is only added if it is not currently in the list. The user ID and/or e-mail account for the recipient is then ordered alphabetically or by domain name and then by component of the e-mail address that appears before the ‘@’ sign, and this list is presented in a format where the authenticated user can pick any recipient-centric mailbox. The current account is set to the picked recipient-centric mailbox, and the message database is queried for messages received by the current account. The query is for messages received by the user reference ID, ordered by either date/time, or message subject, or sender, depending on the sort order specified by the authenticated user. The date/time, message subject, and sender are displayed, the message reference ID is not displayed, but can be used in a subsequent query to obtain the message. Should the authenticated user click on the message, the message reference ID is used to obtain the message and the attachment if stored in the database, or the reference ID is used to obtain the GUID from the database that points to the attachment stored in the file system storing the database. A limited number of message fields are pulled, that number being the equivalent of the message headers (i.e. subject, date/time, sender) that can be displayed in the interface and are useful to the user, with the interface providing a mechanism for moving to prior messages on subsequent screens. The authenticated user can select another account that becomes the current account, and the process repeats itself from the instruction where the system awaits the selection of a current account or of a displayed message.

The above is the mechanism by which an authenticated user accesses recipient-centric mailboxes where access is granted via the group functionality of the system. It enables a user to view mail of multiple recipients from the recipient perspective, from all senders behind the firewall, as received by the recipient.

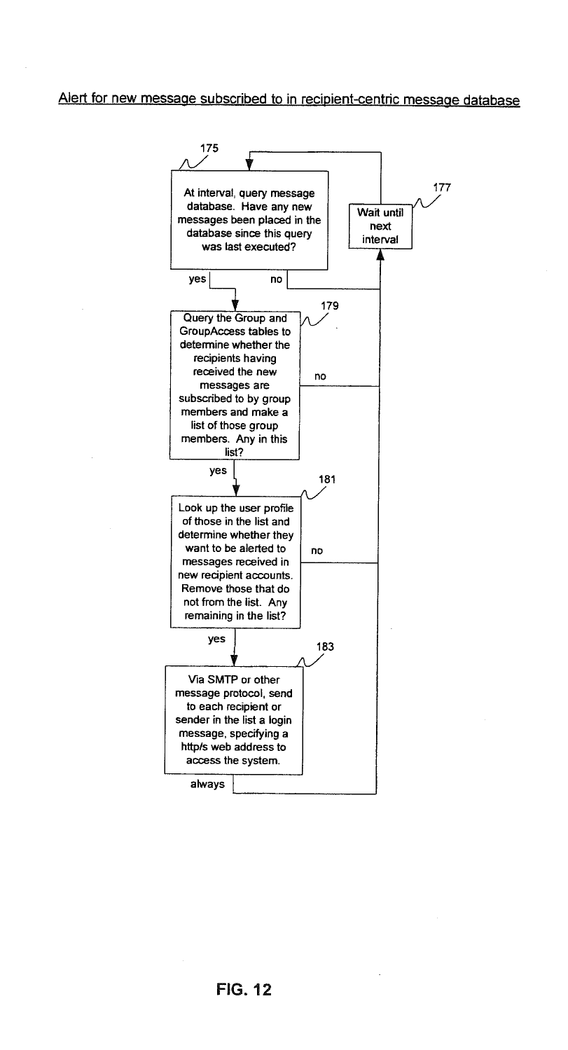

FIG. 12 is a flow diagram of sending a login message to a group member, to indicate that one or more new messages are available in a recipient account, showing steps 175-183.

As shown in FIG. 12, a thread runs under the recipient-centric gateway where the database is queried for new messages since the last query. This is performed by querying the messages table for any entries dated later than the last date/time the query was run, the date/time of the query being stored at the time the query is run. Should there be no existing date/time of the query stored, the query does not run, the date/time is simply stored. In the event that new messages have been stored in the database since the last query performed by this thread on the messages table, the system obtains the recipient user reference ID for the messages and places these in a list (i.e. the “sent-to list”). The system then queries the GroupAccess table to determine if any of the recipient-centric mailboxes to which the messages were sent is accessible to members of one or more groups. If so, the Group reference ID is obtained from the GroupAccess records having the same user reference IDs as the received messages. The Group reference IDs are then used to compose a list of user reference IDs from the GroupedTogether table that represents those users who have access to the recipient-centric mailboxes where the messages were sent (i.e. the “monitored-by list”). In the event that there is a field ‘don't alert (y/n)’ in the users table, and in the event that this field is set to true for any user in the list, that user is removed from the list. The e-mail addresses of individuals in this list are then acquired from the users table, and an e-mail is sent to these individuals indicating that a new message exists and is accessible at the recipient-centric gateway. The e-mail may present a web link pointing to the recipient gateway, the link pointing to the login/authentication page for the gateway.

For the purpose of finer control over alerts, the user may specify that alerts should be only provided for new messages in specific recipient-centric mailboxes, and to indicate as such during the user's interaction with the interface. By querying the GroupedTogether and GroupAccess tables, a list of recipients may be presented by the interface. Where the user designates that an alert for a particular recipient should not be presented, the ‘Alerting’ table is update. The ‘Alerting’ table contains the following fields: user reference ID (authenticated user) and user reference ID (recipient-centric mailbox). Before sending the e-mail alert as specified above, the ‘Alerting’ table is checked for an entry that has both the user reference ID of the authenticated user and the user reference ID for the recipient. Should both fields be present, the alert is not sent.

The above is so that users who have access to recipient-centric mailboxes are made aware that there may be new information in those mailboxes that may be of interest.

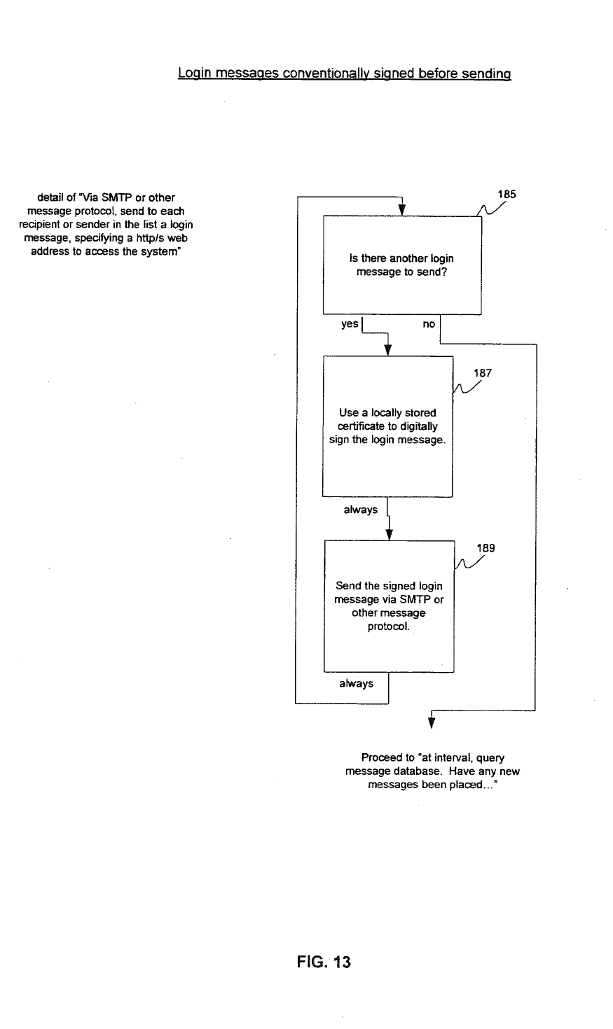

FIG. 13 is a flow diagram where the login message is sent in a conventionally signed manner, showing steps 185-189.

As shown in FIG. 13, the sent notification of FIG. 12 is signed before it is sent out via SMTP.

This is useful because it enables the individual receiving the notification to perform a rudimentary check that the notification message is authentic, and where a web link is presented, that that web link is not designed by a third party to capture the authentication information. This does not preclude the receiving of a false or fraudulent notification, but it provides a mechanism for determining that the notification is not fraudulent, assuming that the notification recipient is aware of the procedure to do so and is willing and able to do so consistently.

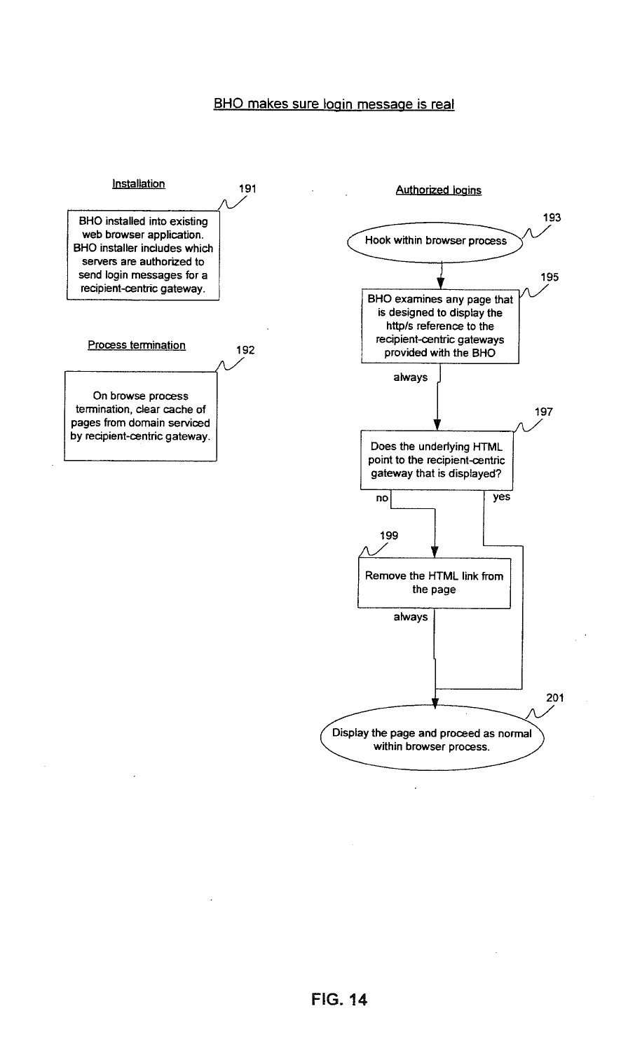

FIG. 14 is a flow diagram of a downloadable BHO that analyzes the HTML of the login message, determining whether the reference points to an authentic recipient-centric server reference, removing inauthentic references, and clearing the cache upon process exit, showing steps 191-201.

As shown in FIG. 14, a browser helper object (BHO) sits in the process space of the web browser, such that when a notification message is received and where the notification message contains a message that includes the web login link, the BHO examines the message and determines whether the underlying link reference actually points to the recipient-centric gateway which is displayed. This BHO is used where the notification message is received via a web mail client. If the link presents the recipient-centric gateway's address, but the underlying link does not point to the recipient-centric gateway's address, the BHO removes the underlying link reference, or changes it to the correct link reference. The BHO can be downloaded from a link within the user's recipient-centric view, or can be e-mailed with the first notification, and is configured to reject in the manner above an invalid representation of the recipient-centric gateway's address as determined above.

The BHO above is useful in that it can reject falsified notification messages, designed to redirect the recipient-centric gateway user to a system that will capture authentication credentials.

The BHO also discards stored recipient-centric mailbox pages cached by the web browser so that such pages are inaccessible to unauthorized third parties with access to the user's file system.

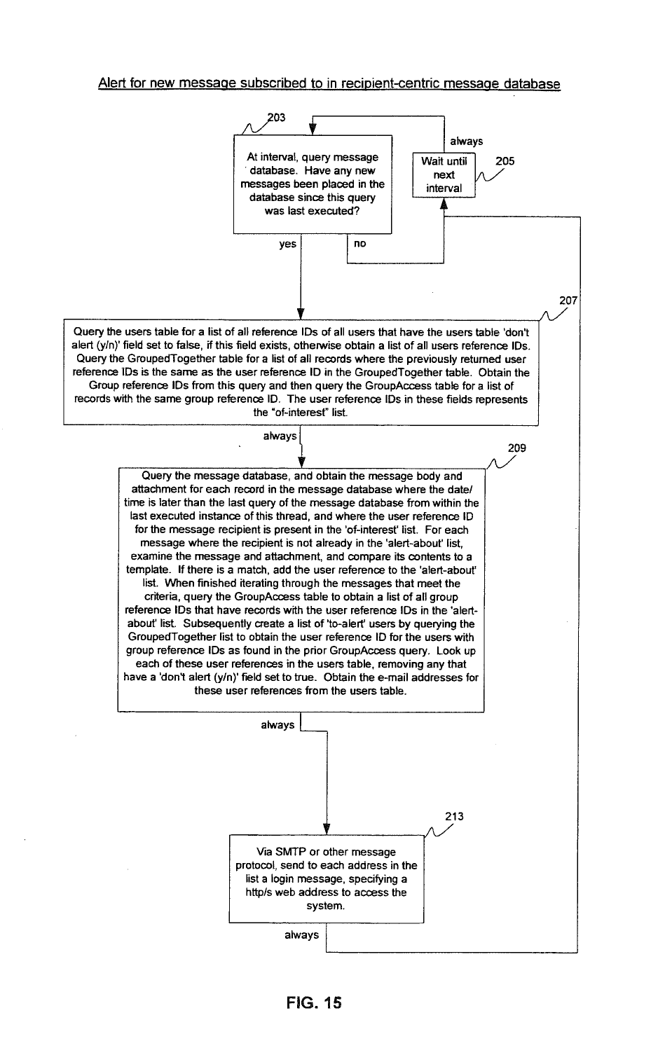

FIG. 15 is a flow diagram showing the sending of login messages to group member(s), to indicate that new messages of interest are available in subscribed recipient accounts, based on template, showing steps 203-213.

As shown in FIG. 15, the system queries the messages table for new messages at intervals, and if there are new messages the users table is queried for a list of all users that have alerting turned on, i.e. if there is a ‘don't alert (y/n)’ field, where that field is false. The GroupedTogether table is then queried for a list of all records where the reference ID from the returned query against the users table is the same as the user reference ID in the GroupedTogether table. The Group reference IDs are obtained from this query and a list of user reference IDs is generated from querying the GroupAccess records with the same group reference ID. This list is the list of recipients whose e-mail is of interest to group members (the ‘of-interest’ list). The message database is then queried to obtain the message body and attachment for each record in the message database where the date/time is later than the last query of the message database from within the last executed instance of this thread, and where the user reference ID for the message recipient is present in the ‘of-interest’ list. For each message where the recipient is not already in the ‘alert-about’ list, examine the message and attachment, and compare its contents to multiple templates, the templates having the form of “##-###-####” and/or “@@@@@ @@@@@”. For example, “11-111-1111” or “Hello World” match these two templates, respectively. If there is a match, add the user reference to the ‘alert-about’ list. After iterating through the messages, the GroupAccess table is queried to obtain a list of all group reference IDs that have records with the user reference IDs in the ‘alert-about’ list. A list of ‘to-alert’ users is subsequently created by querying the GroupedTogether list to obtain the user reference ID for the users with group reference IDs as found in the prior GroupAccess query. Each of these user references is then looked-up in the users table, with any that have a ‘don't alert (y/n)’ field set to true then removed. The e-mail addresses for these user references from the users table are then obtained. An e-mail is sent to these recipients indicating that a new message exists and is accessible at the recipient-centric gateway. The e-mail may present a web link pointing to the recipient gateway, the link pointing to the login/authentication page for the gateway.

The above is so that users who have access to recipient-centric mailboxes are made aware that there is new information in those mailboxes that may be of interest, according to one or more template criteria. This is useful, for instance, in an environment where banking officials want to review customer correspondence, from the customer perspective, where senders behind the firewall may be using confidential account information in e-mail.

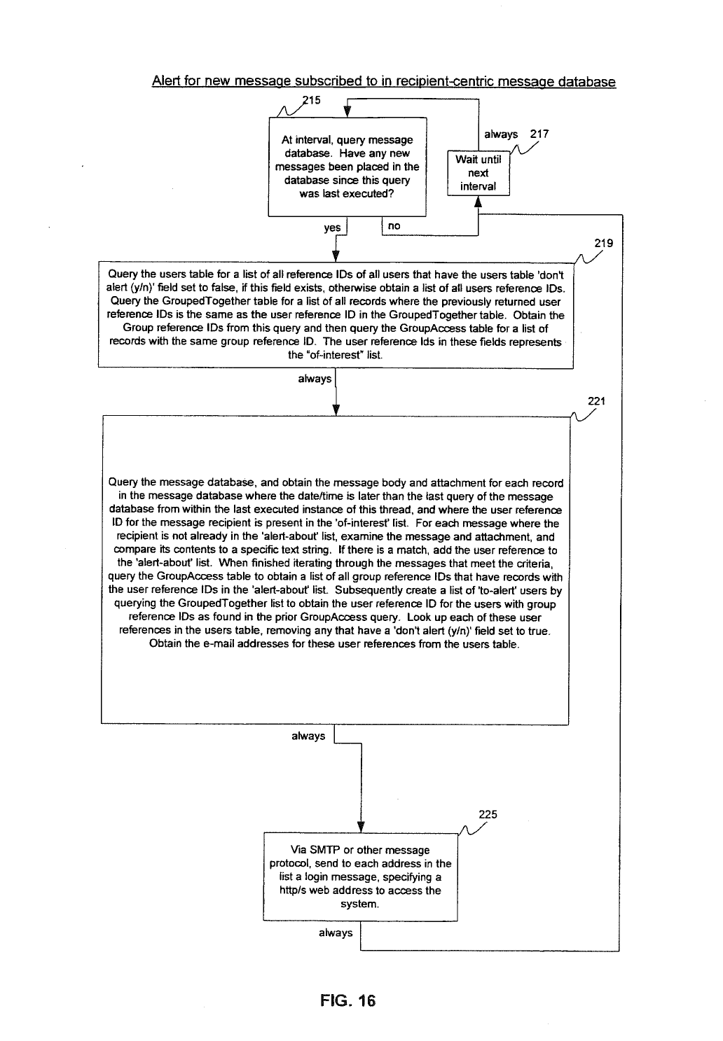

FIG. 16 is a flow diagram showing the sending of login messages to group member(s), to indicate that new messages of interest are available in subscribed recipient accounts based on an exact match, showing steps 215-225.

As shown in FIG. 16, the system queries the messages table for new messages at intervals, if there are new messages the users table is queried for a list of all users that have alerting turned on, i.e. if there is a ‘don't alert (y/n)’ field, where that field is false. The GroupedTogether table is then queried for a list of all records where the reference ID from the returned query against the users table is the same as the user reference ID in the GroupedTogether table. The Group reference IDs are obtained from this query and a list of user reference IDs is generated from querying the GroupAccess records with the same group reference ID. This list is the list of recipients whose e-mail is of interest to group members (the ‘of-interest’ list). The message database is then queried to obtain the message body and the attachment for each record in the message database where the date/time is later than the last query of the message database from within the last executed instance of this thread, and where the user reference ID for the message recipient is present in the ‘of-interest’ list. For each message where the recipient is not already in the ‘alert-about’ list, examine the message and attachment, and compare its contents to a fixed string, the string having the form of “12-123-1234” or “AAAA AAAAA”. For example, “12-123-1234” or “AAAA AAAAA” respectively would match these two fixed strings. If there is a match, add the user reference to the ‘alert-about’ list. After iterating through the messages that meet the criteria, the GroupAccess table is queried to obtain a list of all group reference IDs that have records with the user reference IDs in the ‘alert-about’ list. A list of ‘to-alert’ users is subsequently created by querying the GroupedTogether list to obtain the user reference ID for the users with group reference IDs as found in the prior GroupAccess query. Each of these user references is then looked-up in the users table, with any that have a ‘don't alert (y/n)’ field set to true then removed. The e-mail addresses for these user references from the users table are then obtained. An e-mail is sent to these recipients indicating that a new message exists and is accessible at the recipient-centric gateway. The e-mail may present a web link pointing to the recipient gateway, the link pointing to the login/authentication page for the gateway.

The above is so that users who have access to recipient-centric mailboxes are made aware that there is new information in those mailboxes that may be of interest, according to a set of fixed string criteria. This is useful in a quality control environment, where product managers may be interested in reviewing all received correspondence from the recipient viewpoint, for any mailbox having a mail message with the word “defect” present in the correspondence.

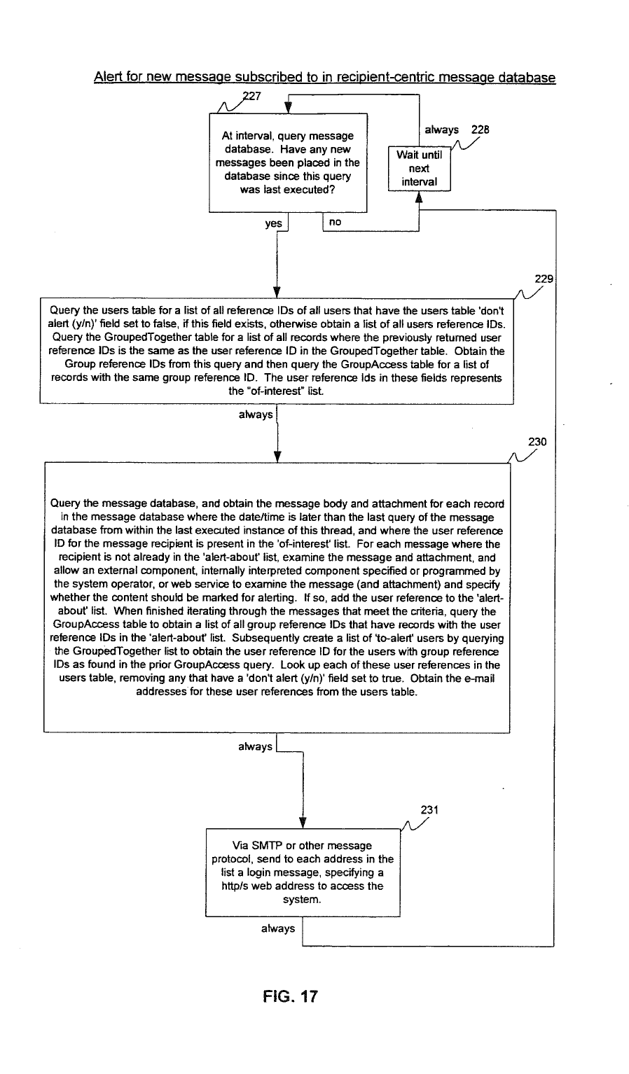

FIG. 17 is a flow diagram showing the sending of login messages to group member(s), to indicate that new messages of interest are available in subscribed recipient accounts based on an externally programmed analysis, showing steps 227-231.

As shown in FIG. 17, the system queries the messages table for new messages at intervals, if there are new messages the users table is queried for a list of all users that have alerting turned on, i.e. if there is a ‘don't alert (y/n)’ field, where that field is false. The GroupedTogether table is then queried for a list of all records where the reference ID from the returned query against the users table is the same as the user reference ID in the GroupedTogether table. The Group reference IDs are obtained from this query and a list of user reference IDs is generated from querying the GroupAccess records with the same group reference ID. This list is the list of recipients whose e-mail is of interest to group members (the ‘of-interest’ list). The message database is then queried to obtain the message body and attachment for each record in the message database where the date/time is later than the last query of the message database from within the last executed instance of this thread, and where the user reference ID for the message recipient is present in the ‘of-interest’ list. For each message where the recipient is not already in the ‘alert-about’ list, allow an external component, internally interpreted component specified or component programmed by the system operator, or web service to examine the message (and attachment) that specifies whether the content should be marked for alerting. If the message is marked for alerting, add the user reference to the ‘alert-about’ list. After iterating through the messages that meet the criteria, the GroupAccess table is queried to obtain a list of all group reference IDs that have records with the user reference IDs in the ‘alert-about’ list. A list of ‘to-alert’ users is subsequently created by querying the GroupedTogether list to obtain the user reference ID for the users with group reference IDs as found in the prior GroupAccess query. Each of these user references is then looked-up in the users table, with any that have a ‘don't alert (y/n)’ field set to true then removed. The e-mail addresses for these user references from the users table are then obtained. An e-mail is sent to these recipients indicating that a new message exists and is accessible at the recipient-centric gateway. The e-mail may present a web link pointing to the recipient gateway, the link pointing to the login/authentication page for the gateway.

The above is so that users who have access to recipient-centric mailboxes are made aware that there is new information in those mailboxes that may be of interest, according to one or more external or externally programmed criteria.

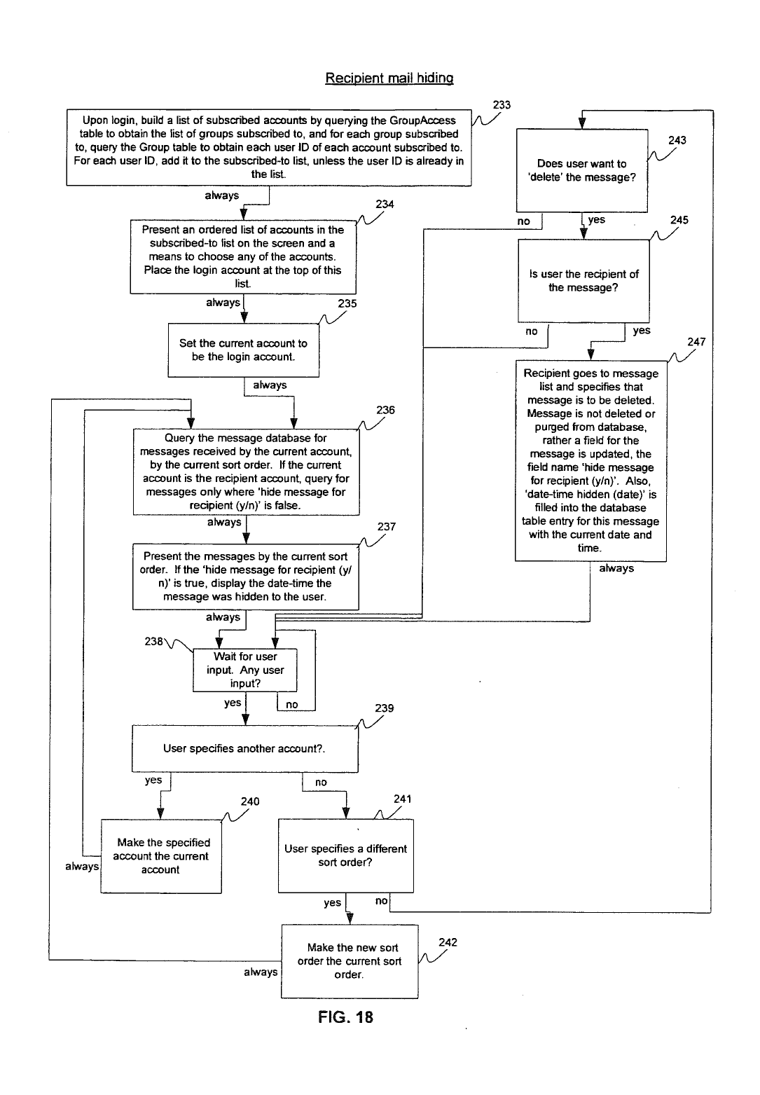

FIG. 18 is a flow diagram where a message is deleted by a recipient, but is nevertheless made available to the group member or administrator, showing steps 233-247.

As shown in FIG. 18, a mechanism for deletion of a message by a recipient hides the message, rather than actually deleting it, so that a user in a group that has access to the recipient's messages, can continue to access the message even if ‘deleted’ (i.e. hidden) by the recipient.

As shown in FIG. 18, the recipient authenticates into the account and is provided with a message list. The message list is displayed as usual, however messages in the database that have a field marked ‘hidden’ are not shown. The recipient is provided with an interface whereby the message can be ‘deleted’, i.e. the message is removed from the view and the hidden field in the messages table for the message is set to true.

As shown in FIG. 18, a user who has access to the recipient-centric mailbox of the recipient authenticates into the account and is shown a list of recipient mailboxes, and chooses one such mailbox. Messages that are marked as ‘hidden’ in the database are still shown, although in a different color.

Optionally, in addition to the hidden field saved as ‘true’, a field for when the message was denoted as hidden may be present in the messages table, and this field may be updated when the message is marked as hidden. Users who have access to the recipient-centric mailbox with the hidden message can, upon viewing the message, or in a message list, view an indication as to the time and date that the message was ‘deleted’ by the user.

The above is so that users who have access to recipient-centric mailboxes through the group subscription continue to get a true record of the recipient, from a recipient's perspective despite the fact that the recipient has ‘deleted’ the message.

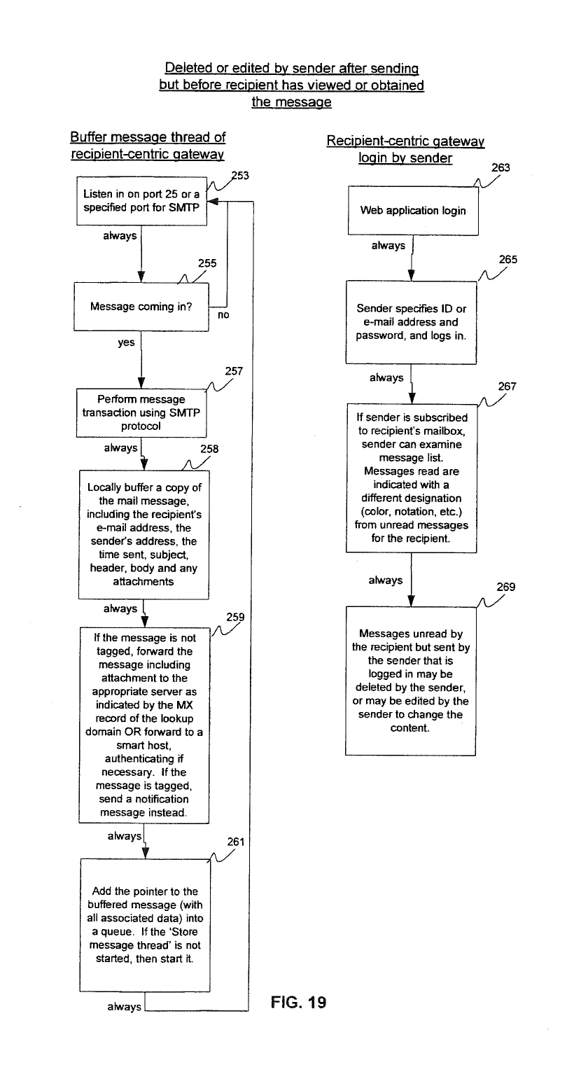

FIG. 19 is a flow diagram where a message can be edited by the sender if not yet read by the recipient, showing steps 253-269.

As shown in FIG. 19, a mechanism is provided where a message can be permanently deleted or edited prior to viewing by the intended recipient. As shown in the recipient-centric buffer message thread, if the sender specifies a tag in the message, the gateway does not send out the original message but instead sends out a notification message to the recipient. The user who is subscribed to a group that contains the recipient authenticates to the account and is presented with a list of recipient-centric mailboxes. The user picks a mailbox, and messages that have been read are marked in a different color than those unread. In one embodiment, when a recipient authenticates into the recipient's account and reads a message, a field in the messages table called ‘date/time read’ is marked with the date and time of the actual read event by the recipient. If this field is the default value, the message has not been read and it is shown as such to the sender of the original message who has access to the recipient-centric mailbox through the group subscription. In such a case, the sender can permanently delete the message or can edit the message if the message is presented in a web browser.

The above is to enable a sender to eliminate a message sent through the recipient-centric gateway, and to enable the sender to change the message. This is useful in the event that the sender wants the option of editing or deleting what was sent but not yet viewed.

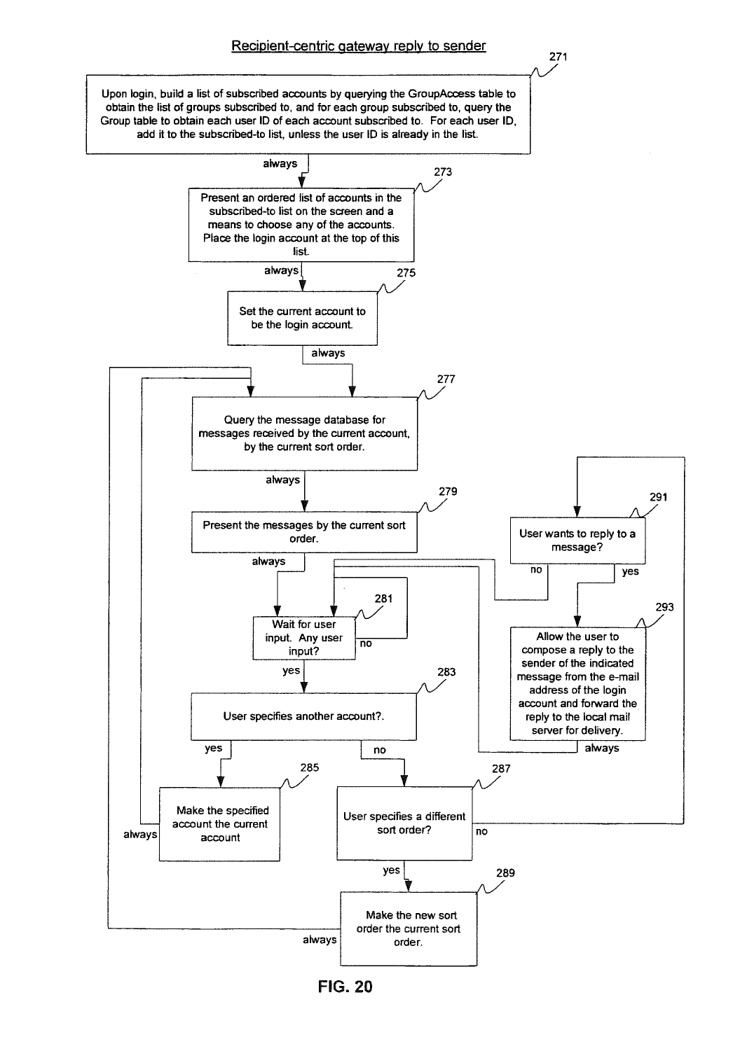

FIG. 20 is a flow diagram where the recipient can reply to the sender through the recipient-centric gateway, showing steps 271-293.

As shown in FIG. 20, the recipient-centric gateway provides a mechanism whereby a recipient can reply with a message to a sender through the gateway. As before, the list of recipient-centric mailboxes is provided to the user, but a reply capability is also provided from within the interface that displays the message. This reply capability exists for messages directed to the authenticated user only, and upon composing a reply, only the original sender of the original message may be designated as the recipient of the reply. The recipient-centric gateway has a local mail server setting and it is to this server to which all replied mail is directed for delivery. This connection is established by the recipient-centric gateway and the mail is forwarded via SMTP.

The above is provided to enable a recipient to reply to a message without leaving the recipient-centric gateway interface. In the event that the organization installing the recipient-centric gateway has specified that sent mail from the recipient should be stored on the recipient-centric gateway, the mail sent through the gateway is stored in the message database and may be queried for the purpose of presenting a listing of sent messages in recipient-centric views. In addition, in the event that the recipient-centric gateway is configured to receive inbound mail via SMTP, passing all inbound mail to the local mail server, the recipient-centric gateway can be configured to make a copy of the inbound e-mail message and store the inbound e-mail message in the message database, for the purpose of presenting the recipient's “sent messages”, i.e. inbound e-mail, to any group members that are authorized to retrieve a recipient-centric view for the recipient.

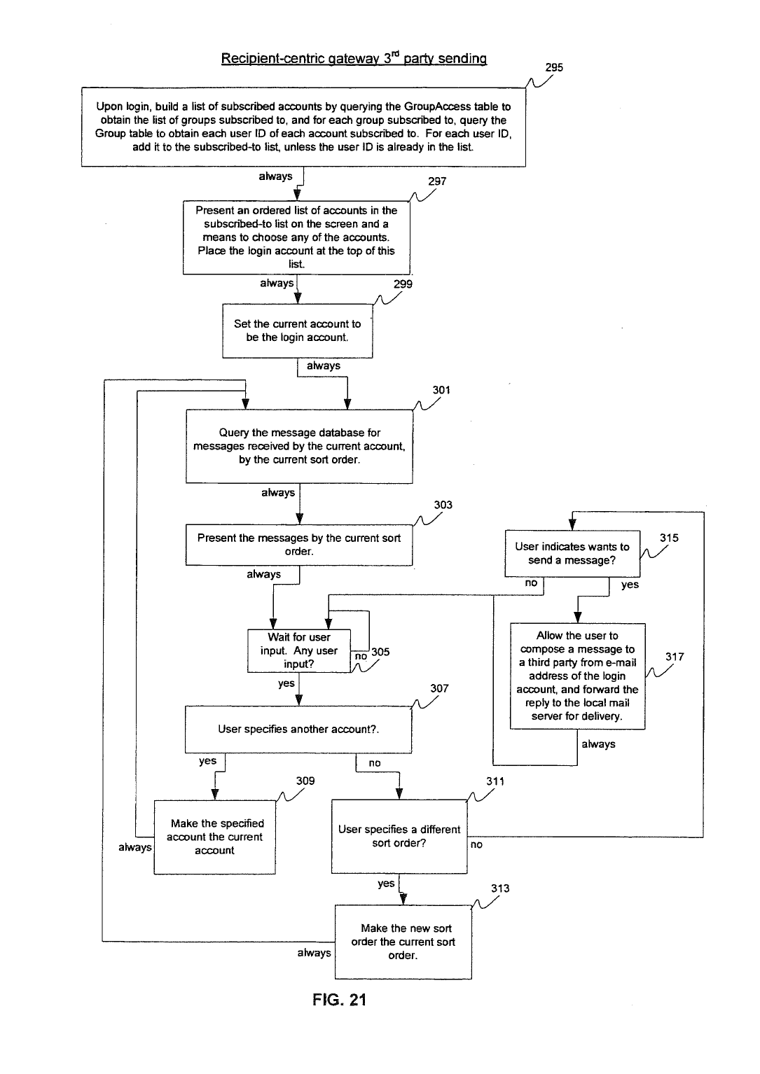

FIG. 21 is a flow diagram where the recipient can send a message to a third party through the recipient-centric gateway, showing steps 295-317.

As shown in FIG. 21, the recipient-centric gateway allows a recipient to send a message to a third party through the gateway. As before, the list of recipient-centric mailboxes is provided to the user, but a compose option is available, and upon composing a message the user is provided with a field for entering the e-mail address to whom the composed message should be addressed. The recipient-centric gateway has a local mail server setting and it is to this server to which all replied mail is directed for delivery. If a tag is specified in the mail message, a notification message is sent instead of the original message. This connection is established by the recipient-centric gateway and the mail is forwarded via SMTP. As usual, a recipient-view is created, this time for the third party recipient, and is stored at the recipient-centric gateway.

The above is provided to enable a recipient to compose a message to a third party without leaving the recipient-centric gateway interface and to allow a recipient to create a third party recipient-centric mailbox so that an administrator can grant access to the third party's recipient-centric view to the original recipient or to other users.

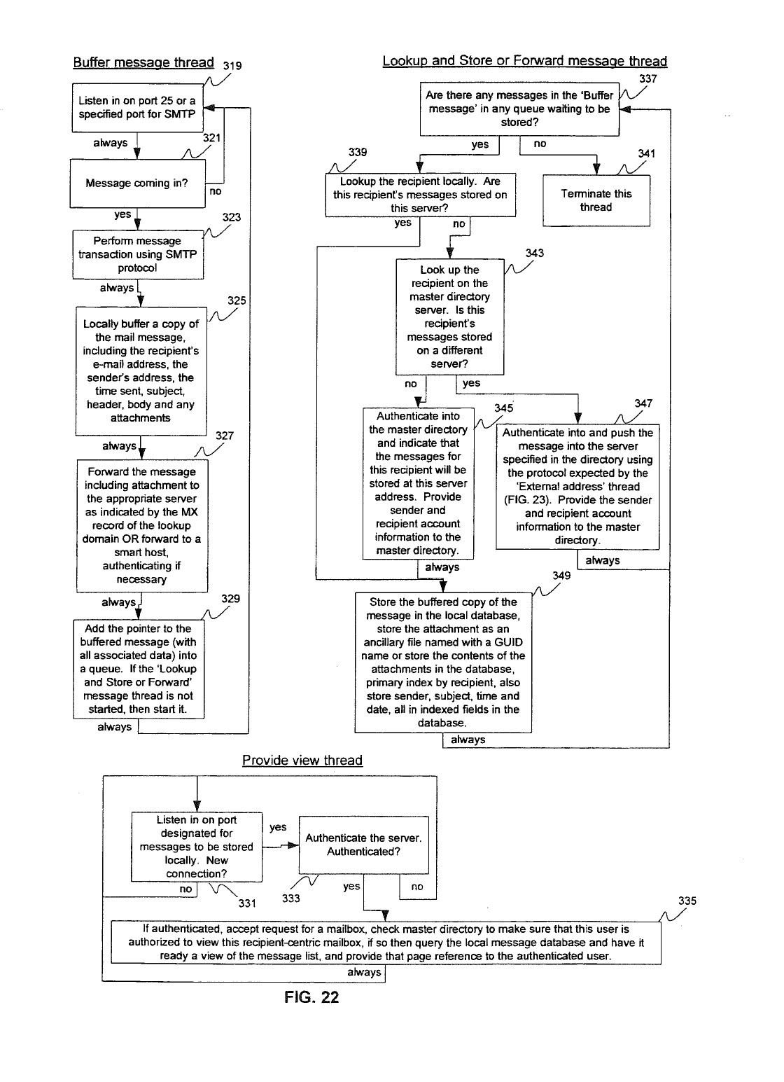

FIG. 22 is a flow diagram showing one of a plurality of recipient-centric message gateways, where a recipient-centric message gateway performs a lookup into the master directory to determine where messages for a particular recipient reside, authenticates into that recipient-centric message gateway, and provides the message to that recipient-centric message gateway for storage, showing steps 319-349.

As shown in FIG. 22, the recipient-centric gateway establishes a recipient-centric mailbox on the server through which the first message to the recipient traverses. The gateway first looks up the recipient on a master directory server the address of which is known to all gateways. If according to the mater directory the recipient's messages are not stored locally, then the gateway authenticates into the server specified in the master directory and presents the message to that server for storage. If the recipient's messages are not stored locally, and a server location for storage is not listed in the master directory, then the gateway authenticates into the master directory and indicates that messages will be stored at this local server, and the initial parameters (i.e. e-mail address) are provided to the master directory server. A copy of the message is then stored locally, and as usual the ‘Buffer Message thread’ causes the message to be sent out on the wire, if so configured.

The ‘Provide view thread’ authenticates incoming requests from other servers and provides a page reference to the recipient-centric mailbox located on the local server, constructed so that it can be invoked from within the authenticating server, so that certain link references refer back to the authenticating server. In this manner pages specified to each recipient-centric mailbox can be presented. This is only performed if the authentication parameters specified for the user provide, per the master directory, that access for the specified recipient-centric mailbox should be permitted, per group designations.

The above is to provide a means by which the recipient-centric gateway can scale up to multiple machines, to handle environments where one server alone is insufficient to bear the load on the recipient-centric system.

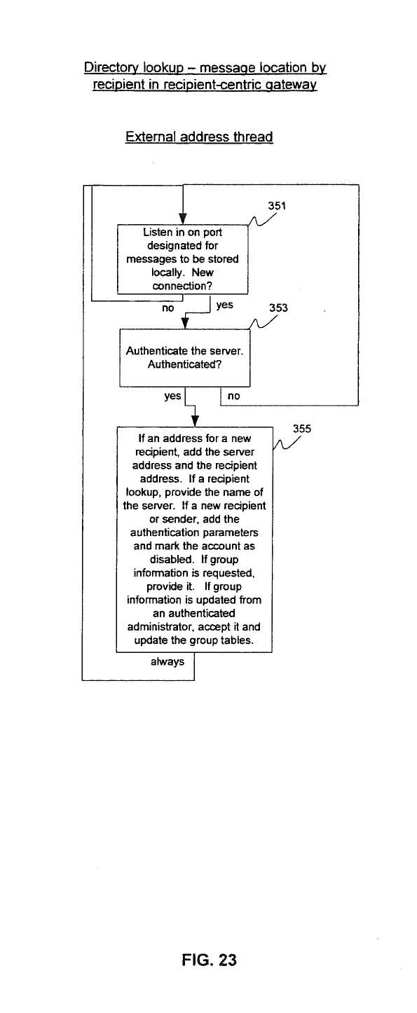

FIG. 23 is a flow diagram of the directory lookup component at a master recipient-centric message gateway, wherein information is available as to which server stores the messages for any particular recipient, showing steps 351-355.

As shown in FIG. 23, the master directory server waits for a server to authenticate and to provide information regarding the transaction. In the event that the authenticated server specifies that it will store a new recipient-centric mailbox, the master directory adds the server address and the recipient address to a table that is used to determine the location of any recipient-centric mailbox. If the authentication parameters are specified for a new recipient or sender, the master directory server adds these parameters to the user's stored information, otherwise it marks the account as disabled. In the event that the request is for a recipient lookup, i.e. where the recipient-centric mailbox is located for that recipient, the master directory server provides the address of the server. In the event group information is requested for a particular user, the master directory server indicates the recipients to which the user is subscribed. In the event that an authenticated server provides authentication parameters for an administrator account, and if the server provides group information, the master directory server accepts that group information and updates the group tables, or indicates to the authenticated server that the information cannot be added, as it conflicts with existing information in the database.

The above provides centralized authentication mechanism and group information storage, as well as indicating where recipient-centric mailboxes reside, when the system is operated across multiple servers for the purpose of scaling up the recipient-centric gateway system.

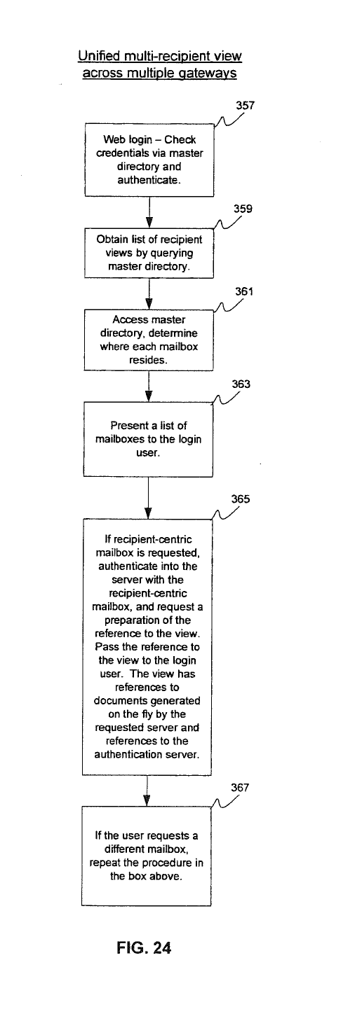

FIG. 24 is a general diagram where a unified presentation to the recipient and/or sender is provided in a multiple recipient-centric gateway environment, showing steps 357-367.

As shown in FIG. 24, the recipient-centric gateway provides a unified view of multiple recipient-centric mailboxes residing on multiple servers by providing the constructed page for each mailbox as provided by each server.

The above provides a mechanism whereby multiple servers can present a single view of a user account that can access multiple recipient-centric mailboxes.

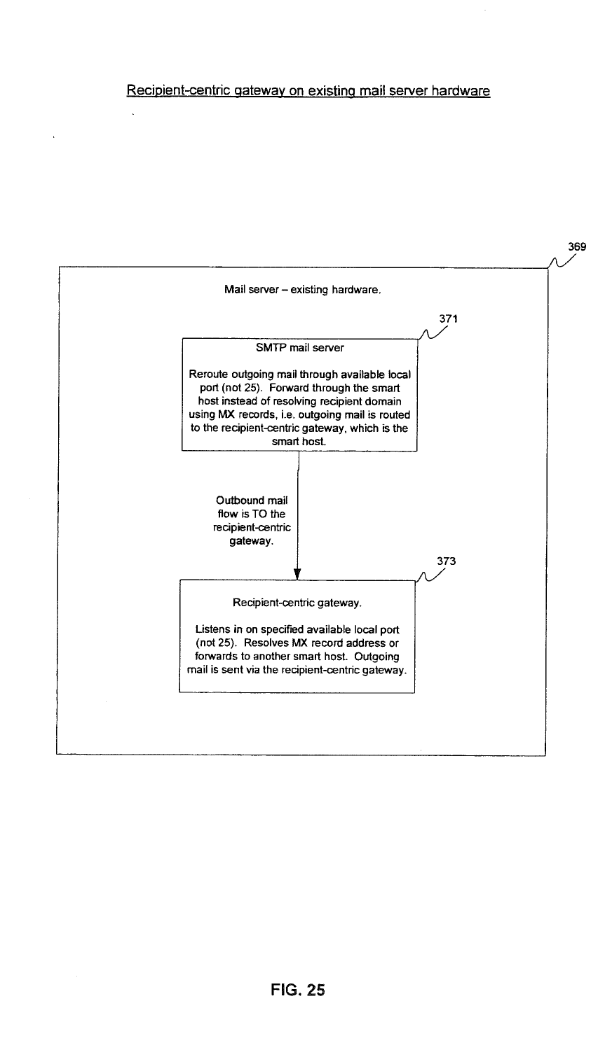

FIG. 25 is a block diagram of the recipient-centric message gateway operating on existing mail server hardware, showing steps 369-373.

As shown in FIG. 25, the recipient-centric gateway can be configured to operate on the same hardware as an existing mail server. The configuration of the existing mail server is set to point the outgoing mail through the mail server's “smart host” setting, which if on the existing hardware will be on localhost, with an as-of-yet unused port. This configuration setting may take the form localhost:xx or 127.0.0.1:xx, for port xx (i.e. a number from 1-65535). The recipient-centric gateway is configured to listen for SMTP traffic on the same port, and the recipient-centric gateway will connect to the SMTP servers as pointed to by the MX records of the domain to which the mail is directed, or will use its own smart host setting and forward the mail to another MTA that will resolve DNS for the outgoing mail.

The above provides that the recipient-centric system can operate on existing hardware, which can reduce the overall cost of the system.

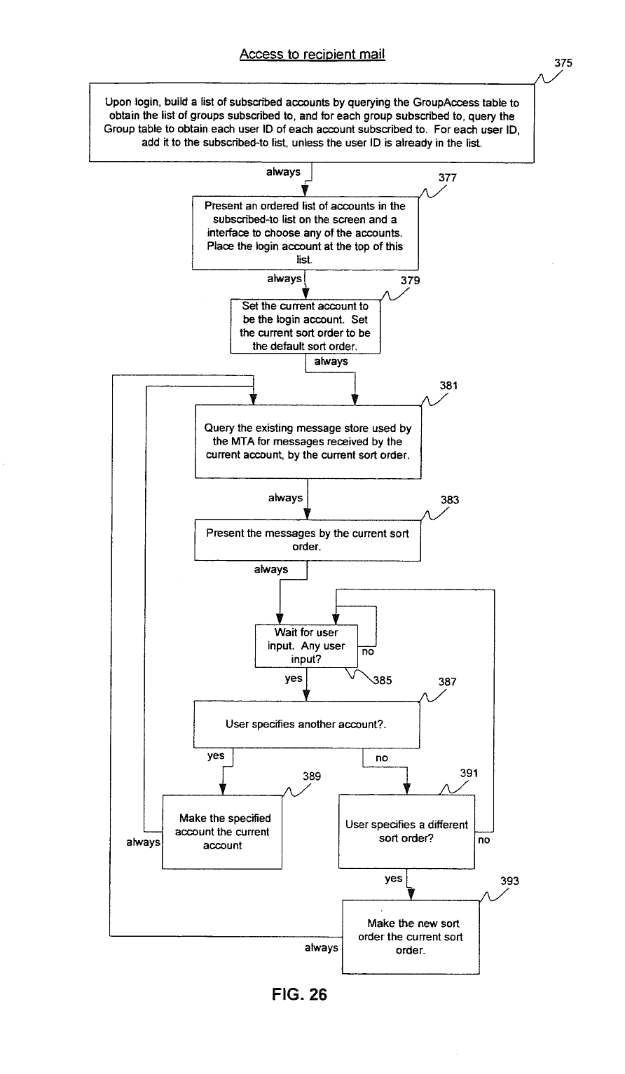

FIG. 26 is a block diagram of the recipient-centric message gateway using an existing server, providing that the existing mail server can be configured to retain all outgoing mail in its own database, showing steps 375-393.

As shown in FIG. 26, where an existing mail store can be modified to retain all outgoing mail, the existing mail store may be used as the database to the recipient-centric gateway. As before, the user that accesses the system is presented with both a list of recipient-centric mailboxes in all groups that the user is subscribed to, and also the ability to access messages within those recipient-centric mailboxes. As shown in FIG. 26, all tables except the messages table are provided by the recipient-centric gateway, however the messages are retrieved from the existing mail store, in the event that the mail store system is capable of and can be programmed to retain all outgoing messages and query those messages by recipient. At initial authenticated access by a user, a list of recipient-centric mailboxes is acquired by obtaining the user reference ID for the authenticated user, querying the GroupAccess table to obtain a list of group reference IDs for the authenticated user, and querying the Group table to obtain the user reference ID and user ID and/or e-mail account for each recipient-centric mailbox, and building a list that contains no duplicates of such recipient-centric mailboxes. To build a list that does not have duplicate entries, the entry for the user reference is only added if it is not currently in the list. The user ID and/or e-mail account for the recipient is then ordered alphabetically or by domain name and then by component of the e-mail address that appears before the ‘@’ sign, and this list is presented in a format where the authenticated user can pick any recipient-centric mailbox. When chosen, the current account is set to the picked recipient-centric mailbox, and the message store message database is queried for messages received by the current account. The query is for messages received by the recipient e-mail address, ordered by either date/time, or message subject, or sender, depending on the sort order specified by the authenticated user. Should the authenticated user click on the message, a message query is constructed and is used to obtain the message from the mail store and the attachment, per the specifications of the mail store database. A limited number of messages header records are pulled (i.e. subject, date/time, sender) that can appear on one screen, with the interface providing a mechanism for moving to prior messages on subsequent screens. The authenticated user can select another account that becomes the current account, and the process repeats itself from the instruction where the system awaits the selection of a current account or of a displayed message.

The above is the mechanism by which an authenticated user that accesses recipient-centric mailboxes is granted access to the group functionality of the system, using an existing mail store that can be programmed to retain outgoing messages as required. This allows designated users to view mail of a recipient from the recipient perspective, from all senders behind the firewall, in the order as received by the recipient, while using an existing mail store database.

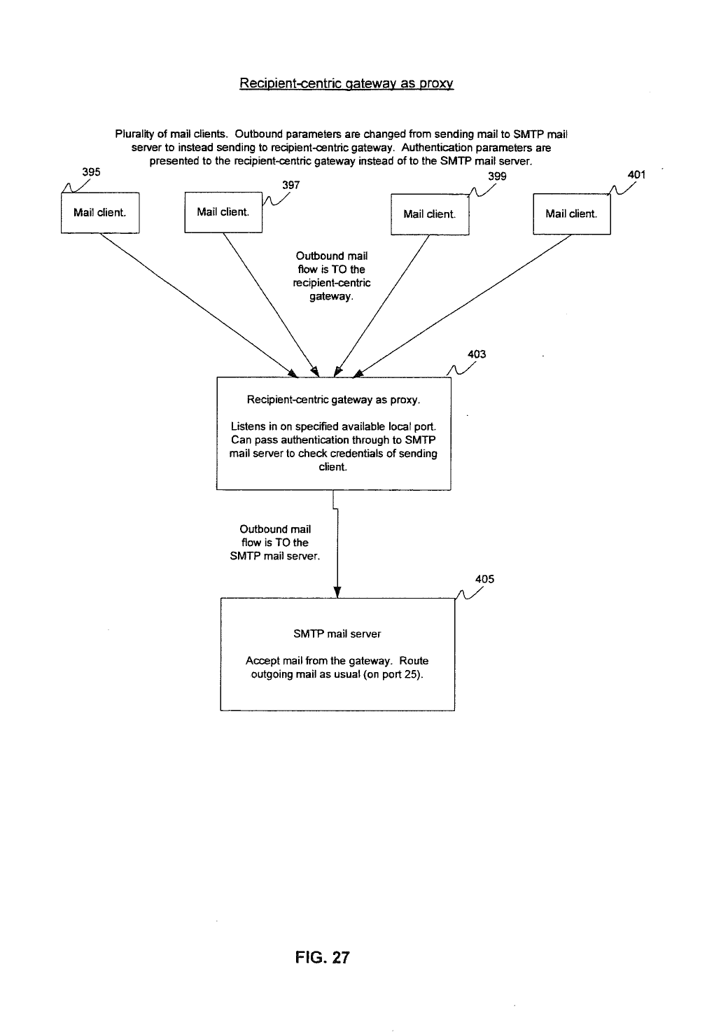

FIG. 27 is a block diagram of a recipient-centric message proxy, where outgoing mail is routed via mail clients through the recipient-centric message proxy that then routes mail to the corporate mail server, showing steps 395-405.

As shown in FIG. 27, the recipient-centric gateway is placed in the network path in a proxy configuration where instead of processing mail after it has traversed through the mail server, it processes mail as it traverses from the mail clients. As shown in FIG. 27, mail clients are reconfigured to point their outgoing SMTP mail to the recipient-centric gateway, instead of to the mail server. Outgoing mail flows from the mail clients to the recipient-centric proxy, which continues to accept the authentication parameters which can either be stored at the recipient-centric gateway, or can be proxied where the recipient-centric gateway first tests the authentication parameters by authenticating into the SMTP mail server for authorized sending of mail. Should the mail client be authorized, the recipient-centric gateway forwards the mail to the server pointed to by the smart host setting of the recipient-centric gateway (i.e. the mail server). Agreed-upon credentials are used to authenticate into the SMTP mail server.

The above is useful in the scenario where the mail server cannot be established by the office or department that controls the mail clients. The above configuration enables a department to independently implement the recipient-centric system without affecting other departments. It also provides a means by which the recipient-centric functionality can be provided even though the mail server resides beyond the corporate firewall.

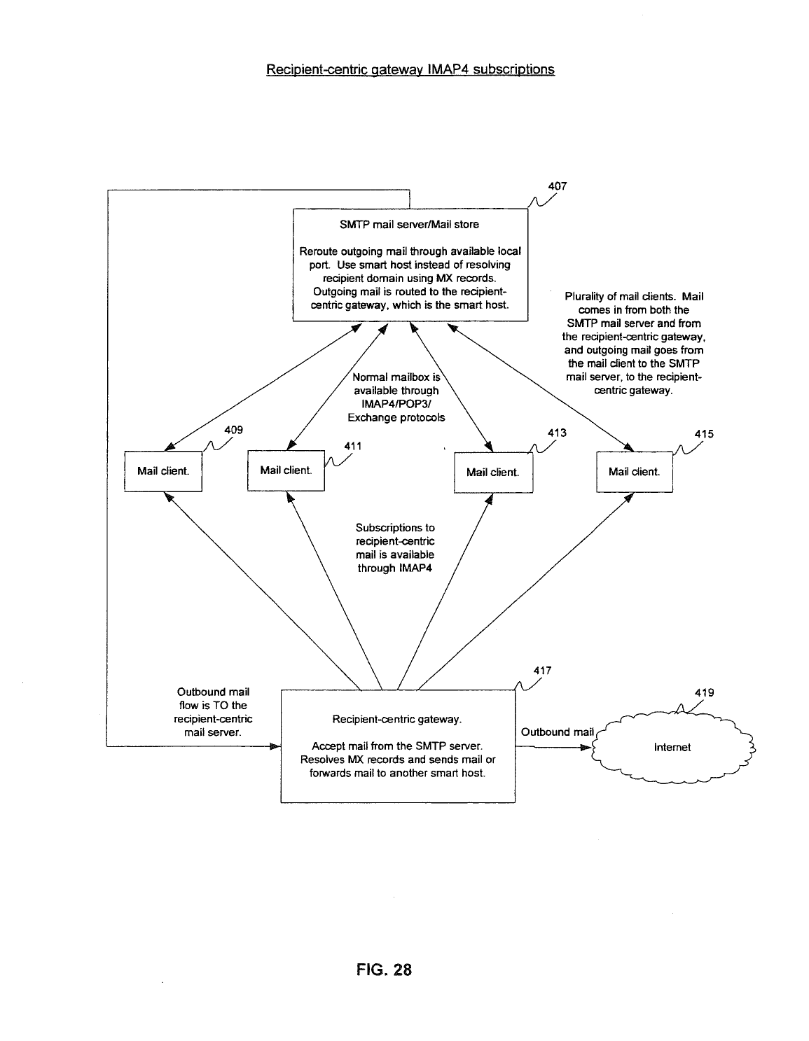

FIG. 28 is a block diagram of the recipient-centric gateway where recipient messages and folders are provided to group member(s) through IMAP4, Exchange or other similar protocol, showing steps 407-419.

As shown in FIG. 28, the recipient-centric gateway can be configured to provide IMAP4 (or other similar protocol) subscriptions of recipient-centric mailboxes to group members who have been provided with access to recipient-centric mailboxes. Mail starts at the mail client and flows outward to the SMTP mail server, which forwards mail to the recipient-centric gateway. Mail is retained at the recipient-centric gateway, and administrators can establish groups, and recipient mailboxes can be made available to such groups as indicated by the administrator. The recipient-centric gateway allows an IMAP4 authentication that corresponds to the password and the user ID for any user, as designated by an administrator, and the recipient-centric gateway performs all read-only IMAP4 functions to group members. This includes retrieving message headers, retrieving messages, etc. Administrators are provided true delete capability through IMAP4, or other protocol that provides similar functionality. Recipients are provided a delete capability that hides the message for the recipient. Group members who do not have administrative capability are not provided with a delete function for mailboxes not their own.

The above allows group members to see recipient-centric mailboxes without entering a different interface, i.e. by using their existing IMAP4 capable mail client.

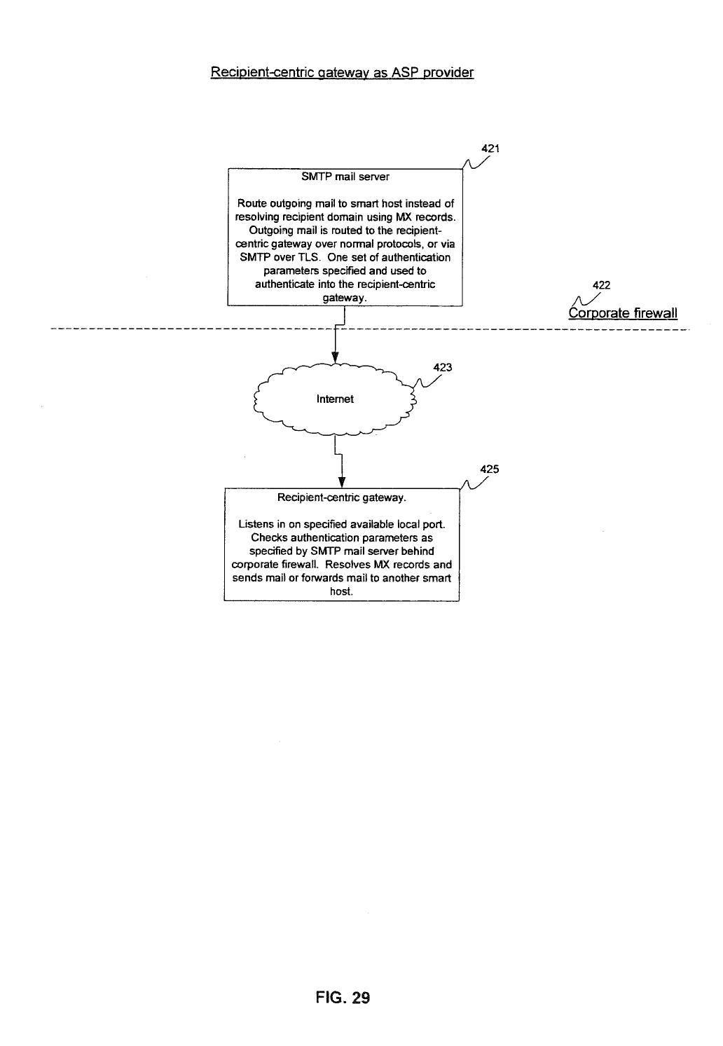

FIG. 29 is a block diagram of the recipient recipient-centric message gateway as an Application Service Provider solution, where only the mail forwarding options on the corporate mail system serviced by the recipient-centric message gateway are changed, where authentication parameters are required to connect to the recipient-centric message gateway, and where SMTP over TLS is optionally used as the mail transfer protocol to the recipient-centric message gateway, showing steps 421-425.

As shown in FIG. 29, the recipient-centric gateway may be established outside the corporate firewall, for use in an application service provider (ASP) scenario. SMTP over TLS is used to communicate agreed-upon credentials to allow the corporate SMTP mail server to forward mail to the recipient-centric gateway, the smart host setting of the mail server set for this purpose. The recipient-centric gateway only accepts mail that is sent from the authenticated SMTP server. Similarly, the IMAP4 capability can be used by authenticating via IMAP4 over TLS, and the authentication parameters are those that the recipient-centric gateway would use for web type authentication (i.e. user ID and password).

This capability is useful in that the system can be provided as a service, where no hardware or software resides at the premises of the user, and where only a change in parameters at the mail server enables the system.

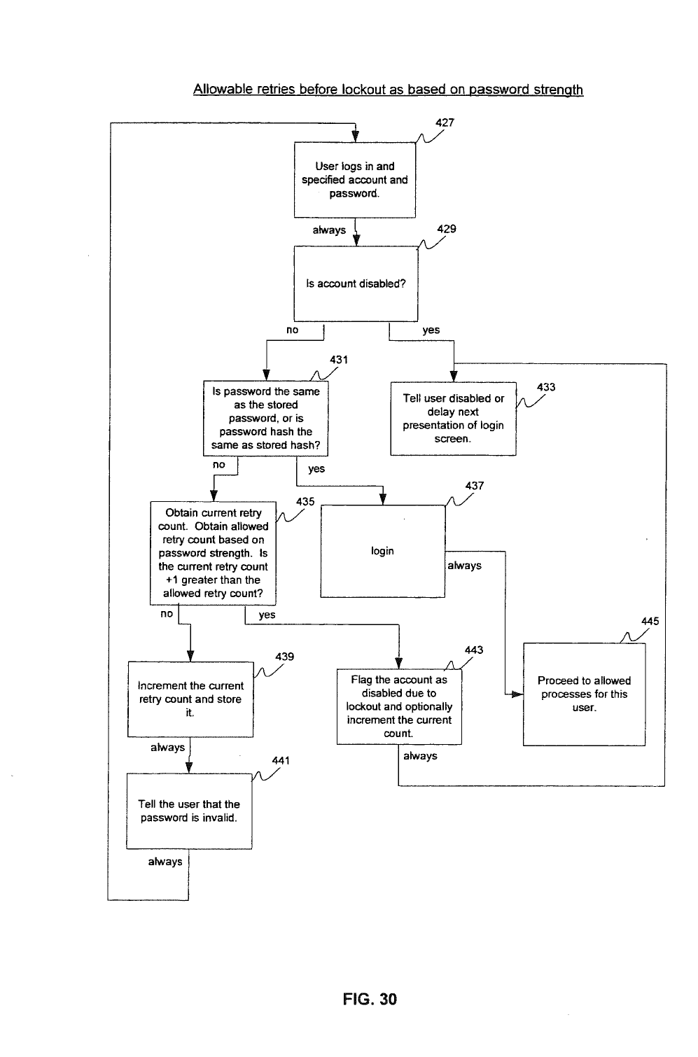

FIG. 30 is a general flow diagram showing a method of determining the retry count based on the strength of the password in a typical login scenario, showing steps 427-445.

As shown in FIG. 30, a system is described that enables the allowed retry count to be determined by password strength. For example, a four digit password with all alphanumerics in upper case may have a strength index of 2, a password in a password hack list may have a password strength of 1, and a twelve digit password that includes upper case, lower case, numeric and symbol characters not appearing in a password hack list may have a password strength of 20. A password strength of 1 may correspond to three tries before lockout, a password strength of 2 may correspond to five tries before lockout, and a password strength of 20 may correspond to fifty tries before lockout. These values are obtained from a table lookup (password hack table), a password strength (count the number of various kinds of characters, and a total character count), and a password strength to retry conversion table. If the hash of the password is stored, then the allowed retry count is determined and stored at the time the password is entered and before it is hashed. Two values are stored, the allowed retry count and the current retry count. If the actual password is stored, then the same storage procedure can be used or the current retry count can be stored and the allowed retry count can be computed at login.

This enables an administrator to allow simplistic passwords, which are very desirable in that they are less likely to require a reset because they are less likely to be forgotten by the user. Because the retry limit is substantially lowered for simplistic passwords, the system is less compromised from a security standpoint than if allowing simplistic passwords and a higher retry limit, and the system requires fewer manual password resets than when using a fixed retry limit.

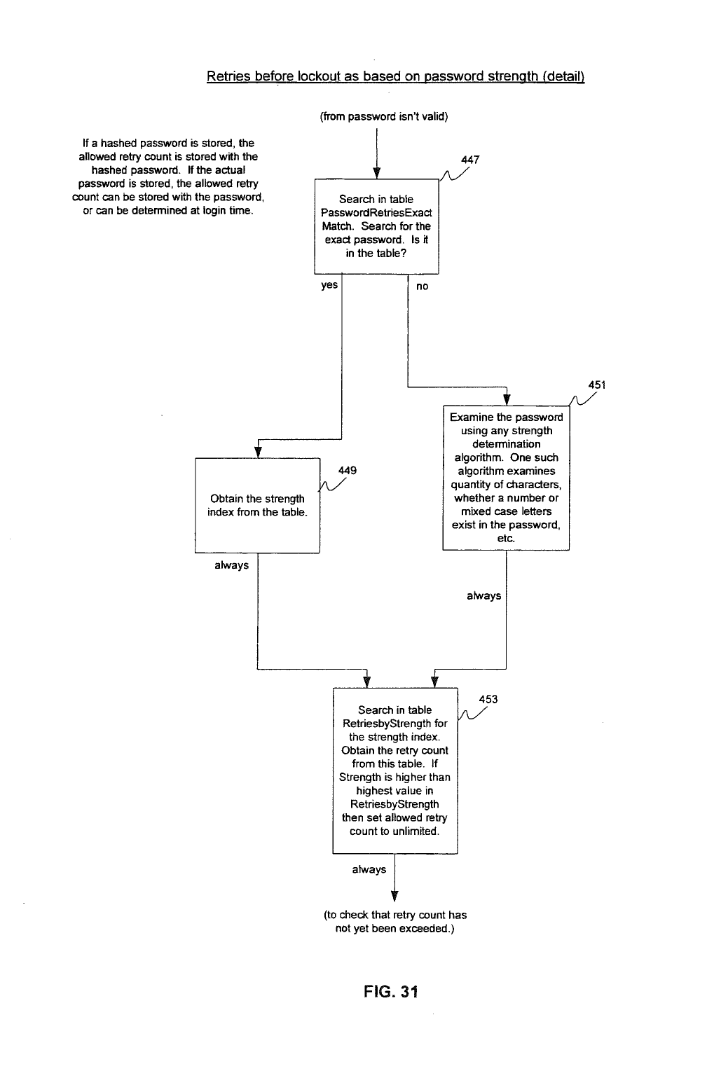

FIG. 31 is a flow diagram of a lockout process based on retry count as determined by password strength, showing steps 447-453.

As shown in FIG. 31, one implementation of the retry system described in FIG. 30 is shown, where the password hack list is searched in a table Password RetriesExactMatch. If the identical password is listed in this table, a corresponding strength index will be obtained from a corresponding field in the record. If the exact match is not found, the strength will be determined. One such method is by counting characters, and by counting characters of a specific type of character, and by counting the different types of characters present in the password. That strength index is then cross-referenced in the RetriesByStrength table and a retry count is obtained which is stored with the password when the password is reset or established. The current retry count is set to zero at password initialization or reset, and when it reaches the allowed retry count the user is locked out of the account.

The above is one implementation of a system that lowers costs as a result of requiring fewer password resets.

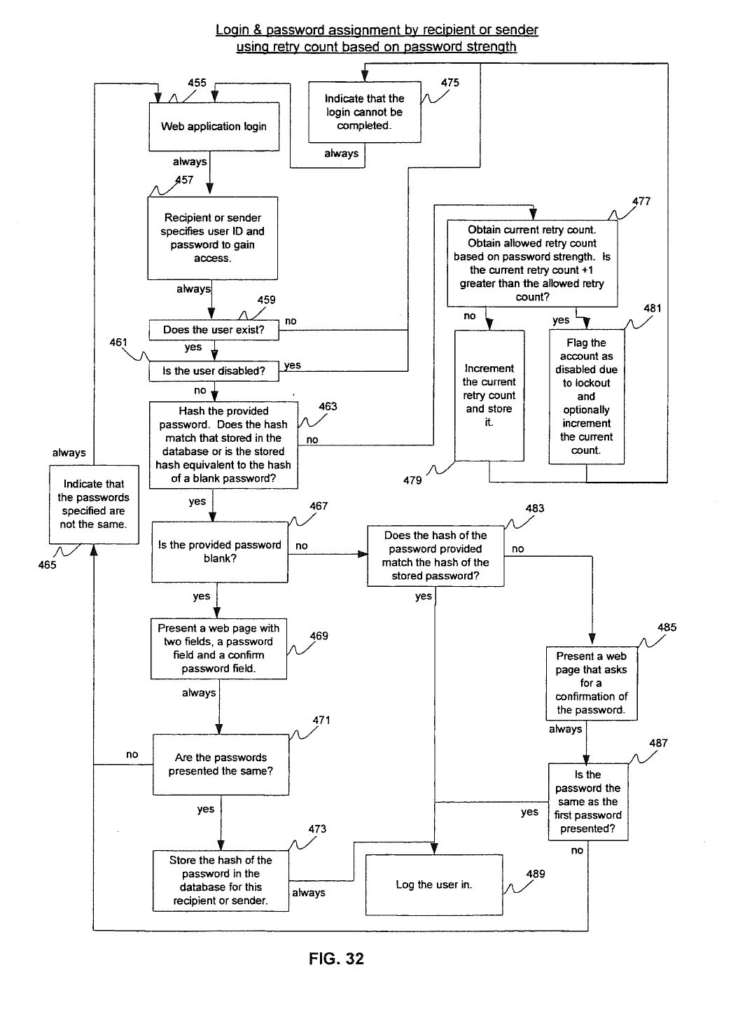

FIG. 32 is a flow diagram of a system that establishes a password by the recipient where the subsequent allowed retry count is determined by password strength, showing steps 455-489.

As shown in FIG. 32, the password retry system is applied in an environment where retries are checked based on password strength, and the initial password can be established by the user. As shown in FIG. 32, the user logs to the system, specifies a user ID and a password, the user ID checked for its existence in a directory. Should the user ID not exist, the system indicates that the login cannot be completed. Should the user ID exist, the system checks to determine if it is disabled, and if disabled the system indicates that the login cannot be completed. Should the user exist and the account not be disabled, the password is hashed and compared against the stored password. If the account has had a password established (i.e. the stored hash is not the equivalent of a hashed blank password, or if a field in the table with the password indicates that the password has been set), then the hash of the password entered is compared against the hash of the password stored. Should these two hashes not be equivalent, the retry count for this recipient is increased by one, the count compared against the previously stored allowed retry count. Should the retry count be equal to the stored retry count, the account is disabled, and optionally a message indicating as such is provided.

As shown in FIG. 32, in the event that the password has not yet been established, and the user specifies a password upon login, a confirmation is requested, and if confirmed the password is hashed and stored in the table that stores the password for this user, and the user is logged in. In the event that the password has not yet been established, and the user specifies a blank password, a password and a confirmation are requested. If these passwords are identical, the password is hashed and stored in the table that stores the password for the user, and the user is subsequently logged in.

The purpose of the above is to reduce costs, and to allow the user to establish a simplistic login password without overwhelmingly degrading system security.

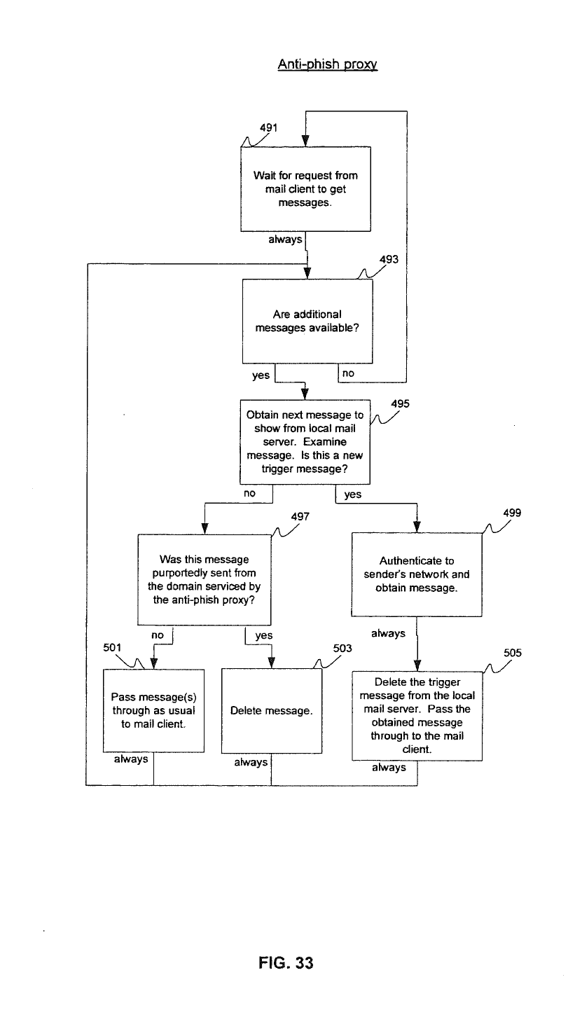

FIG. 33 is a flow diagram of the anti-phish proxy that guarantees that a recipient is not phished with mail purported to be from the sender's e-mail address, downloaded with account name and/or GUID and password and sender's domain, where a trigger message causes the proxy to retrieve new messages from the sending server, and which discards any other message claimed to be from the sender's domain, showing steps 491-505.

As shown in FIG. 33, a proxy sits between the mail client and the local mail server. The proxy waits form request to obtain new messages, proceeds in obtaining the new messages from the corporate mail server and determines if any mail message is a trigger message, i.e. a specially crafted message that contains instructions to the recipient, if read by the recipient where the proxy is not installed or through a web browser, and that causes the proxy to delete the trigger message and instead authenticate into the pre-programmed server address (pre-programmed into the proxy, both server address and authentication parameters), to obtain the actual message. The actual message is then passed to the mail client, the proxy discarding all other messages that arrive from the domain of the server address.

The above enables a sender to guarantee that a recipient is not phished with e-mail from the sending domain, i.e. that mail received by the recipient purported to be from the sender can only be from the sender.

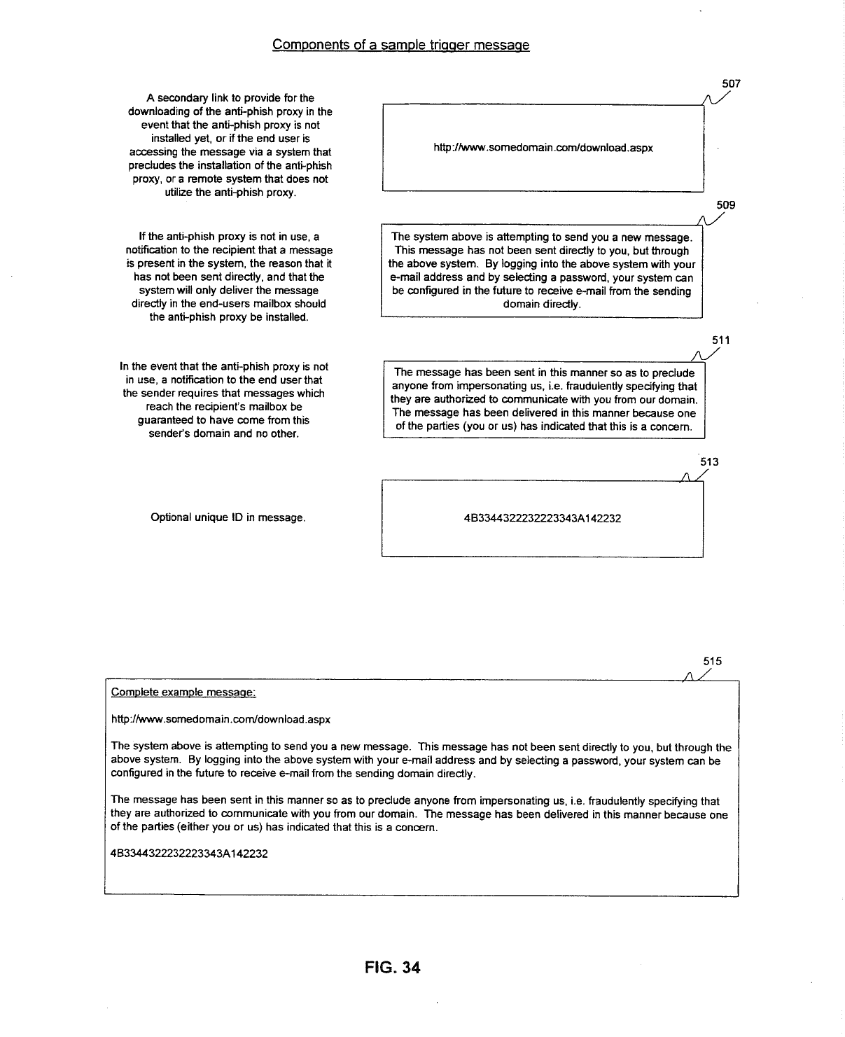

FIG. 34 is a diagram of the construction of the trigger message for the anti-phish proxy, showing steps 507-515.

As shown in FIG. 34, a trigger message may contain several components, some components for the purpose of informing the recipient and some components for the purpose of instructing the recipient in the event that the proxy is not yet installed, or in the event that the mail message is read through an alternative means, i.e. not the mail client on a system on which the proxy is installed. These components are: the secondary link that specifies the location where the proxy component may be downloaded, the informational message as to what function the proxy performs, the reason that the message has been sent in this manner, and an optional unique identifier to the message. Also shown in FIG. 34 is the text of an entire sample message.

The secondary link is provided to enable the recipient to download the anti-phish proxy if it is not yet installed. The informational message is provided to indicate to the recipient that there is a message waiting, and that a procedure is required to acquire it. The informational message is also present to indicate that the proxy guarantees the sender that the recipient is not being phished with messages from the sender's domain.

The message serves a dual purpose, to trigger the anti-phish proxy to recover messages, and to inform the user upon first use how to obtain messages through the system.

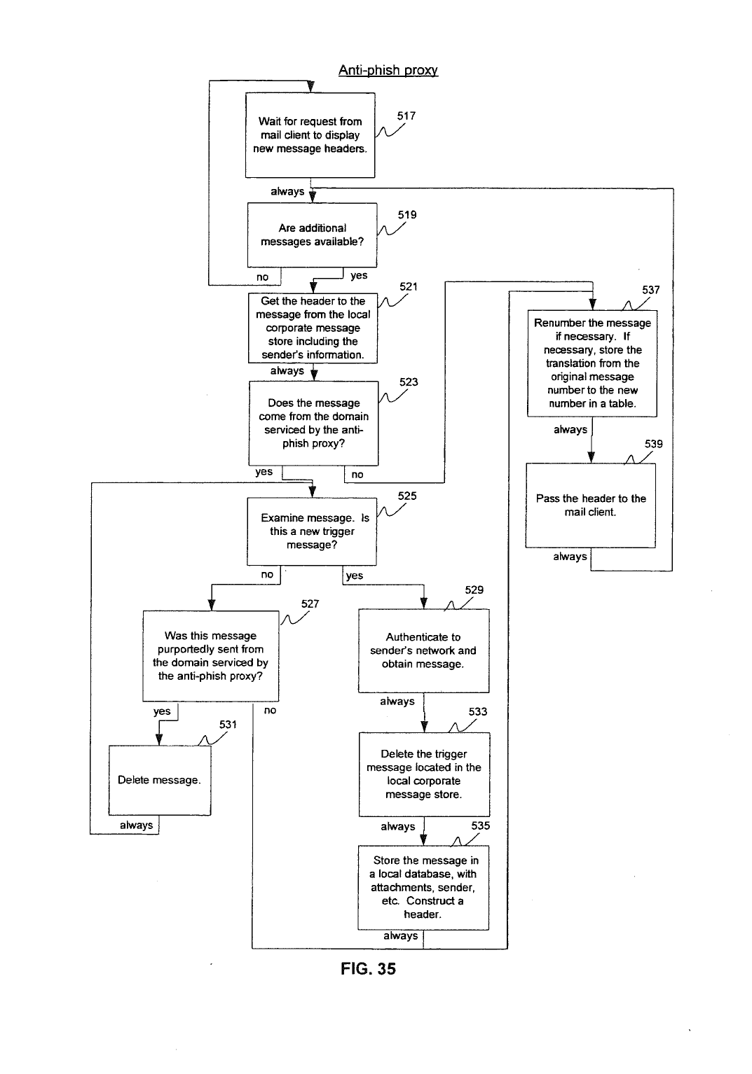

FIG. 35 is a flow diagram of the anti-phish proxy that enables the mail client to display new message headers within an existing mailbox for protocols where the message is retained at the mail store, showing steps 517-539.

As shown in FIG. 35, under protocols like IMAP4 or Exchange where the message is retained at the mail store, the proxy renumbers messages in order to present a unified view of a mailbox to the mail client. When messages headers are requested, i.e. date/time, subject and sender for each message, the anti-phish proxy determines whether the message is purported to have come from the domain that distributed the anti-phish proxy to the recipient, and determines whether this is a trigger message, discarding it or any other message that purports to come from the specified domain from the local mail store. In the event that the message is a trigger message, the proxy connects to the sender's network and obtains the actual message, assigning it a message number per the mail store protocol, and storing that message and the message number in a local database for subsequent retrieval. A header is constructed and that is presented with the appropriate message number when requested by the mail client. Subsequently retrieved messages from the local mail store are numbered with appropriate message numbers, and the translation of these message numbers is also stored in the local table, for subsequent lookup if required.

This enables the anti-phish proxy to present a unified mailbox view of message headers, despite acquiring messages from the local mail server and from the domain that provided the anti-phish proxy.

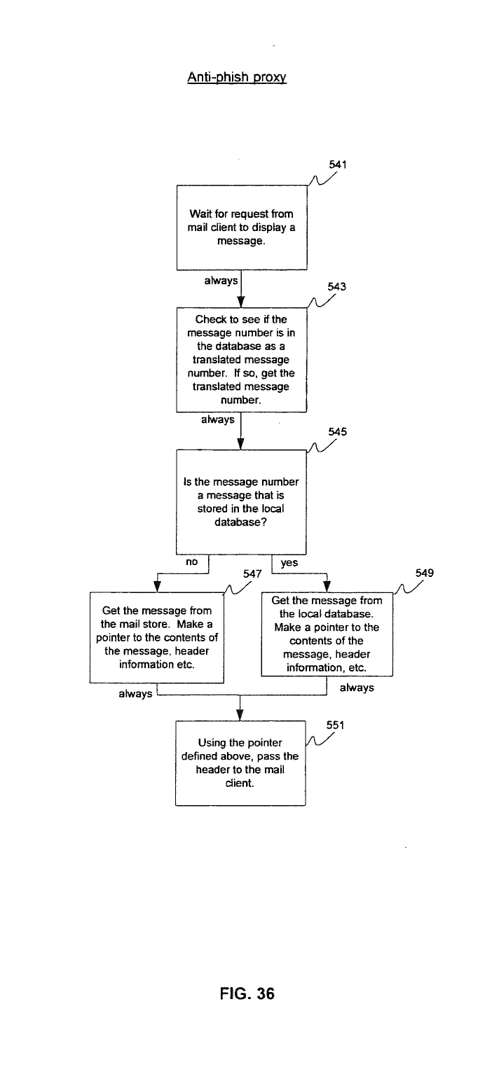

FIG. 36 is a flow diagram of the anti-phish proxy as it presents a single mailbox view to the mail client by combining messages with existing mailbox messages for protocols where the message is retained at the mail store, showing steps 541-551.

As shown in FIG. 36, when the body of a message is retrieved by the mail client, the message is obtained from either the mail store or from the proxy's local anti-phish message database, and an appropriate message number is presented to the mail client.

This enables the anti-phish proxy to present a unified mailbox view of messages, despite acquiring messages from the local mail server and from the domain that provided the anti-phish proxy.

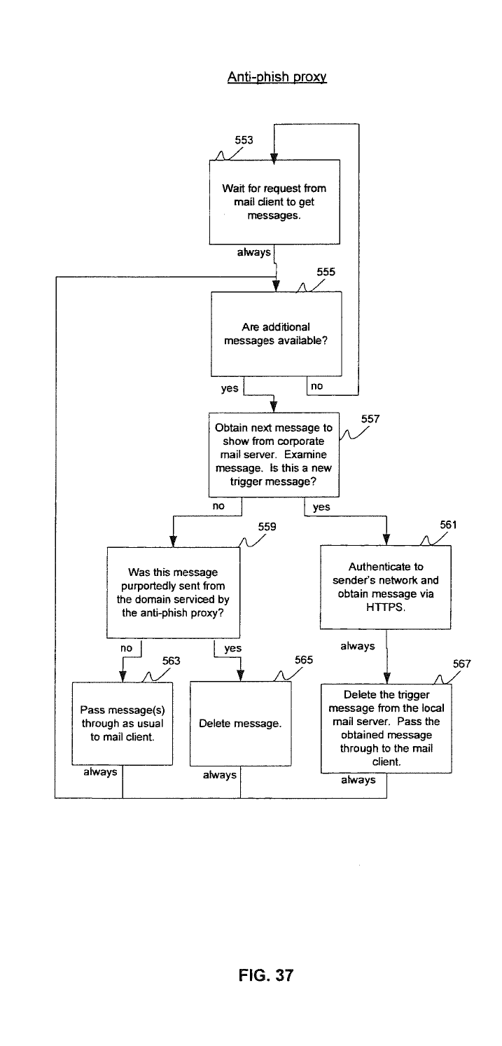

FIG. 37 is a flow diagram of the anti-phish proxy that uses a firewall traversing protocol, showing steps 553-567.

As shown in FIG. 37, the anti-phish proxy uses HTTPS to acquire the message from the domain that provided the anti-phish proxy.

This enables the anti-phish proxy to traverse the corporate firewall without requiring any special configuration of the recipient's network. This simplifies the installation of the proxy.

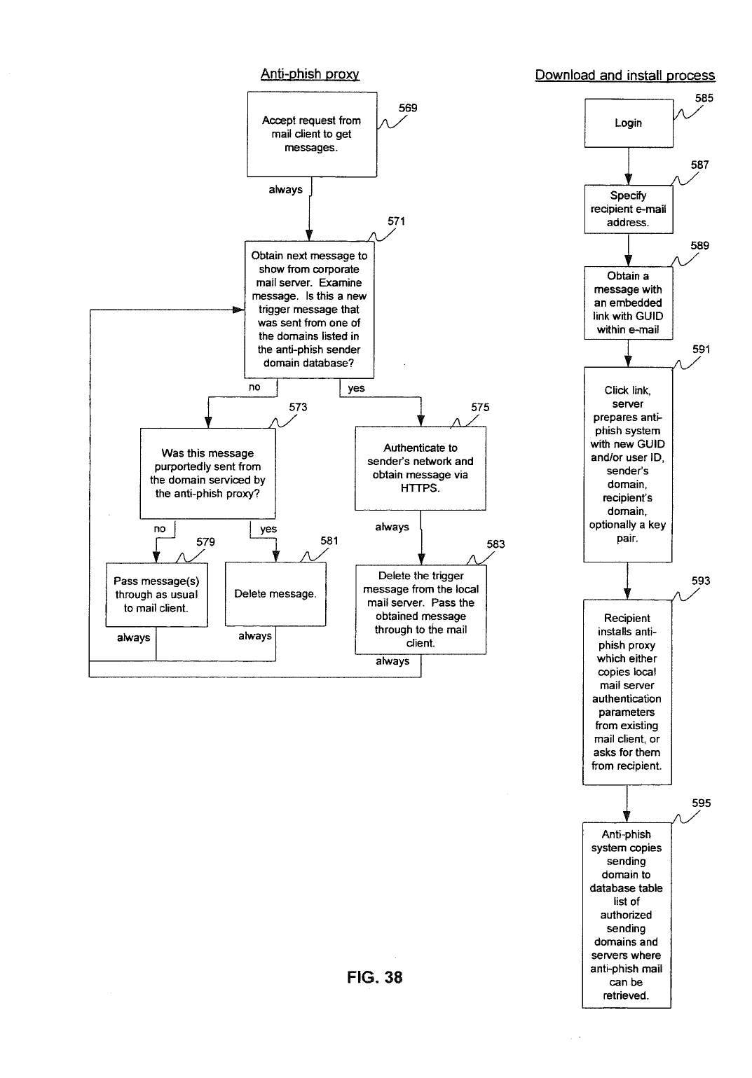

FIG. 38 is a flow diagram of the anti-phish proxy where access to additional sending servers is added and managed subsequent to the initial download and proxy installation and includes a flow diagram of the download and installation process, showing steps 569-595.

As shown in FIG. 38, the anti-phish proxy, upon first use, creates a version specific to the recipient, which includes the recipient's user ID and/or e-mail address, and optional GUID to indicate the specific installation, and the name of the server to which the proxy should authenticate to retrieve messages. In the event that the installation process encounters a previously installed anti-phish proxy, the proxy is not reinstalled, only the stored list of servers and authentication parameters is updated.

This enables the anti-phish proxy to service multiple domains, so that it can guarantee senders at multiple domains that the recipient will not receive phished e-mail from those domains.

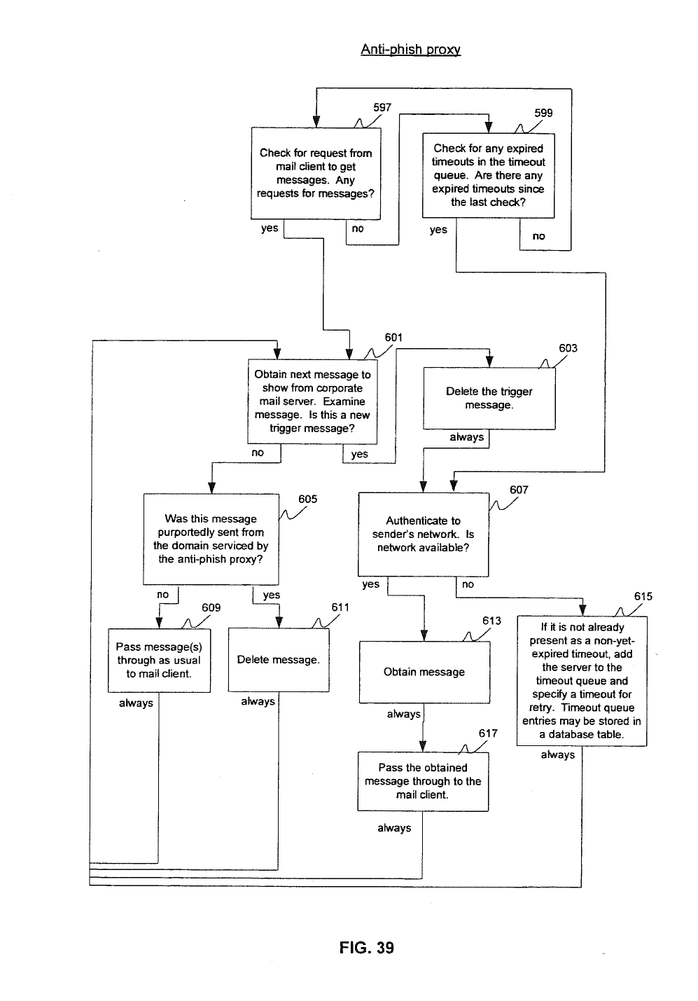

FIG. 39 is a flow diagram of the anti-phish proxy that has a timeout period when messages aren't available and establishes a queue for later retrieval, showing steps 597-617.

As shown in FIG. 39, in the event that the server is not available (i.e. the server from which messages guaranteed to be from the sender are retrieved), a queue is established so that the anti-phish proxy schedules retrieval at a later time. The trigger message is deleted immediately and a queue is established if it the sender's network is not available.

This enables the domain that services the anti-phish proxy to be unavailable due to servicing or lack or connectivity, so that messages bound for the recipient are not dropped or lost.

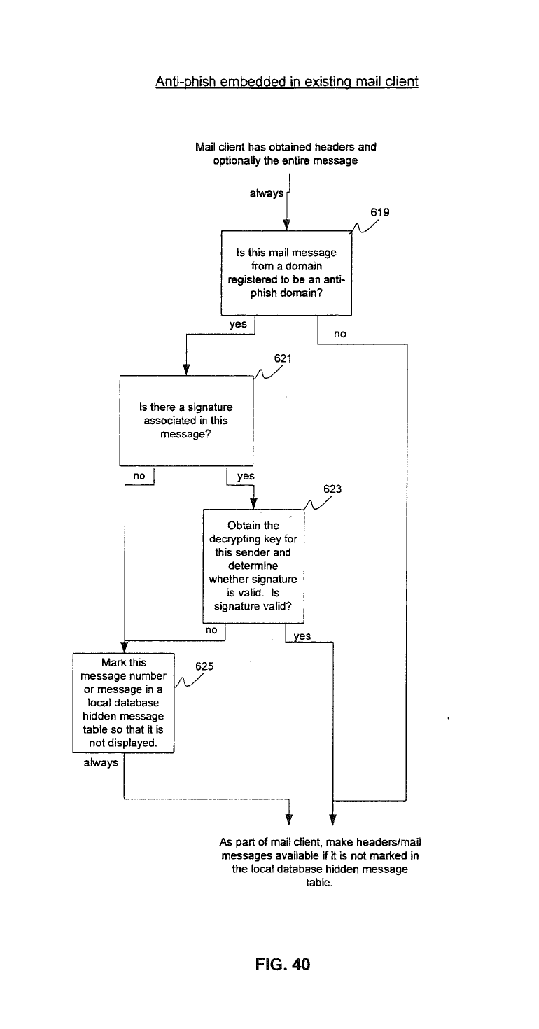

FIG. 40 is a flow diagram of the anti-phish proxy functionality embedded into an existing mail client, which rejects mail sent from the sending domain other than mail signed by the actual sender, showing steps 619-625.

As shown in FIG. 40, the anti-phish proxy capability may be incorporated into an existing mail client. In the event that the code for the anti-phish proxy is compiled into an existing mail client, the hook to the anti-phish proxy code is within the iterative process where the mail client retrieves headers for each mail message. The additional code determines whether the mail message comes from a domain registered with the modified mail client as a domain that only permits mail to be received if it is guaranteed to have come from the sending domain. Signatures in messages purported to be sent from the sending domain are determined to be valid, those message headers (and subsequently message bodies) allowed to be displayed, all others from this domain marked as hidden and not displayed.

This is a method whereby an existing mail client can preclude recipients from being phished at the recipient mail client for multiple sending domains by maintaining a list of sending domains that have this requirement.

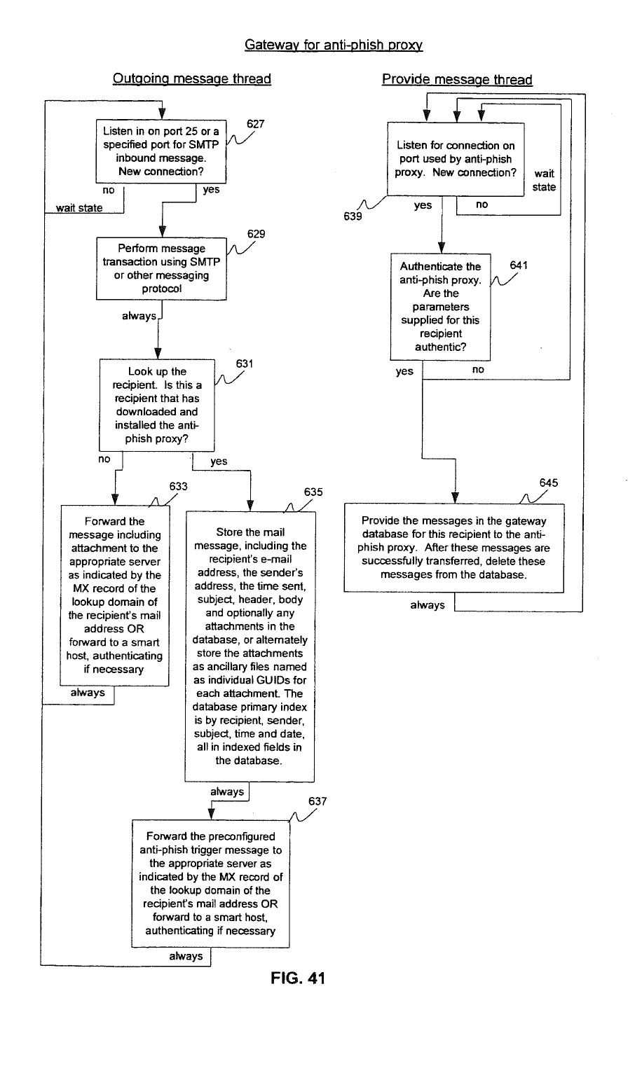

FIG. 41 is a flow diagram of a gateway that retains messages and provides them to the authenticated, retrieving anti-phish proxy. The gateway keeps a record of which recipient downloaded the proxy and accordingly sends the trigger message instead of the actual message, showing steps 627-645.

As shown in FIG. 41, the gateway determines whether the recipient has installed the anti-phish proxy by looking up that information in a table, the information having been provided by the system that was notified that a successful installation occurred, such a system normally residing on the gateway. If the proxy was installed, the gateway retains the sent message and instead sends a trigger message. Additionally, the gateway listens for authenticated connections from one or more anti-phish proxies, and provides new messages to authenticated proxies.

This is so that the messages are provided to one or more anti-phish proxies to guarantee that the messages do, in fact, come from the sender, and that all other messages claimed to be from the sending domain can, in fact, be discarded.

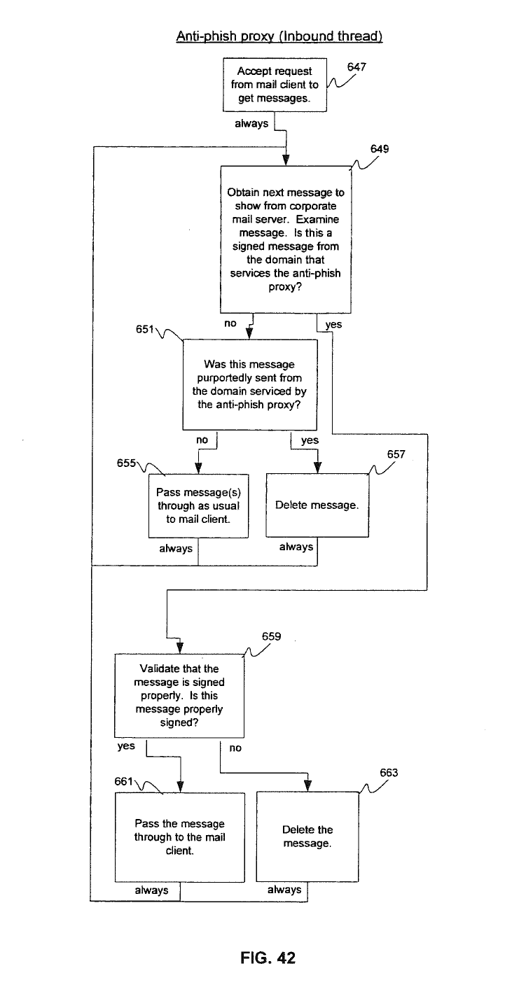

FIG. 42 is a flow diagram of an anti-phish proxy that guarantees that a recipient is not phished with sender's e-mail address by deleting any message purportedly from the sender but not signed with the sender's signature, showing steps 647-663.

As shown in FIG. 42, this embodiment of the anti-phish proxy checks the signature of any message sent from the domain serviced by the gateway, and if valid presents the message to the mail client, discarding any others. The gateway that services the anti-phish proxy signs all outgoing message.

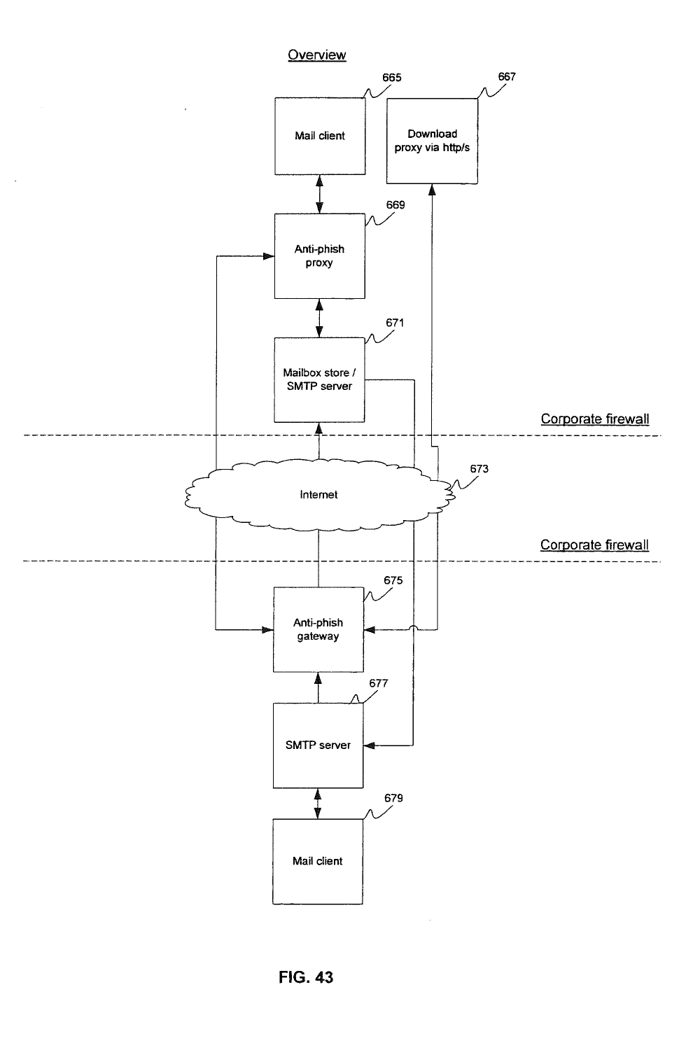

FIG. 43 is a general diagram of the anti-phish proxy interoperating with the gateway at the sender, showing steps 665-679.

As shown in FIG. 43, the anti-phish proxy sits between the mail client and the recipient's mail server, the trigger message providing a mechanism whereby the proxy may be downloaded from the gateway, the successful proxy installation recorded by the gateway, and where the anti-phish proxy communicates with the mail client, the local mail server, and the anti-phish gateway.

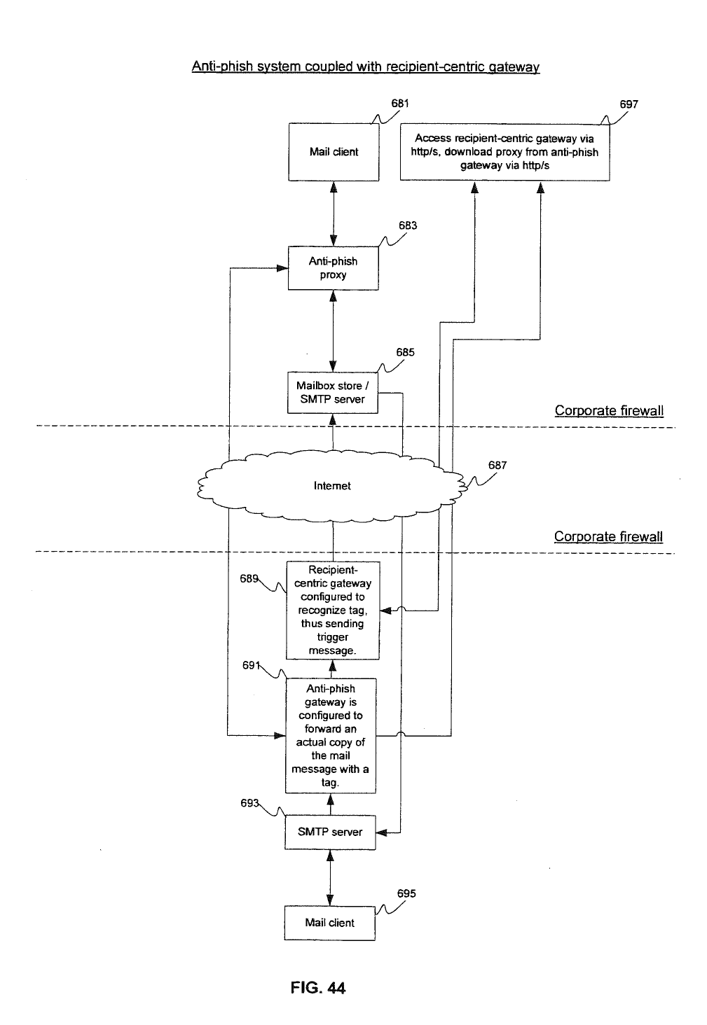

FIG. 44 is a block diagram of the anti-phish system operating with a recipient-centric gateway, showing steps 681-697.

As shown in FIG. 44, the anti-phish gateway places a tag into actual (not trigger messages) outgoing mail messages, and sends the actual message (not the trigger message) through the gateway, causing the recipient-centric gateway to retain the actual message and send a specially configured trigger message instead. The specially configured trigger message specified to the recipient-centric gateway is an anti-phish trigger message that includes a recipient-centric login and the anti-phish download link, and that causes the anti-phish proxy to download the mail message from the anti-phish proxy, but also enables the recipient at a webmail system to log to the recipient-centric gateway to retrieve the message or enables a user to download the anti-phish proxy.

This provides the functionality of both systems, i.e. the ability to view correspondence from the recipient perspective as sent by the corporate entity, and to guarantee that the recipient is not phished at the proxied mail client with e-mail purportedly by the sending entity.

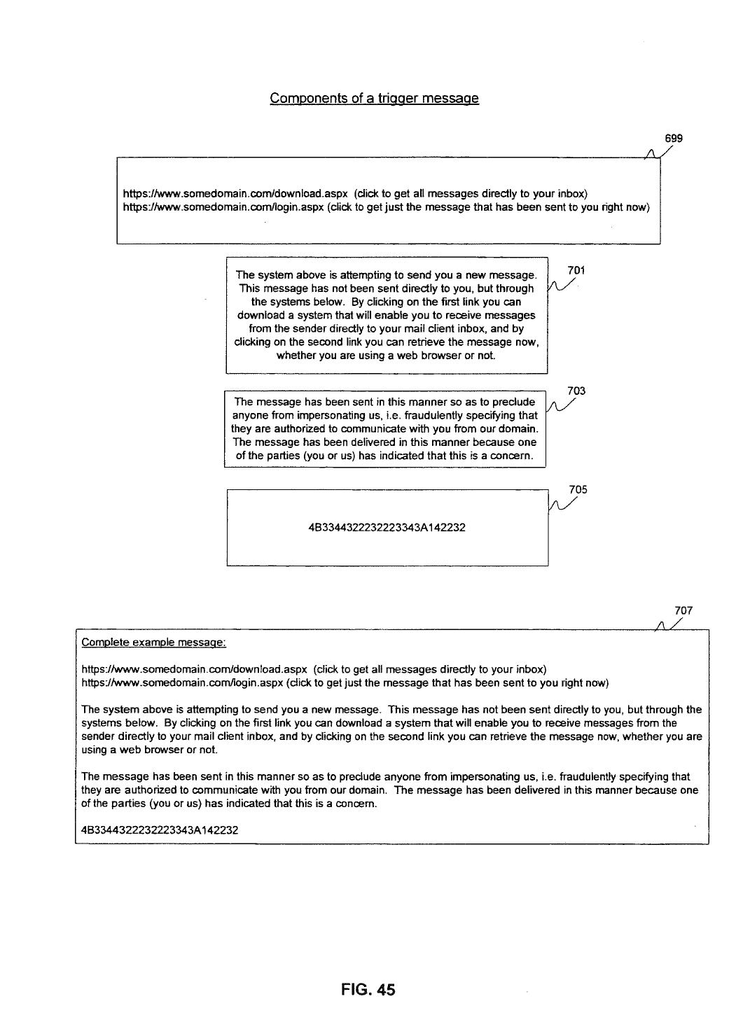

FIG. 45 is a block diagram of the construction of the trigger message for the anti-phish proxy used in conjunction with the recipient-centric gateway, showing steps 699-707.

As shown in FIG. 45, the trigger message for use with both the anti-phish gateway and the recipient-centric gateway provides a link for downloading the proxy, and a link for recovering the messages stored at the recipient-centric gateway.

This is specially constructed message that enables the functionality of both the recipient-centric gateway and the anti-phish system.

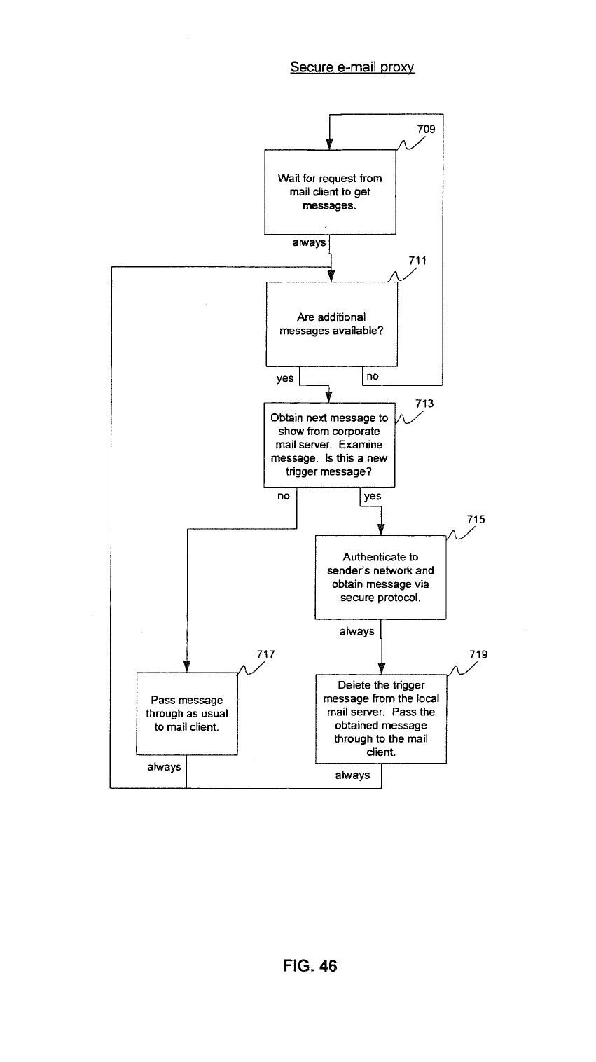

FIG. 46 is a flow diagram of a secure e-mail proxy, downloaded with account name and/or GUID and password used to authenticate into the sending server, where a trigger message causes the secure e-mail proxy to attempt to retrieve new messages from the sending server via a secure protocol, showing steps 709-719.

As shown in FIG. 46, a proxy sits between the mail client and the local mail server. The proxy waits for a request to obtain new messages, proceeds in obtaining new messages from the local mail server and determines if any mail message is a trigger message, i.e. a specially crafted message that contains instructions to the recipient, if read by the recipient where the proxy is not installed or through a web browser, and that causes the proxy to delete the trigger message and instead authenticate via a secure protocol into the pre-programmed server address (pre-programmed into the proxy, both server address and authentication parameters), to obtain the actual message. The actual message is then passed to the mail client.

The above enables a sender to securely send a message to a recipient, from the sender's corporate network to the recipient's desktop.

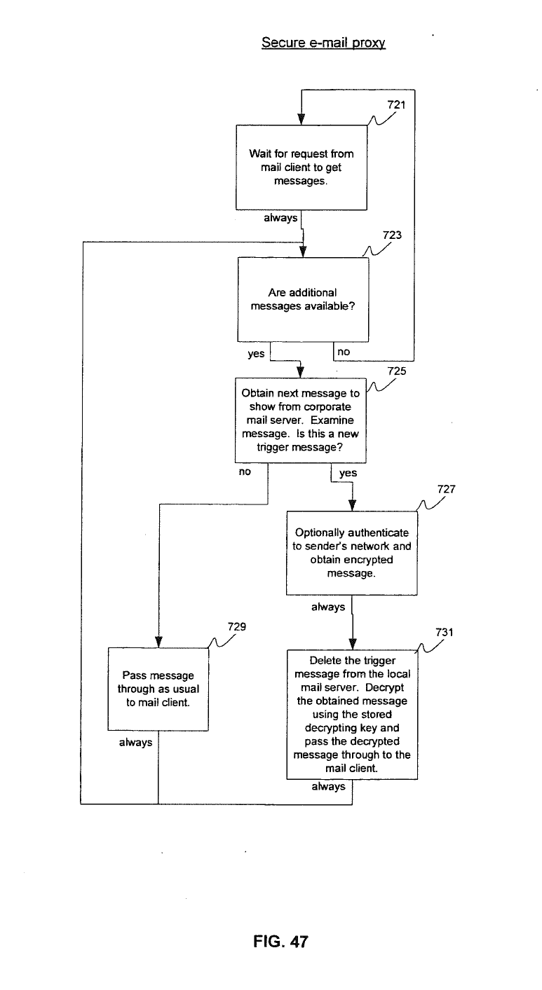

FIG. 47 is a flow diagram of a secure e-mail proxy, downloaded with GUID and key pair, where a trigger message causes the secure e-mail proxy to attempt to retrieve new messages from the sending server, showing steps 721-731.

As shown in FIG. 47, a proxy sits between the mail client and the local mail server. The proxy waits for a request to obtain new messages, proceeds in obtaining the new message from the local mail server and determines if the mail message is a trigger message, i.e. a specially crafted message that contains instructions to the recipient, and causes the proxy to take action, in the process modifying the resulting e-mail as presented by the mail client. The trigger message can be read by the recipient where the proxy is not installed or through a web browser, and causes the proxy to delete the trigger message and instead obtain from the server at the pre-programmed server address (pre-programmed into the proxy, both server address and authentication parameters), an encrypted message, the proxy performing the decryption using the decrypting key provided with the proxy.

The above enables a sender to securely send a message to a recipient, from the sender's corporate network to the recipient's desktop without requiring a secure communications channel to transfer the message.

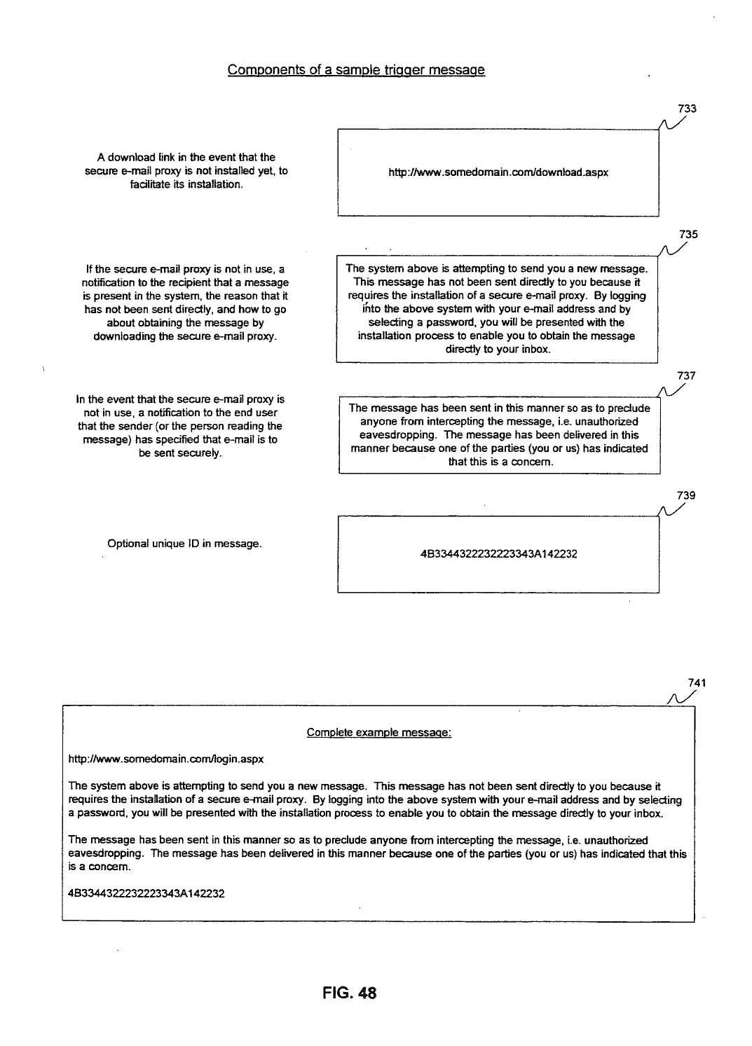

FIG. 48 is a diagram of the construction of the trigger message for the secure e-mail proxy, showing steps 733-741.

As shown in FIG. 48, a trigger message may contain several components, each component for the purpose of informing the recipient as well as instructing the recipient in the event that the proxy is not yet installed, or in the event that the mail message is read through an alternative means, i.e. not via the mail client on a system on which the proxy is installed. These components of the trigger message are: the download link where the proxy component may be installed, the informational message as to what function the proxy performs, the reason that the message has been sent in this manner, and an optional unique identifier to the message. Also shown is the text of an entire sample message.

The download link is provided to enable the recipient to download the secure e-mail proxy if it is not yet installed. The informational message is provided to indicate to the recipient that there is a message waiting, and that a procedure is required to acquire it. The informational message is present to indicate that the reason for the proxy is to provide confidentiality in the communication of the message.

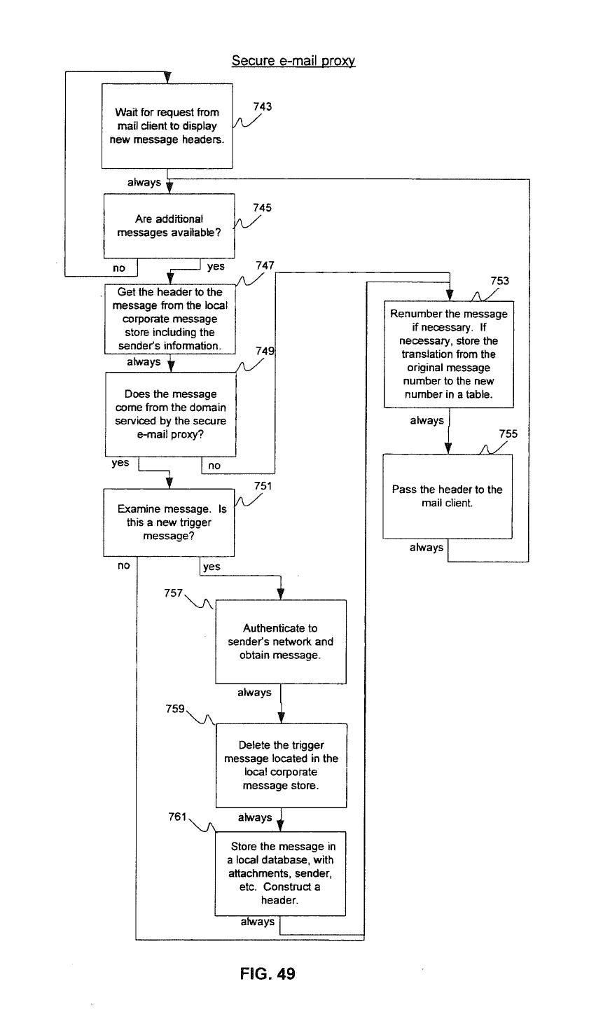

FIG. 49 is a flow diagram of the secure e-mail proxy that enables the mail client to display new message headers within an existing mailbox for protocols where the message is retained at the mail store, showing steps 743-761.

As shown in FIG. 49, under local recipient protocols like IMAP4 or Exchange where the message is retained at the mail store, the proxy can renumber messages in order to present a unified view of a mailbox to the mail client. When additional messages are requested, specifically additional message headers, i.e. date/time, subject and sender, the secure e-mail proxy determines whether the incoming message is a trigger message, and discards it. In the event that the message is a trigger message, the secure e-mail proxy connects to the sender's network and obtains the message, assigning it a message number per the mail store protocol, and storing that message and the message number in a local database for subsequent retrieval. A header is constructed and that is presented, with the appropriately sequenced message number to the mail client. Subsequently retrieved messages from the local mail store are numbered with appropriate message numbers, and the translation of these message numbers is also stored in the local table.

This enables the secure e-mail proxy to present a unified mailbox view of message headers, despite acquiring messages from the local mail server and from the sending domain that provided the secure e-mail proxy.

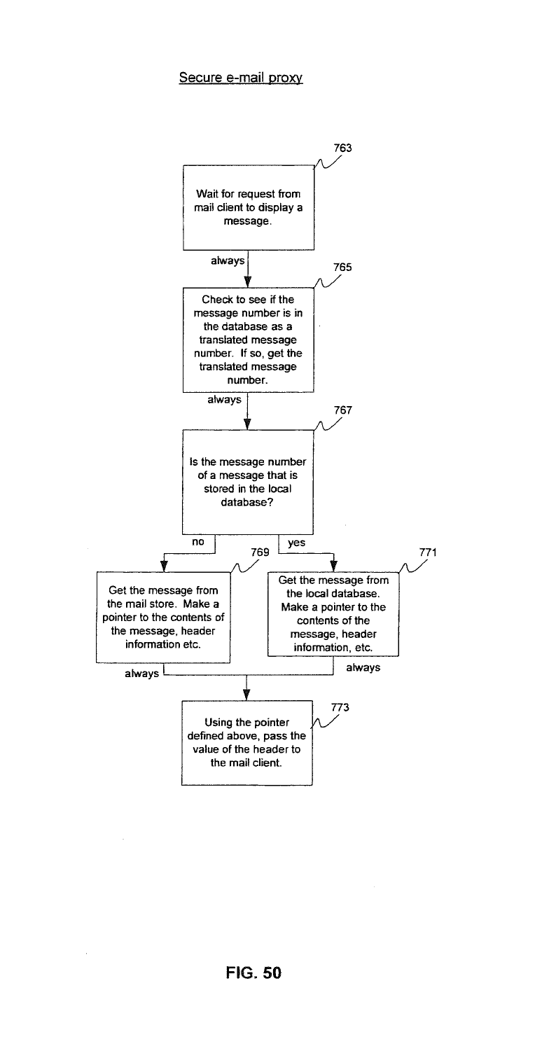

FIG. 50 is a flow diagram of the secure e-mail proxy that combines messages with an existing mailbox for various protocols, showing steps 763-773.

As shown in FIG. 50, when the body of a message is retrieved by the mail client, the message is obtained from either the mail store or from the local secure e-mail message database, and an appropriate message number is presented to the mail client.

This enables the secure e-mail proxy to present a unified mailbox view of messages, despite acquiring messages from the local mail server and from the domain that provided the secure e-mail proxy.

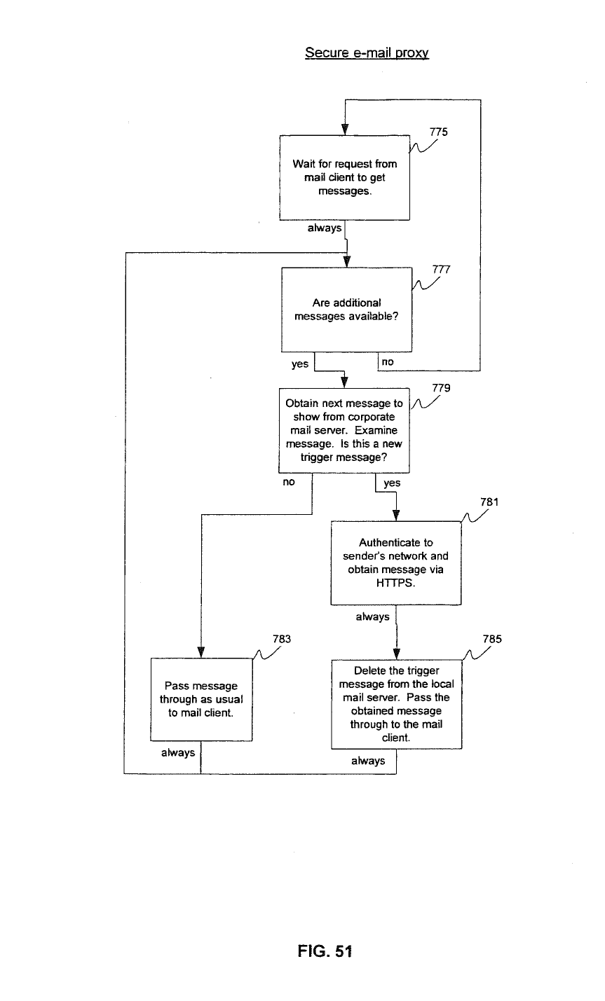

FIG. 51 is a flow diagram of the secure e-mail proxy that uses a firewall traversing protocol, showing steps 775-785.

As shown in FIG. 51, the secure e-mail proxy uses HTTPS to acquire the message from the domain that provided the secure e-mail proxy.

This enables the secure e-mail proxy to traverse the corporate firewall without requiring any special configuration of the recipient's network. This simplifies the installation of the proxy.

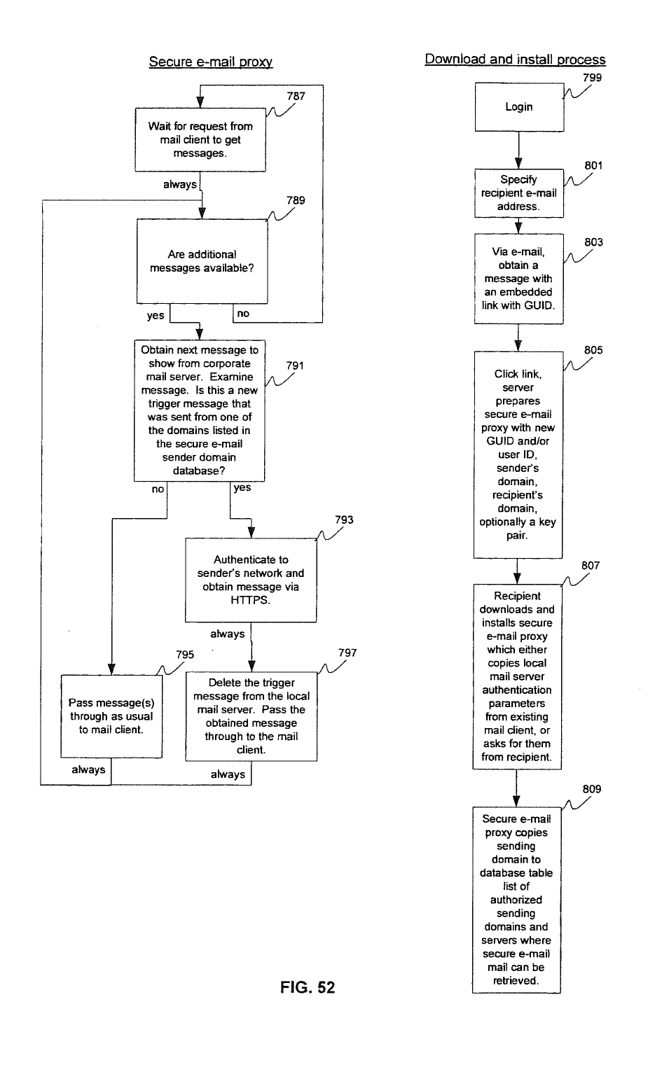

FIG. 52 is a flow diagram of the secure e-mail proxy where access to additional sending servers is added and managed subsequent to the initial download and secure e-mail proxy installation, showing steps 787-809.

As shown in FIG. 52, the specific secure e-mail proxy installation is created during a download process, packaged with parameters specific to the recipient, the version including the recipient's user ID and/or e-mail addresses, and optional GUID indicating the specific installation, and the name of the server to which the proxy should authenticate to retrieve messages and an optional key pair. In the event that the installation process encounters a previously installed secure e-mail proxy, the proxy is not reinstalled, only the list of servers and authentication parameters is updated with the address of the additional servers and the authentication parameters.

During the creation of the installer, information about the server that services the proxy is included in the installer, and this information subsequently enables the secure e-mail proxy to retrieve mail for one domain, but the proxy can be updated to retrieve e-mail securely from senders at multiple domains.

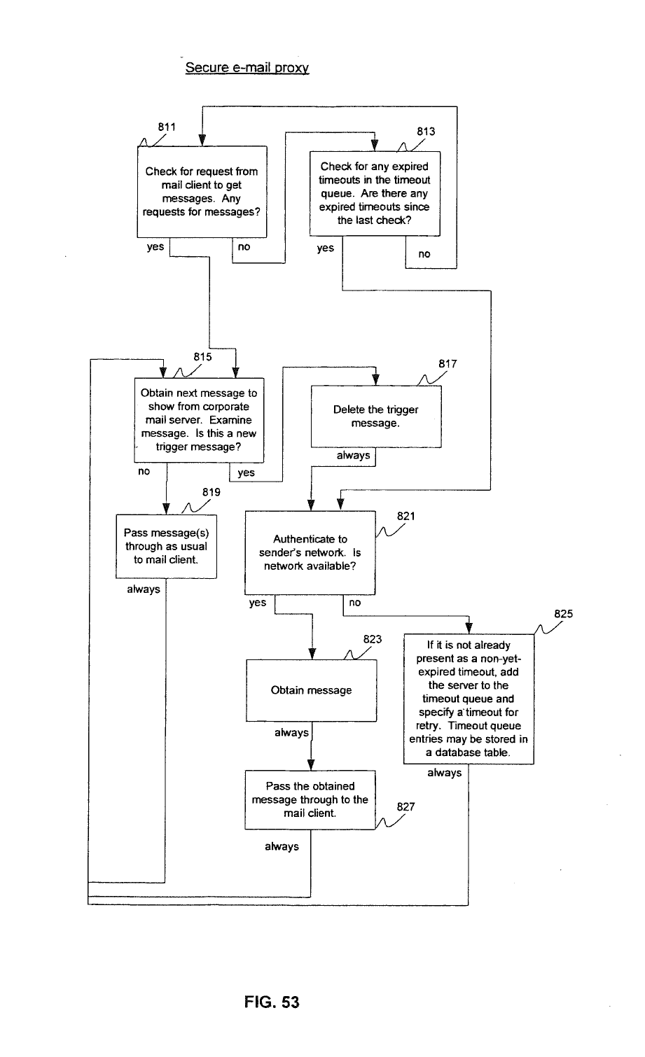

FIG. 53 is a flow diagram of the secure e-mail proxy with timeout when message isn't available and establishes a queue for later retrieval, showing steps 811-827.

As shown in FIG. 53, in the event that the server is not available (i.e. the server from which secure messages from the sender are retrieved by the proxy), a queue is established so that the secure e-mail proxy schedules retrieval at a later time.

This provides for later retrieval of secure messages when the server storing the messages is unavailable due to servicing or lack or connectivity, so that messages bound for the recipient are not dropped or lost.

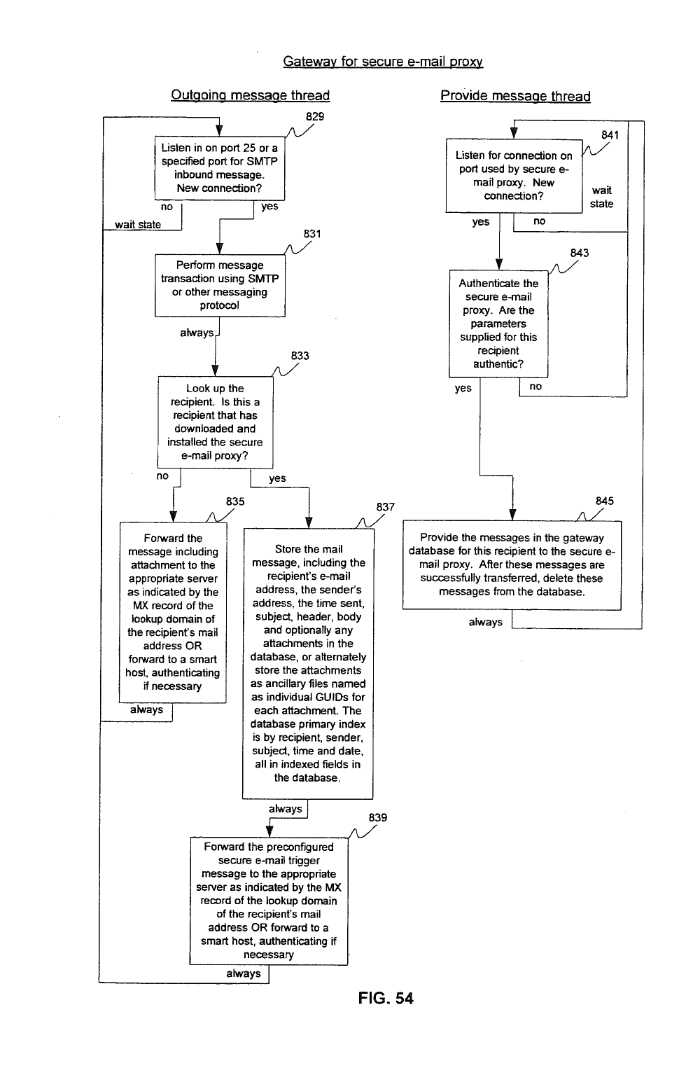

FIG. 54 is a flow diagram of a gateway that retains messages for the account where the secure e-mail proxy has been downloaded, sending a trigger message instead, and using a secure protocol makes available the original message to the secure e-mail proxy when authenticated, showing steps 829-845.

As shown in FIG. 54, the gateway determines whether the recipient has installed the secure e-mail proxy. If the proxy was installed for the recipient, the gateway retains the sent message and instead sends a trigger message. Additionally, the gateway listens for authenticated connections from one or more secure e-mail proxies, and provides new messages to authenticated proxies.

This is the method whereby the messages are provided to one or more secure e-mail proxies to provide for secure e-mail from the domain serviced by the gateway.

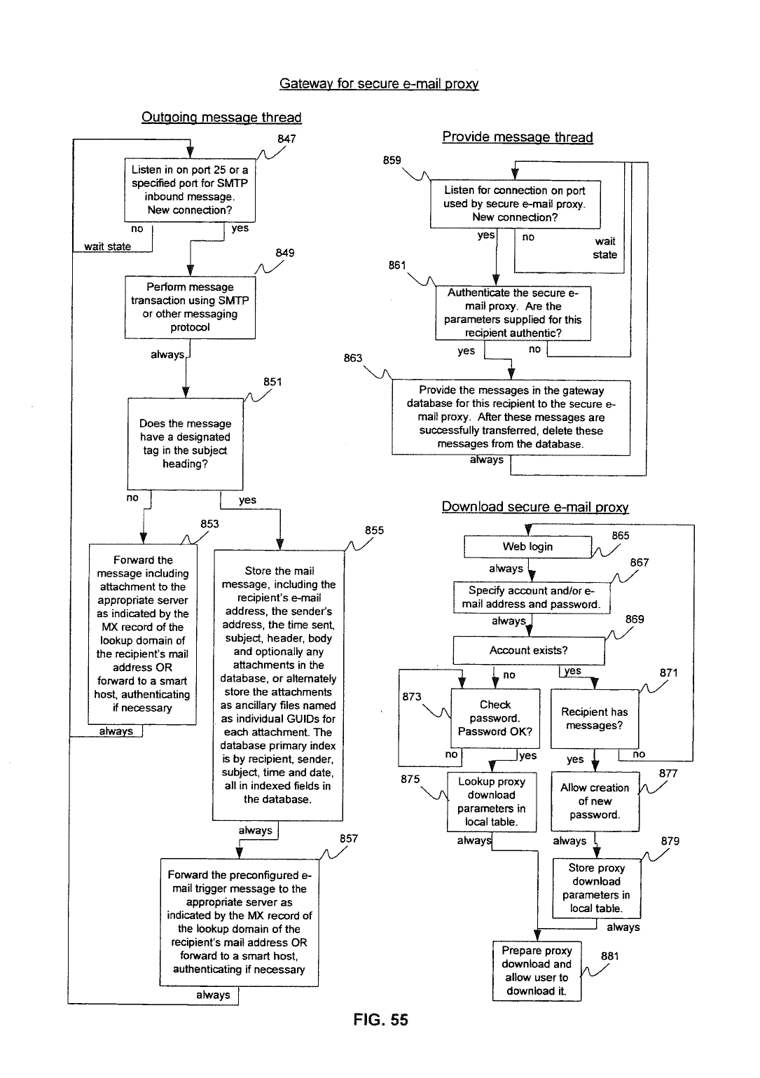

FIG. 55 is a flow diagram of a gateway that retains messages for the account where a tag is provided in the e-mail, sending a trigger message instead, and using a secure protocol makes available the original message to the secure e-mail proxy when authenticated, and via the trigger message can display a web login where the secure e-mail proxy may be downloaded, showing steps 847-881.

As shown in FIG. 55, a tag indicates to the secure e-mail gateway that the message should not be sent, and that a trigger message should instead be sent to the recipient, requiring the recipient to download the secure e-mail proxy to obtain the e-mail. As shown in FIG. 55, it is determined if the tag is present in the subject heading, and if so the message is retained.

This is so that the sender can force the message to require a downloading of the secure e-mail proxy, thereby insuring that the message may only be retrieved securely.

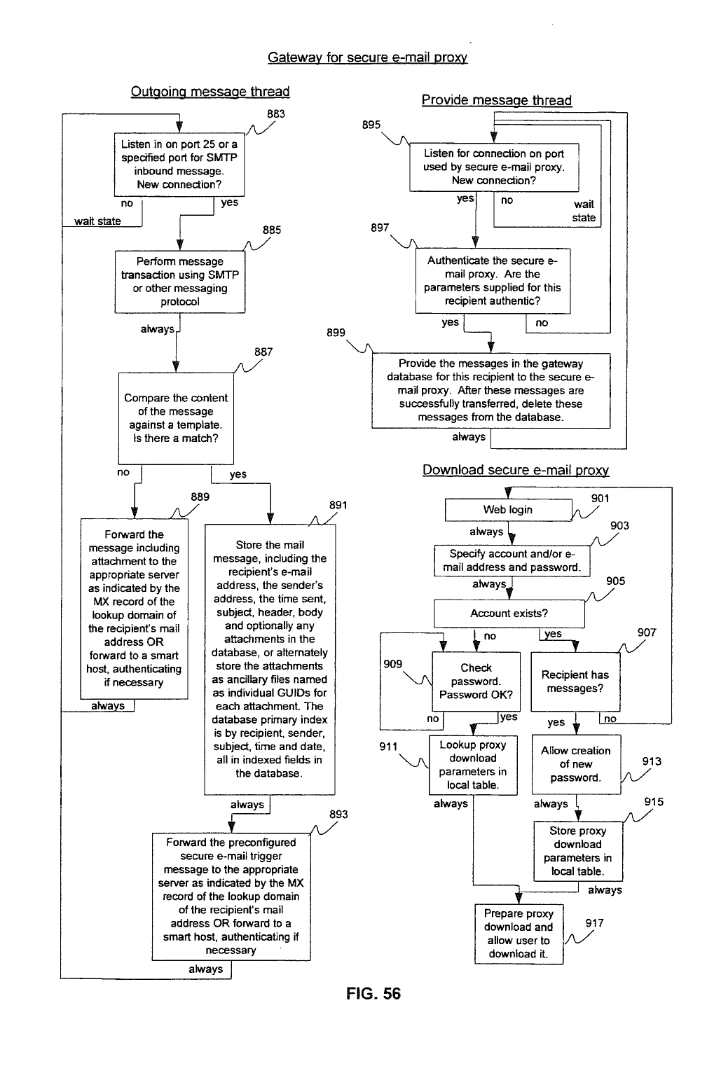

FIG. 56 is a flow diagram of a gateway that retains messages for the account where a matching template is found in the e-mail, sending a trigger message instead, and using a secure protocol makes available the original message to the secure e-mail proxy when authenticated, and via the trigger message can display a web login where the secure e-mail proxy may be downloaded, showing steps 883-917.

As shown in FIG. 56, one or more previously stored templates, when matched to the body of text in the e-mail message or the attachments, indicates to the secure e-mail gateway that the message should not be sent, instead a trigger message should be sent to the recipient, requiring the recipient to download the secure e-mail proxy to obtain the e-mail. As shown in FIG. 56, if it is determined that the template is matched in the body or attachment of the e-mail, the message is retained. Had the templates “##-###-####” and “@@@@@ @@@@@” been entered into the system, for example, any instance of “11-111-1111” or “Hello World” in the message body or attachment causes the trigger message to be sent instead of the actual message.

This is so that the system can automatically force the message to require a downloading of the secure e-mail proxy, thereby insuring that the message may only be retrieved securely, in the event that the e-mail message matches the specified templates.

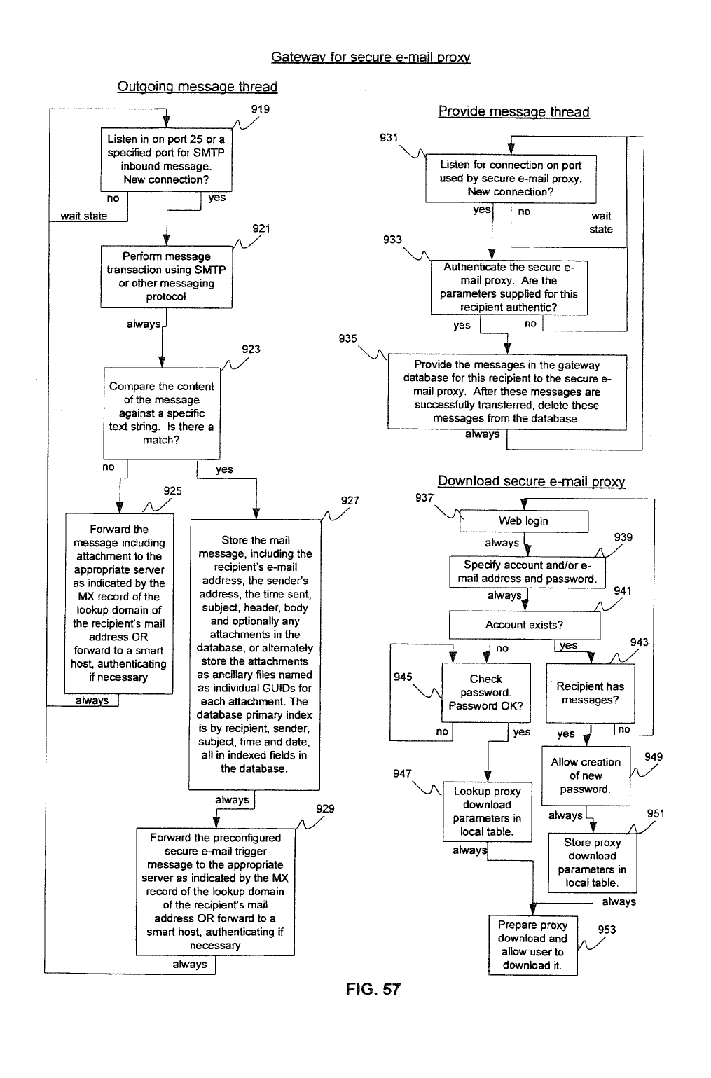

FIG. 57 is a flow diagram of a gateway that retains messages for the account where matching fixed strings are found in the e-mail, sending a trigger message instead, and using a secure protocol makes available the original message to the secure e-mail proxy when authenticated, and via the trigger message can display a web login where the secure e-mail proxy may be downloaded, showing steps 919-953.

As shown in FIG. 57, one or more previously stored fixed strings, when matched to the body of text in the e-mail message or the attachments, indicates to the secure e-mail gateway that the message should not be sent, instead a trigger message should be sent to the recipient, requiring the recipient to download the secure e-mail proxy to obtain the e-mail. As shown in FIG. 57, if it is determined that the case insensitive fixed string is matched in the body or attachment of the e-mail, the message is retained. Had the fixed string “top secret” and “do not forward” been entered into the system, for example, any instance of “top secret” or “do not forward” in the body or attachment causes the trigger message to be sent instead of the actual message. Should typical punctuation marks for the locality (i.e. ‘.!&,” etc.) or blank space prefix or postfix the fixed string, the trigger message is sent, however if the string is a subset of another string, i.e. the only fixed string specified is “social” and the only instance of the word in the message body is within the word “socialization”, the trigger message is not sent.

This is so that the system can automatically force the message to require a downloading of the secure e-mail proxy where the message is known to require security, thereby insuring that the message may only be retrieved securely, in the event that part of the e-mail message matches the specified fixed strings.

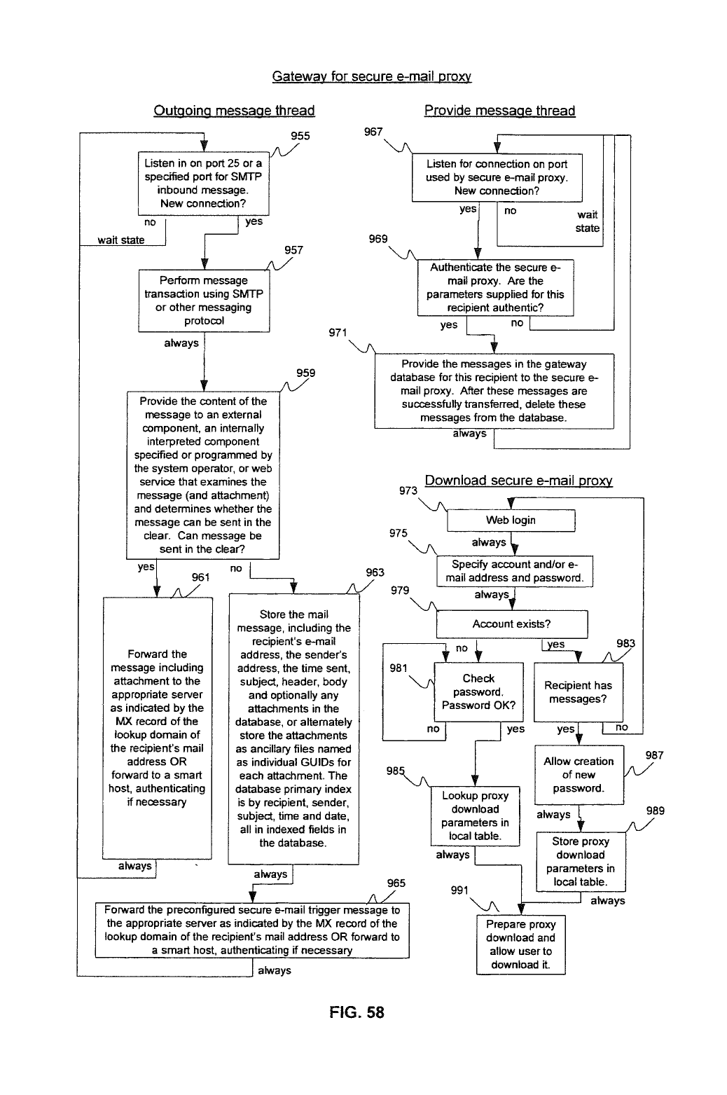

FIG. 58 is a flow diagram of a gateway that retains messages for the account where external custom programmed analysis indicates that the message should be sent securely, sending a trigger message instead, and using a secure protocol makes available the original message to the secure e-mail proxy when authenticated, and via the trigger message can display a web login where the secure e-mail proxy may be downloaded, showing steps 955-991.

As shown in FIG. 58, one or more externally programmed criteria, having examined the body and attachments of the e-mail, where the determination is made that the e-mail warrants sending the message securely, indicates to the secure e-mail gateway that the message should not be sent, instead a trigger message should be sent to the recipient, requiring the recipient to download the secure e-mail proxy to obtain the e-mail message. As shown in FIG. 58, the gateway allows an external component, internally interpreted component or component programmed by the system operator, or web service to examine the message (and attachment) and to specify whether the e-mail requires secure transmission. If so, this causes the sending of the trigger message, requiring the downloading of the proxy in the event that it is not currently in use.

This is so that the system can automatically force security for messages deemed worthy based on analysis of the e-mail as performed by an external analysis engine.

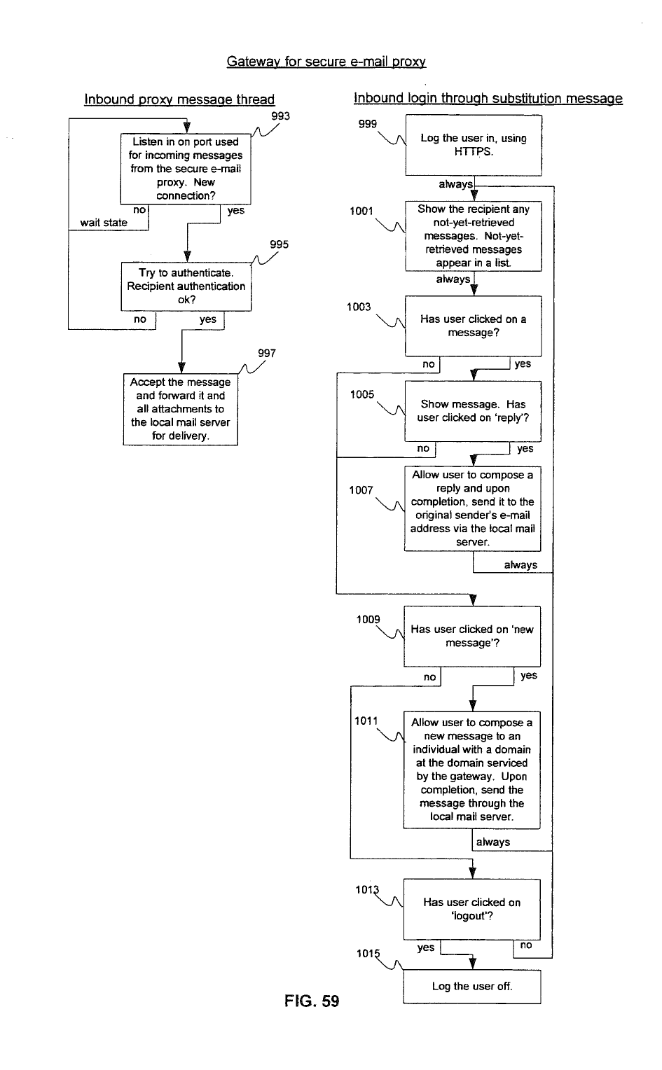

FIG. 59 is a flow diagram of a gateway that accepts messages from an authenticated secure e-mail proxy, showing steps 993-1015.

As shown in FIG. 59, the gateway that services the secure e-mail proxy accepts inbound messages, i.e. messages to be delivered from the secure e-mail proxy to recipients behind the corporate firewall at the entity serviced by the gateway. Inbound messages are forwarded to the local mail server, behind the corporate firewall. In addition, for those messages retained by the gateway as a result of sending a trigger message, the gateway provides a mechanism for composing a mail message through a web browser, in response to a mail message, made available in the event that the secure e-mail proxy has not yet retrieved the e-mail message. Optionally these messages may be retained unless deleted manually, or deleted on a scheduled basis by the gateway.

The above facilitates a two-way transmission of secure e-mail by the secure e-mail proxy.

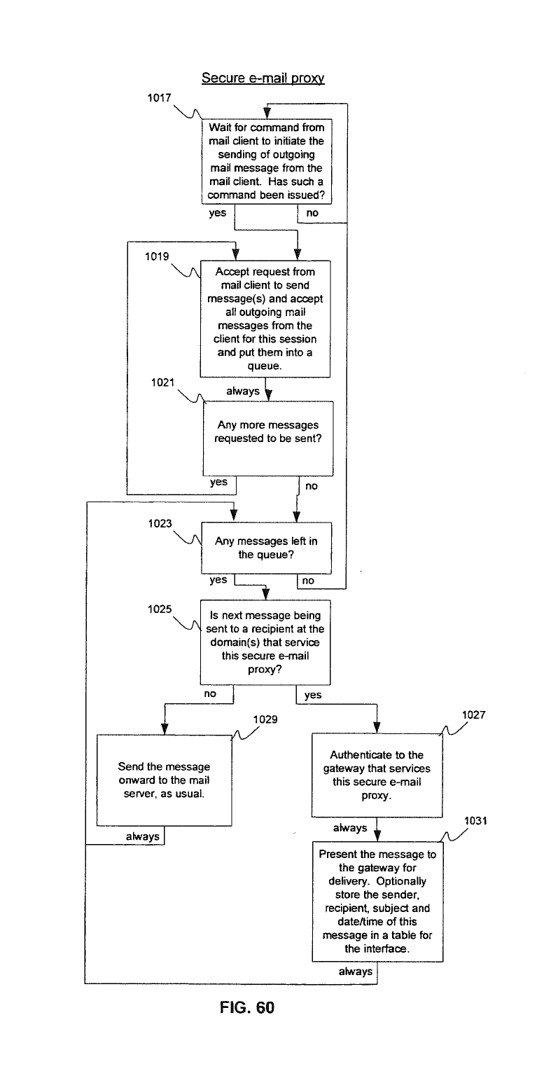

FIG. 60 is a flow diagram of the secure e-mail proxy that is configured prior to download to send outgoing messages to the domain serviced by the gateway directly to the gateway, authenticating to the gateway to provide a message using a secure protocol, showing steps 1017-1031.

As shown in FIG. 60, the secure e-mail proxy can send outgoing e-mail bound for any of the domains serviced by the secure e-mail proxy directly to the gateways at those domains. As shown in FIG. 60, the header information may be optionally stored in a local table, so that it may be combined with the local sent message information in the event that this information is stored at a local mail store.

The above facilitates a two-way transmission of secure e-mail by the secure e-mail proxy.

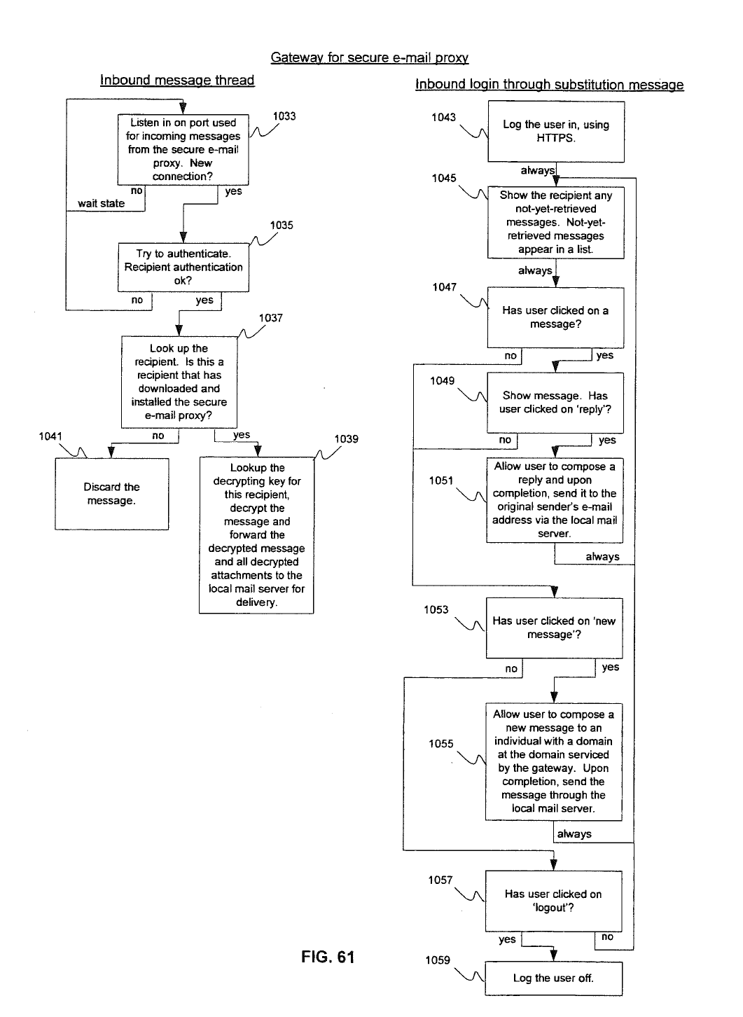

FIG. 61 is a flow diagram of a gateway that accepts messages from a secure e-mail proxy where the messages are encrypted with an encrypting key, and where the gateway decrypts the messages with the corresponding decrypting key, showing steps 1033-1061.

As shown in FIG. 61, the gateway recovers a decrypting key that was generated and stored when the proxy was established for downloading, on a per recipient basis, and decrypts the inbound message before forwarding it to the local mail server.

The above is another embodiment of a system to communicate securely bi-directionally using the secure e-mail proxy.

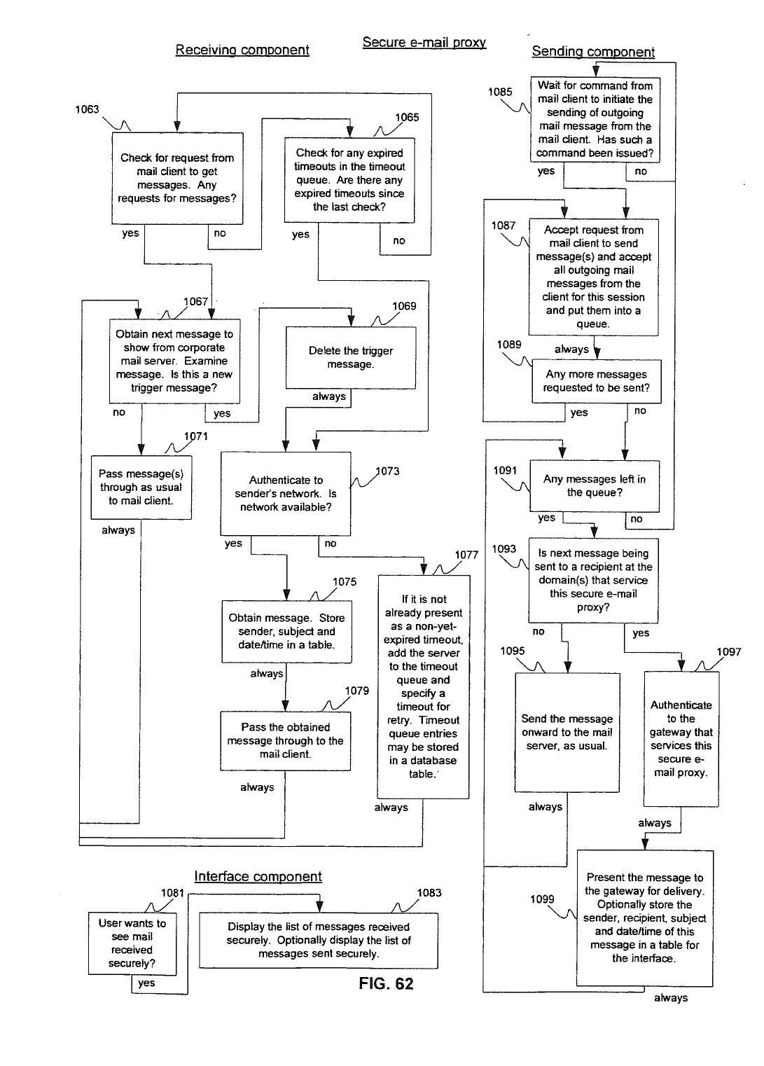

FIG. 62 is a flow diagram that includes the interface to the secure e-mail proxy that enables the recipient to see which messages were retrieved securely, showing steps 1063-1099.

As shown in FIG. 62, an interface component is provided with the mail client that indicates which messages have been received or sent securely. This interface component is not normally shown, however upon initialization it shows messages that have been securely transmitted to and from the proxy and mail client.

Because the system does not change the recipient's workflow, i.e. because the proxy user does not perform any out-of-the-ordinary procedures, it is desirable to be able to indicate to the proxy user that messages serviced by the proxy have, in fact, been sent and received in a secure manner. Because it is desirable not to change the workflow of the proxy user, an unobtrusive interface, one that requires a special procedure to invoke (i.e. a key sequence, double clicking on “taskbar” icon, or running a program, etc.), can be presented to those users who want some proof or indication that the system is operating. The interface can display the nature of the encryption, when the messages were sent, etc., if so desired.

The above is for the purpose of indicating to proxy users that the proxy is operating as expected.

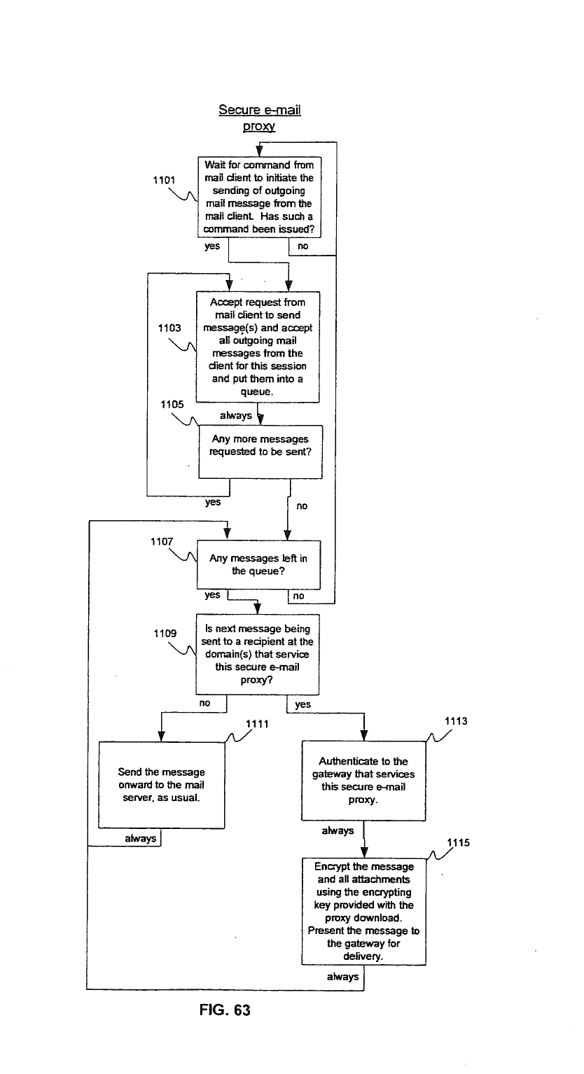

FIG. 63 is a flow diagram of the secure e-mail proxy that is configured prior to download to send outgoing messages to the domain serviced by the gateway directly to the gateway, providing a message encrypted through the use of an encrypting key, provided with the secure e-mail proxy download, showing steps 1101-1115.

As shown in FIG. 63, the secure e-mail proxy encrypts the message with the encrypting key supplied with the proxy download, and after authenticating into the gateway, provides the encrypted message to the gateway. Because the gateway has access to the decrypting key, it decrypts the message before passing it to the local mail server.

This is one embodiment of a secure e-mail proxy that does not depend upon a secure channel for the transmission of the actual e-mail message.

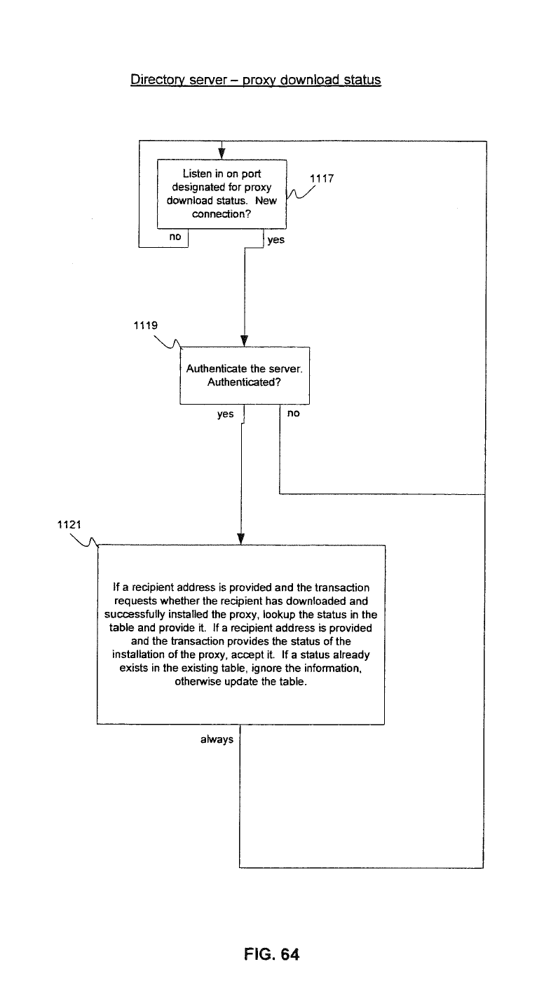

FIG. 64 is a flow diagram of the gateway that provides directory services to indicate whether a particular recipient has downloaded the secure e-mail proxy, showing steps 1117-1121.

As shown in FIG. 64, if the proxy has been downloaded, and the authenticated system specifies the parameters supplied in the download and the recipient's e-mail address to the directory server, the directory server will accept that information and store it so it can be retrieved.

This is for the purpose of centralizing on one server the information as to which recipient downloaded the proxy, and the parameters associated with that proxy, so that multiple secure e-mail gateway systems can obtain that information without caching the information.

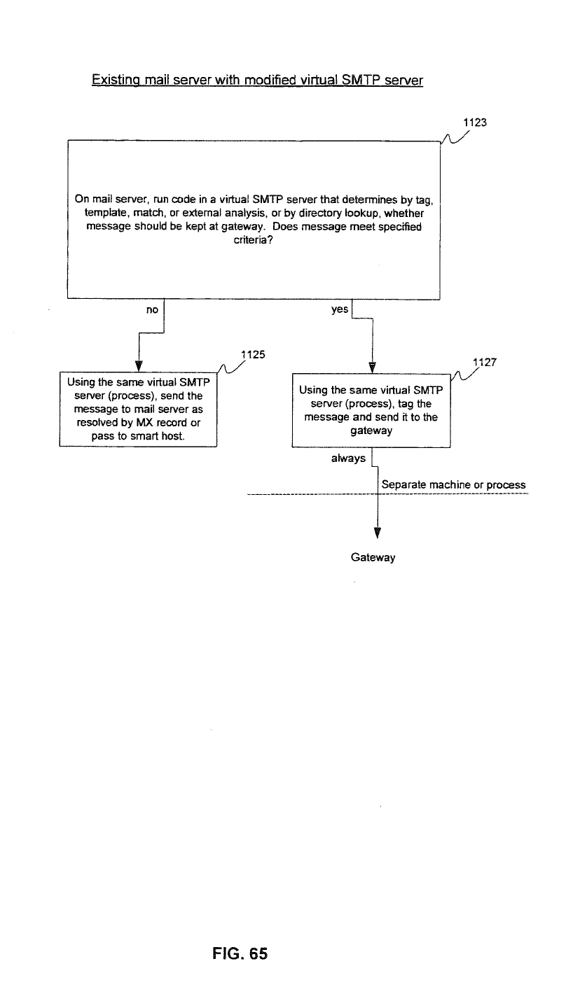

FIG. 65 is a flow diagram of the gateway components separated to two separate networks for the purpose of maximizing the available resources of the existing mail server infrastructure, showing steps 1123-1127.

As shown in FIG. 65, a determination as to whether to send the trigger message in lieu of the actual message can be performed in the process of the existing mail server. If the trigger message is to be sent, the modified mail server or “virtual SMTP server” will pass the message with the tag through to the gateway and the gateway will send the trigger message and the existing mail server will send no message, so that the determination does not have to be made twice (for analysis that requires examining the body and any attachments). As shown in FIG. 65, the dotted line denotes that whereas the determination whether to send the trigger message in lieu of the actual message is made in the same process space as the existing mail server, the gateway functionality executes either in a different process space or on another machine.

The above is for the purpose of maximizing the utilization of the existing mail network. Prior to installation of the secure e-mail system, the mail network may have been optimized, and transmitting all mail through the secure gateway may not be desirable. This facilitates sending only that mail through the secure e-mail system as required, all other mail traversing through the existing systems.

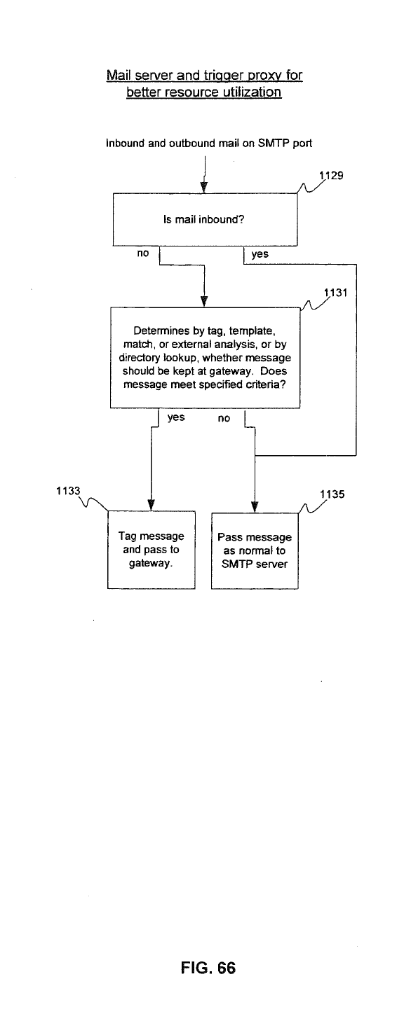

FIG. 66 a flow diagram of a trigger proxy that sits at the mail server, forwarding all inbound requests for delivery to the mail server, and that examines all outbound requests, directing to the mail server those outbound transactions that do not require the trigger message, and directing to the gateway those outbound transactions that do require the trigger message, showing steps 1129-1135.

The existing mail server is configured to listen in on a new port, and the trigger proxy passes messages as appropriate to the mail server at the new port.

The above is for the purpose of maximizing the existing resources of the existing mail network. Prior to installation of the secure e-mail system, the mail network may have been optimized, and transmitting all mail through the secure gateway may not be desirable. This facilitates sending only that mail through the secure e-mail system as required, all other mail traversing through the existing systems.

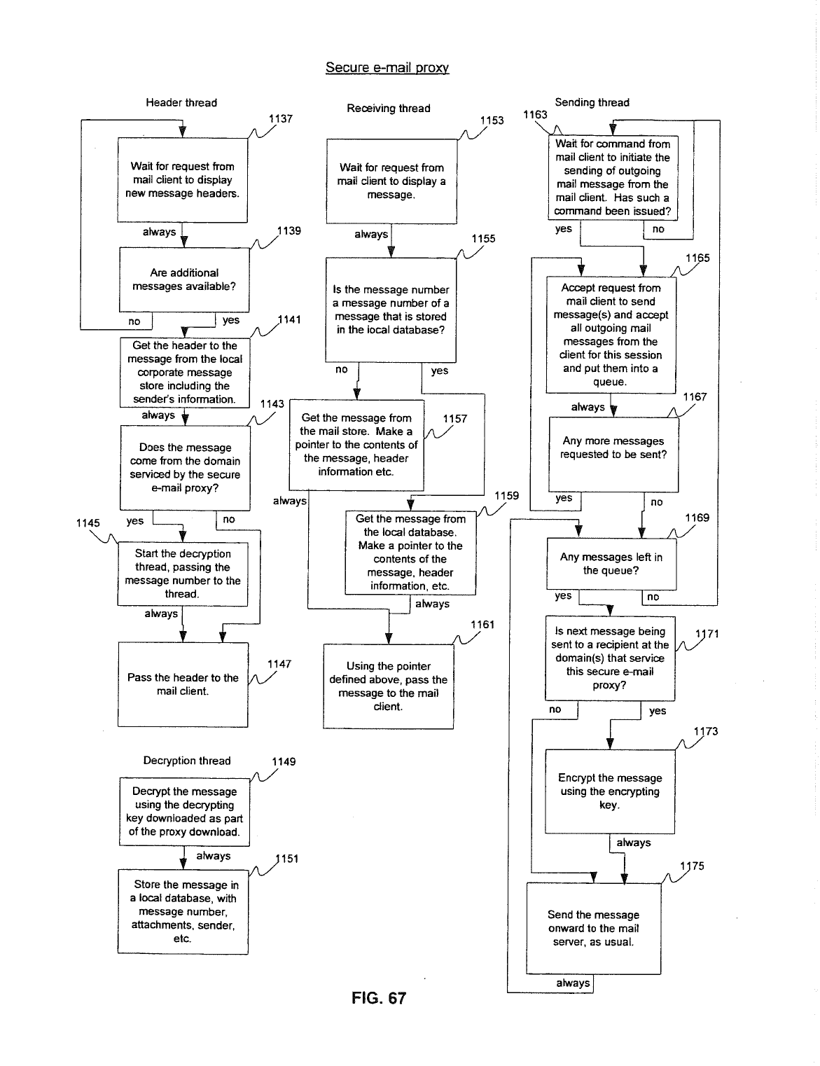

FIG. 67 is a flow diagram of a secure e-mail proxy, downloaded with account name, key pair, and sender's domain, which combines incoming messages into an existing mailbox and decrypts any message sent from the sending domain, and which encrypts any message sent to the sending domain, where the message is constructed to show a link if obtained not using the proxy, showing steps 1137-1175.

As shown in FIG. 67, the secure e-mail proxy is designed to integrate into the existing mail client infrastructure such that it displays one unified mailbox. As shown in FIG. 67, the header thread obtains mail headers as requested by the mail client, and also obtains headers as encrypted by the sending gateway using the proxy's decrypting key. Messages are decrypted and stored in a local database for subsequent retrieval, as performed by the ‘Decryption thread’. The receiving thread renumbers mailbox messages for those protocols that expect the storage of the mail message at the mail store. The sending thread, for those messages sent to the domains serviced by this secure e-mail proxy, encrypts the messages using the encrypting key provided with the proxy download, and sends them to the receiving domain as usual. The gateway must be configured to receive incoming mail so that it can decrypt it before passing it onto the local mail server.

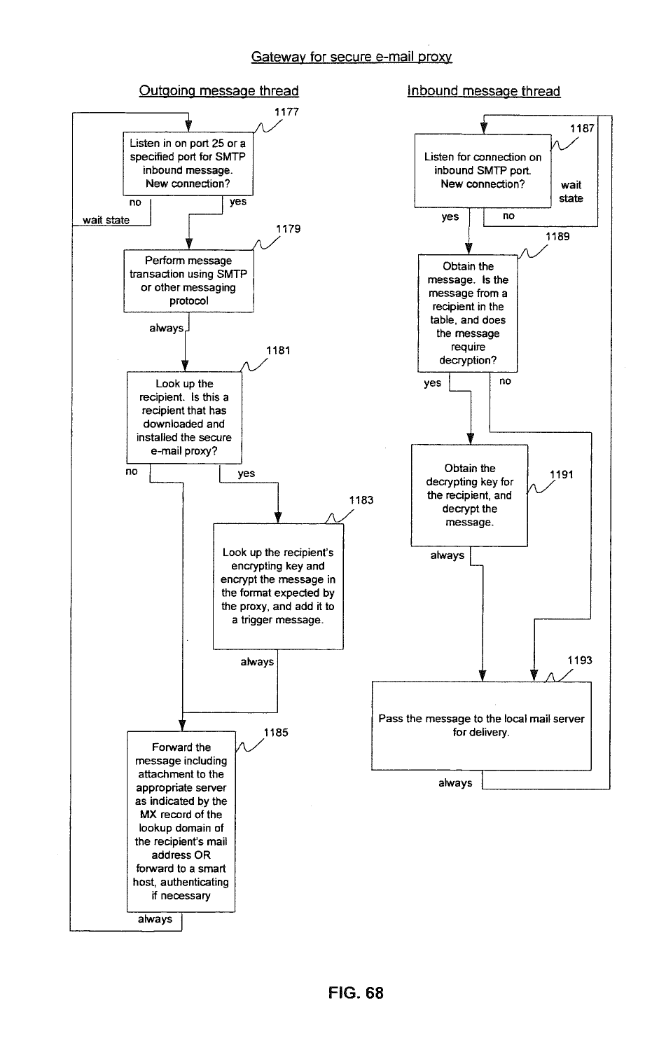

FIG. 68 is a flow diagram of a gateway that accepts inbound mail as encrypted and sent by the proxy of FIG. 68, where the message is decrypted before it is passed to the local mail server for local delivery, showing steps 1177-1193.

As shown in FIG. 68, the gateway accepts inbound mail as encrypted by the proxy of FIG. 68, and looks up the decrypting key for inbound messages for the sender, decrypting the message and passing it along to the local mail server. All other inbound messages are passed to the local mail server, as usual.

The purpose of the above is to provide that the proxy of FIG. 68 accept encrypted mail sent through an insecure channel.

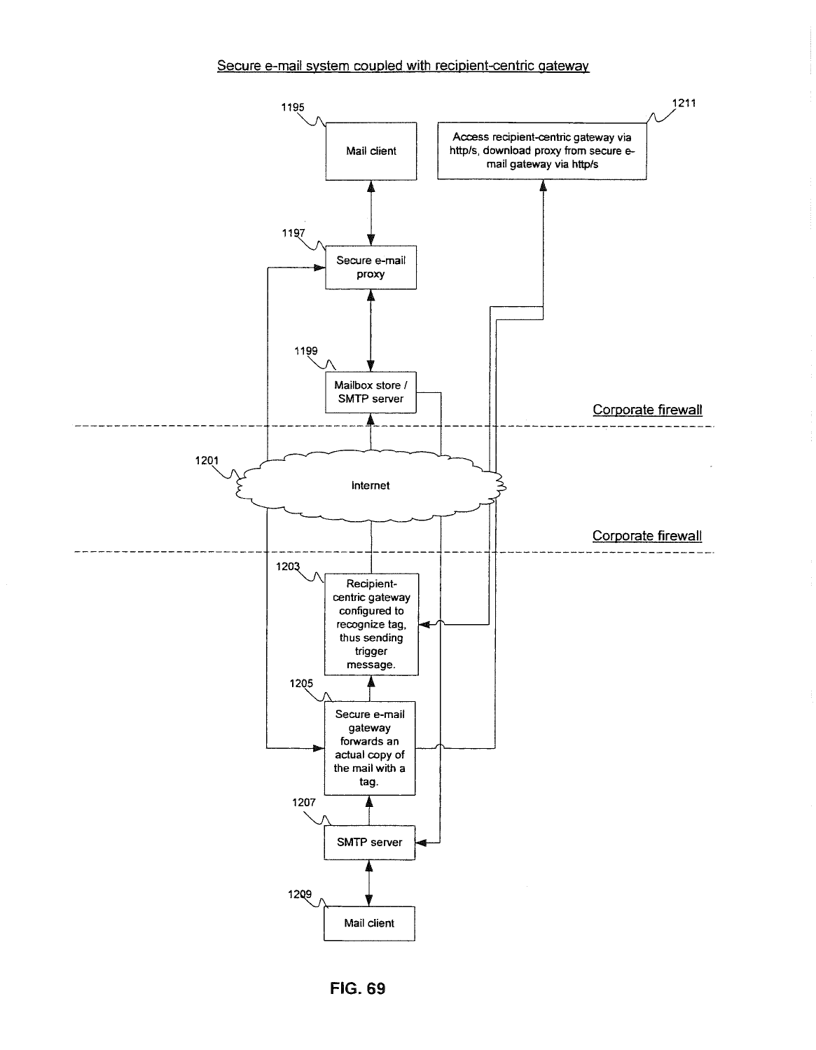

FIG. 69 is a general diagram of the secure e-mail proxy with the recipient-centric gateway, showing steps 1195-1211.

As shown in FIG. 69, the secure e-mail gateway places a tag into actual outgoing mail messages, and sends the actual message (not the trigger message) through the gateway, causing the recipient-centric gateway to retain the actual message and to send a specially configured trigger message instead. The specially configured trigger message specified to the recipient-centric gateway configuration is a secure e-mail trigger message that includes a recipient-centric login and the secure e-mail download link, and that causes the secure e-mail proxy to download the mail message from the secure e-mail proxy, but also enables the recipient at a webmail system to log to the recipient-centric gateway to retrieve the message or enables a first time user to download the proxy.

This provides the functionality of both systems, i.e. the ability to view correspondence from the recipient perspective as sent by the corporate entity, and the ability to transparently communicate secure e-mail.

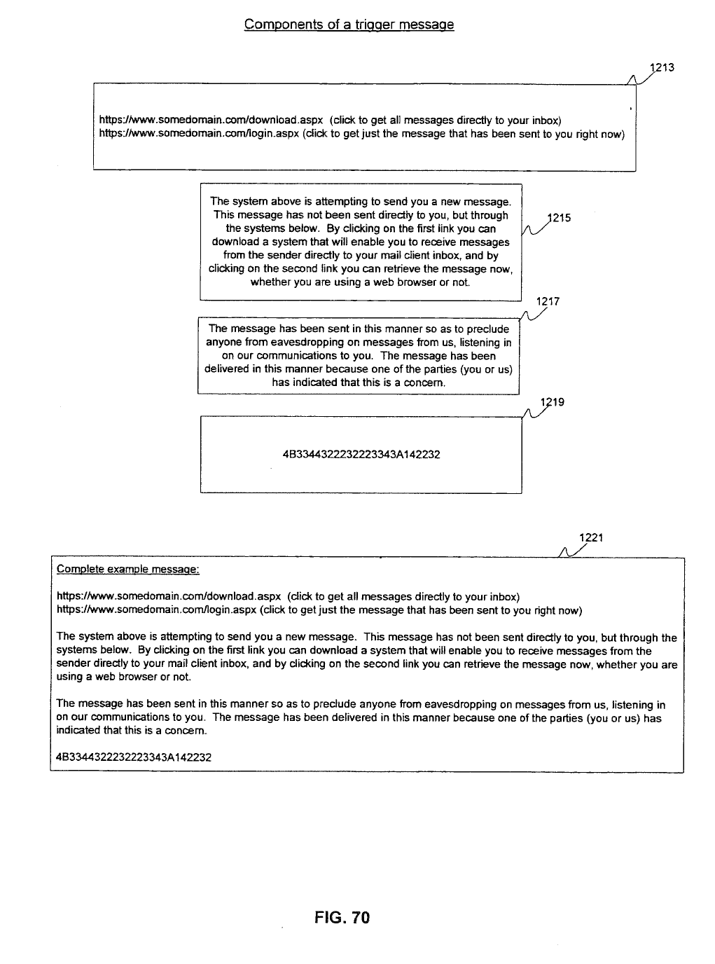

FIG. 70 is a general diagram of the trigger message for the secure e-mail proxy with the recipient-centric gateway, showing steps 1213-1221.

As shown in FIG. 70, the trigger message for use with both the secure e-mail gateway and the recipient-centric gateway provides a link for downloading the proxy, and a link for recovering the messages stored at the recipient-centric gateway.

This is a specially constructed message that operates with both the recipient-centric gateway and the secure e-mail system.

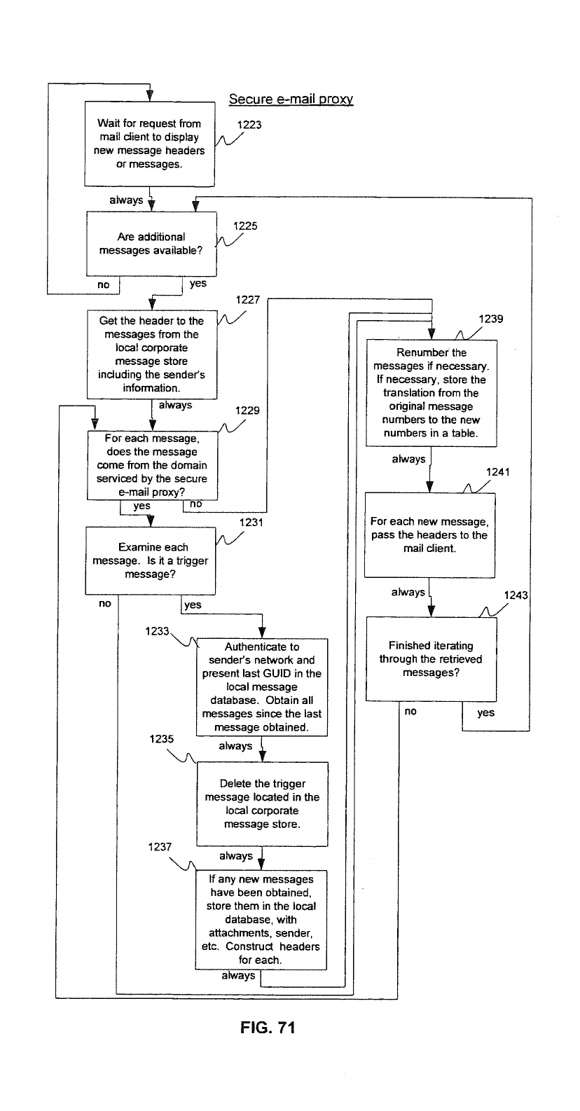

FIG. 71-75 are additional embodiments of secure email proxies and gateways that enable multiple recipient computers to view the same mailbox using the proxy system for a single email address, for the purpose of displaying the same mailbox view across multiple machines. Also presented are embodiments of gateways that adjust the sending of e-mail in real time based on proxy usage for the purpose of reducing resource usage.

FIG. 71 is a flow diagram of a proxy that can combine secure and mail store messages to show a single mailbox view across multiple machines, despite proxy installation on different machines at different times, showing items 1223-1243.

As shown in FIG. 71, a secure e-mail proxy from a gateway obtains messages not yet retrieved and stores these messages in the local database if the messages were not previously retrieved and stored in the local database. Using a GUID unique to each message facilitates the determination as to which messages should be obtained.

The above is so that the proxy can be installed on additional computers, and the message view will remain the same across multiple installations. For example, a recipient can install the proxy on an office machine and on a home machine, both mail clients connected to the same IMAP4 or Exchange mail store for unencrypted mail, and the view of all mail (i.e. mail from the IMAP4/Exchange mail store and secure mail) at both mail clients will be identical. This is because the proxy downloads messages newer than the last message retrieved and because the gateway does not delete messages immediately after retrieval. When a copy of the proxy is installed on another computer, because the new copy of the proxy has not yet retrieved any messages, all messages stored at the gateway are provided to the proxy. Subsequent retrievals are based on the GUID of the last message retrieved, so only messages new to the particular proxy installation are provided by the gateway.

This functionality is provided because in the event that the recipient uses an IMAP4 server or an Exchange server to access mail, the user will expect to see the same mailbox view despite access from multiple machines.

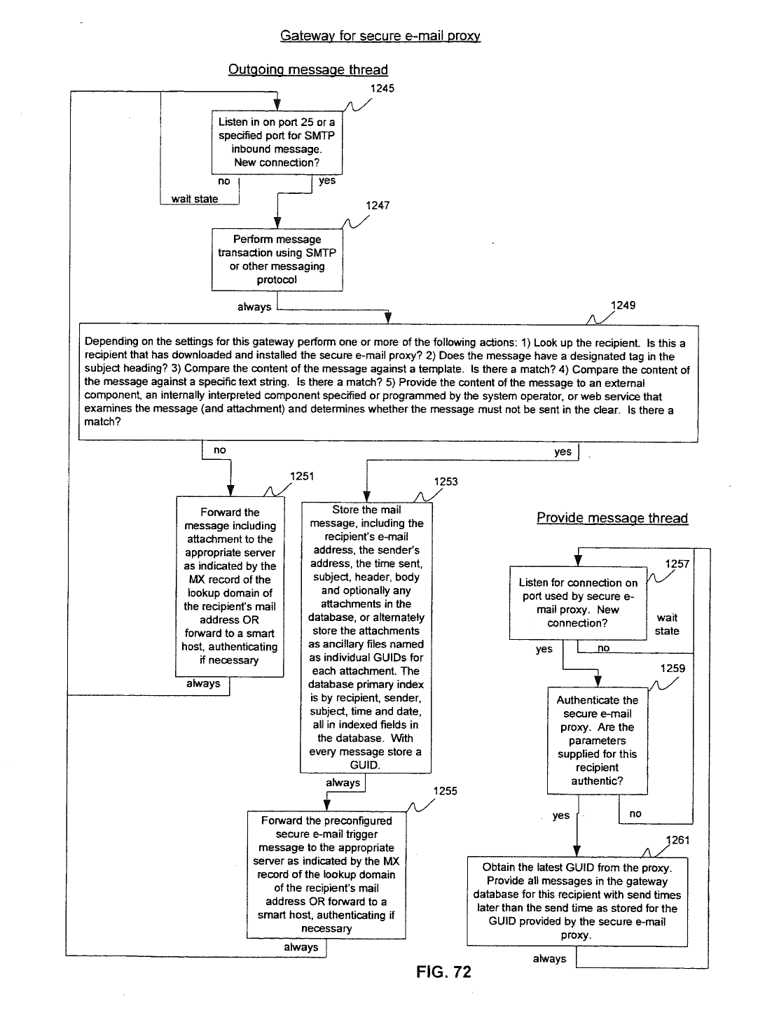

FIG. 72 is a flow diagram of a gateway that supports the proxy of FIG. 71 that can combine secure and mail store messages to show a single mailbox view across multiple machines, despite installation on different machines at different times, showing items 1245-1261.

As shown in FIG. 72, a gateway retains all messages and does not delete them after the proxy retrieves them, rather it retains them in the event that additional proxies request the messages. Each message is stored with a GUID, by using this GUID that the proxy can determine whether the message has already been retrieved to the local database. A thread can periodically delete messages older than a certain date, or by some other criteria.

The above is so that the proxy can be installed on additional computers, and the message view will remain the same across multiple machines.

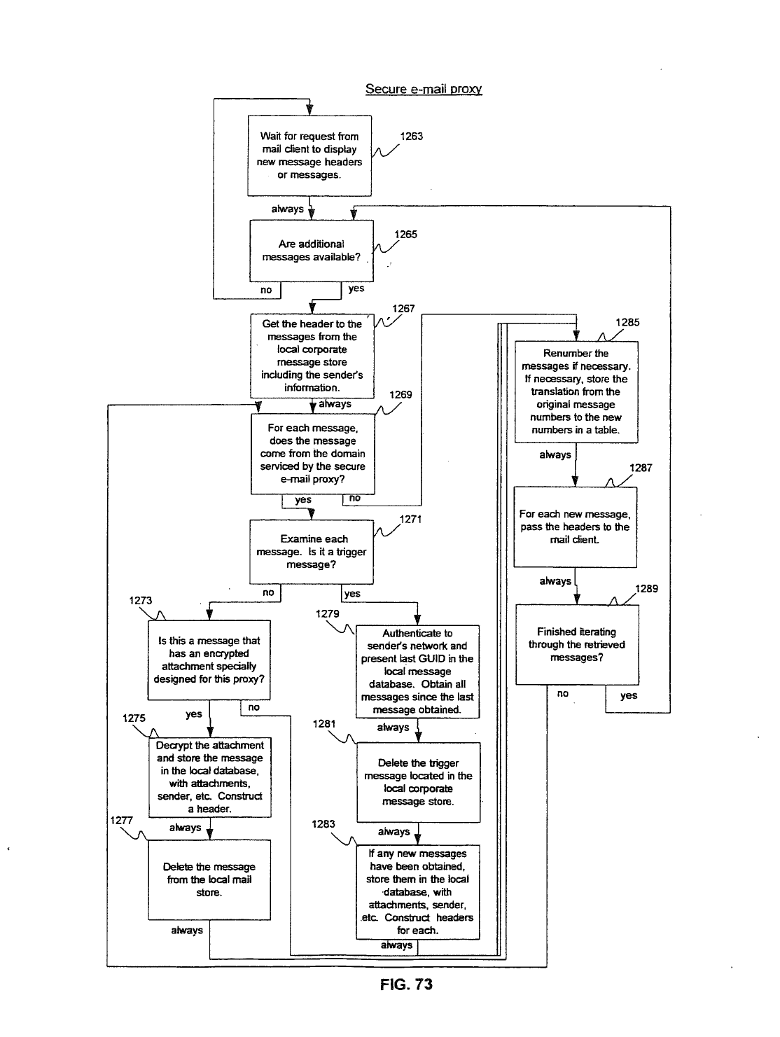

FIG. 73 is a flow diagram of a proxy that can combine secure and mail store messages to show a single mailbox view across multiple machines, despite installation on different machines at different times and that can receive secure messages, showing items 1263-1289.

As shown in FIG. 73, a secure e-mail proxy can decode messages that are sent encrypted and have been retrieved at the local mail server, and can also obtain messages directly from the gateway and can combine all messages into one mailbox view. In the event that a message is sent by the gateway, the message is encrypted and is sent as an attachment, the main body containing a message indicating that the actual message can only be retrieved by downloading the proxy, and a link where the download is located. In the event that this message is received on a system on which the proxy is installed, the proxy decodes the actual encrypted message contained in the attachment using the decrypting key stored with the proxy when it was packaged and communicated to the recipient, the message is stored in the local proxy database and is combined with other messages to form one mailbox view and the original message is deleted from the local mail store. In the event that the proxy receives any trigger messages from the gateway, they are deleted and the proxy connects to the gateway to obtain any new messages.

The advantage to the system above is that it may reduce resource requirements. In the event that the proxy has not yet been installed, or has been installed and has no usage history, the gateway sends the small trigger message, putting a small drain on the resources of both the sending and receiving networks. In the event that the message and others are subsequently retrieved at the gateway, the gateway may go into a mode where it begins to send messages directly to that recipient, and may also lower resource usage because the mechanism for sending is via the existing SMTP mail infrastructure, i.e. it is not an on-demand system.

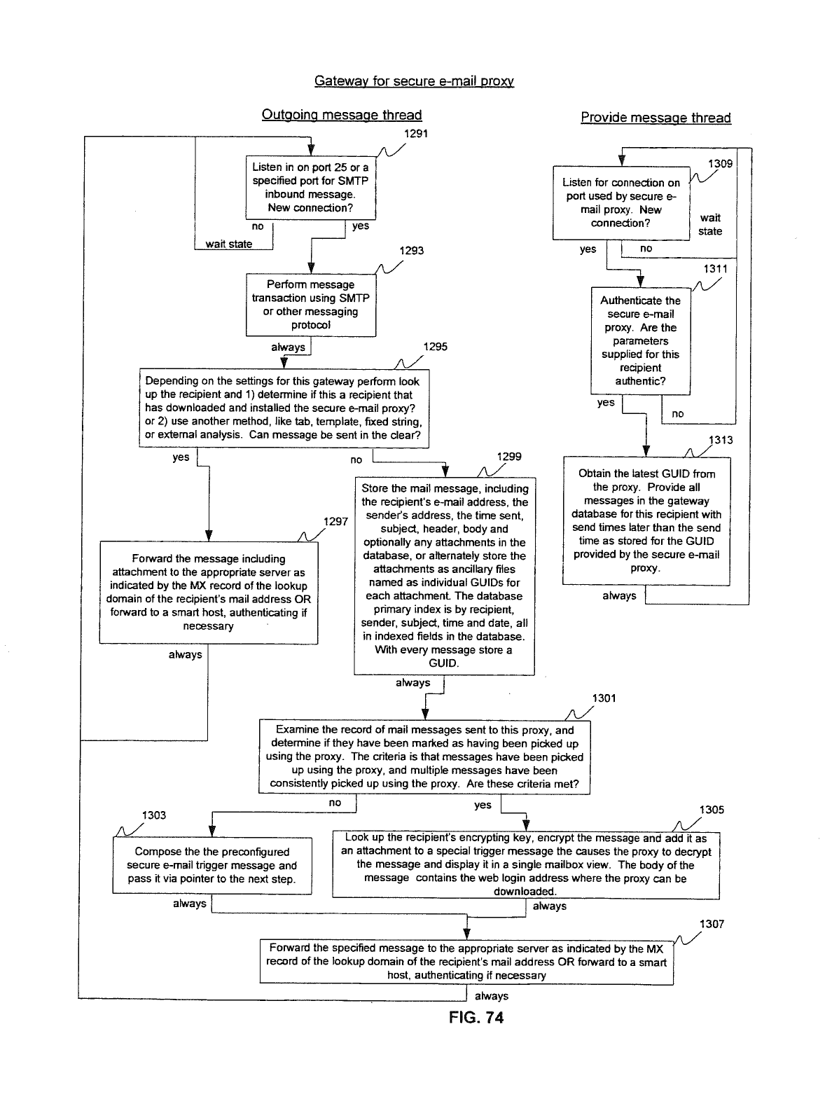

FIG. 74 is a flow diagram of a gateway that supports a proxy that can combine secure and mail store messages to show a single mailbox view across multiple machines, despite installation on different machines at different times and that can receive secure messages, showing items 1291-1313.

As shown in FIG. 74, a gateway retains all messages in the local database and does not delete messages after they are retrieved by the proxy, rather it retains them in the event that one or more proxies request messages that have not yet been stored in the local database. Each message is stored with a GUID, and it is by this mechanism that the proxy can determine whether the message has already been retrieved to the local database. Messages can be stored encrypted for the recipient. Also, messages can be sent where the messages are constructed such that they show the login for obtaining the proxy, the message encrypted in an attachment. The format of such messages is known to the proxy and is decrypted accordingly, i.e. the message body showing the login for obtaining the proxy is discarded. The first message sent to any recipient is a trigger message. The gateway records message retrieval events (date/time) for each recipient (where the retrieval occurs via the proxy). In the event that the recipient is consistently recovering messages by authenticating into the gateway, the gateway may begin to send messages encrypted rather than waiting for messages to be retrieved. The gateway still stores these messages, and the GUID within the message is the same.

The advantage to storing the messages encrypted is that in the event they are recovered numerous times, the encryption process draws on system resources once only per message. The advantage to detecting the usage of the recipient and switching to sending the messages rather than waiting for them to be retrieved is that it lowers resource requirements. In certain circumstances requiring privacy, the recipient doesn't need to get the message and will not, in fact, do so. This is the case, for example, when medical results are made available via phone and are sent to a large plurality of recipients using the secure e-mail system. If the summary of test results can be retrieved by phone, if explained in the trigger message that the content of the encrypted communication is the otherwise available medical records, it is probable some recipients who want to acquire the information by phone will not install the proxy and will not retrieve the result electronically. In such cases, it is not desirable to send the actual record with the first (or possibly subsequent messages). A trigger message is sufficient. In cases where large documents or images are sent to recipients who have other modes of recovering those parts of the transmitted information that are of interest, this process of sending the trigger message without the attachment can reduce sender resource usage.

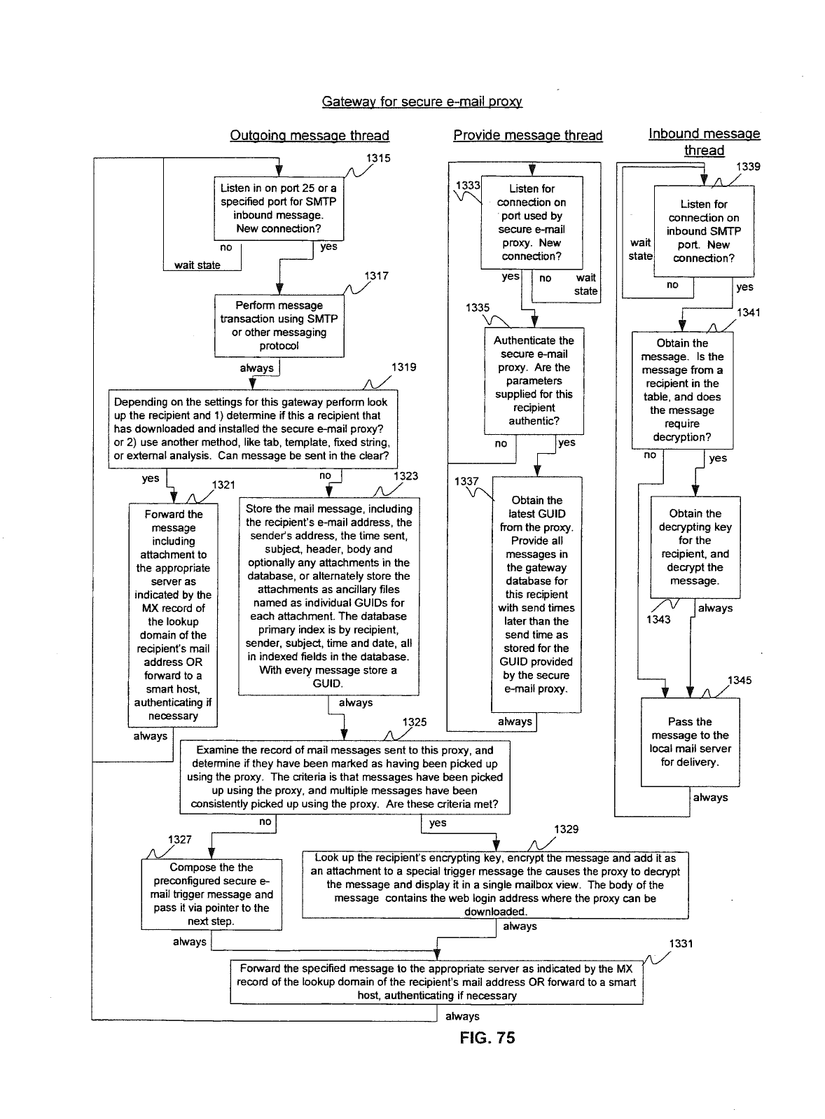

FIG. 75 is a flow diagram of a gateway that supports a proxy that can combine secure and mail store messages to show a single mailbox view across multiple machines, despite installation on different machines at different times and that can receive secure messages, where the gateway can receive secure messages via SMTP and pass them to the local mail server for delivery, showing items 1315-1345.

As shown in FIG. 75, a gateway accepts messages sent from a sender that has downloaded the proxy and decrypts such messages, passing them to the local mail server. The gateway also retains all messages in the local database and does not delete messages after the proxy retrieves them, rather it retains them in the event that one or more proxies that have not yet populated the local database with retrieved messages request messages. Each message is stored with a GUID, and it is by this mechanism that the proxy can determine whether the message has already been retrieved to the local database. A thread can periodically delete messages older than a certain date, or by some other criteria. Messages can be stored encrypted for the recipient. Also, outbound messages are constructed so that they show the login for obtaining the proxy, and the actual message is encrypted in an attachment. The format of such messages is known to the proxy and is decrypted accordingly, i.e. the message showing the login for obtaining the proxy is discarded. The first message sent to any recipient is a trigger message. The gateway records message retrieval events (date/time) for each recipient (where the retrieval occurs via the proxy). In the event that the recipient is consistently recovering messages via the gateway, the gateway may begin to send messages encrypted rather than waiting for them to be retrieved. The gateway still stores these messages, and the GUID within the message is the same.

The above is part of a system for sending and retrieving secure mail that can present a single mailbox view to IMAP4/Exchange mailboxes, while reducing resource usage.

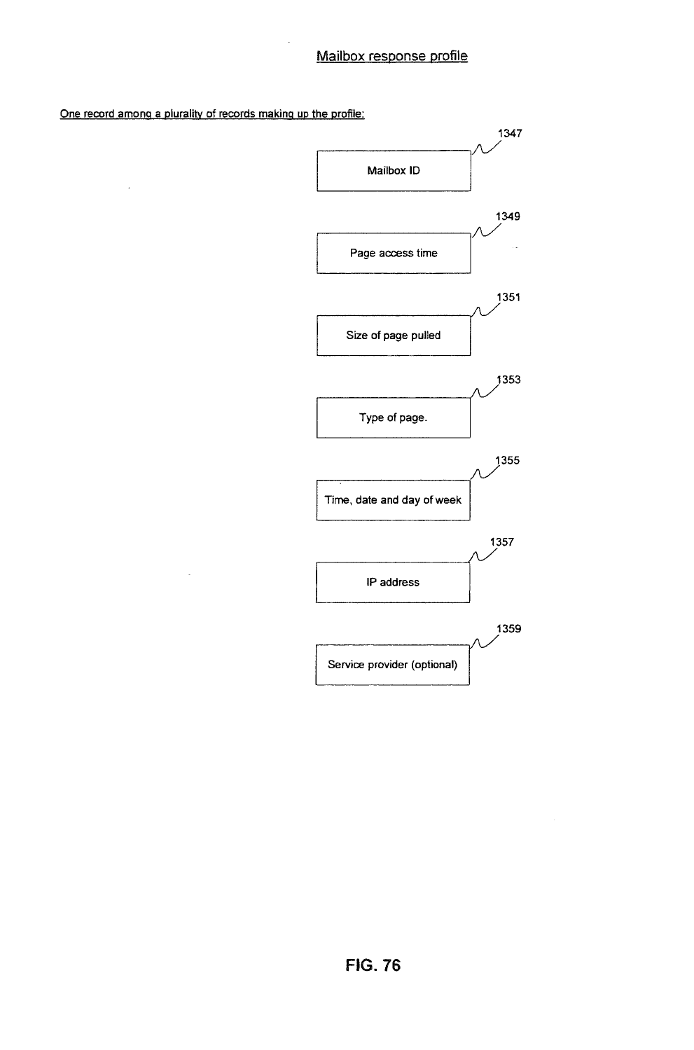

FIG. 76 is a mailbox response profile definition where the mailbox profile is defined based on client pull usage, i.e. access time for every page and size pulled and time and day of week, showing fields 1347-1359.

As shown in FIG. 76, a record in a table stores the response of a request for web pages that contain client requested information (i.e. messages, headers). The record consists of a mailbox identifier, an access time for the page, the size of the data pulled, the type of page (i.e. headers, messages), and the time, date, and day of week, and the IP address and optionally the service provider of the requestor.

The purpose of the above is to represent one of a plurality of records that collectively indicates the general responsiveness of a mailbox from the user perspective, so that it can be used as one basis for the moving of mailboxes to one or more alternate locations where resources will be better utilized.

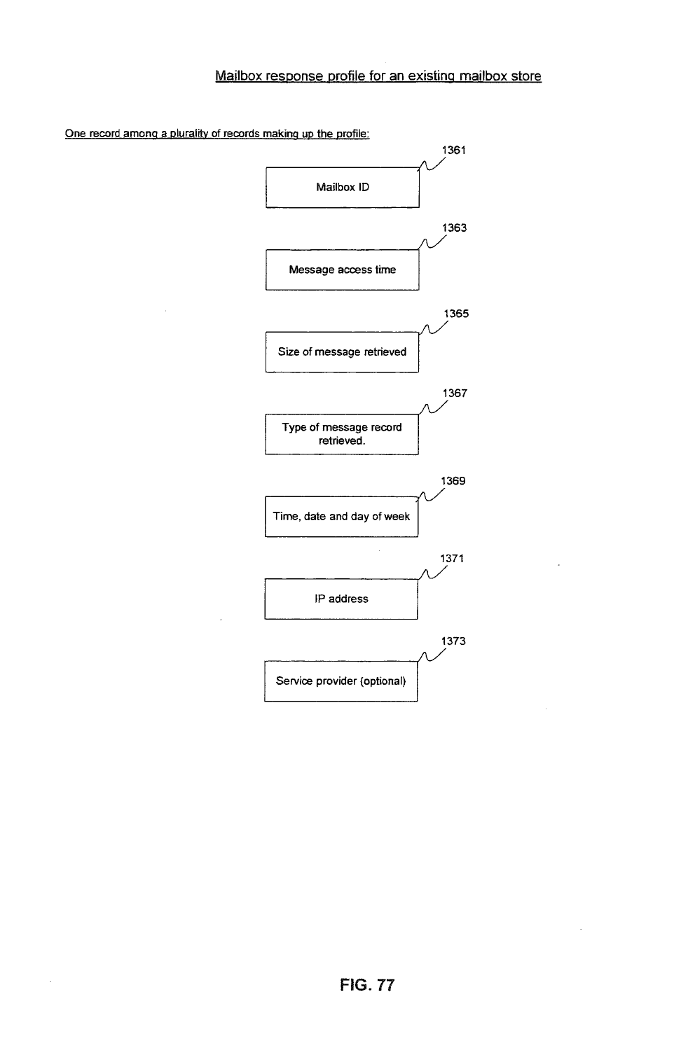

FIG. 77 is a mailbox response profile definition for a mailbox in an existing mail system, showing fields 1361-1373.

As shown in FIG. 77, a record in a table stores the response of a request for mailbox messages in an existing mailbox store that contain client requested information (i.e. messages, headers). The record consists of a mailbox identifier, an access time for the page, the size of the data pulled, the type of data pulled (i.e. message information, IMAP4 information, etc.) and the time, date, and day of week, and the IP address from the client and optionally the requestor's service provider.

The purpose of the above is to represent one of a plurality of records that collectively indicate the general responsiveness of a mailbox in an existing mail store from the user perspective, so that it can be used as one basis for the moving of mailboxes to one or more alternate locations where resources will be better utilized.

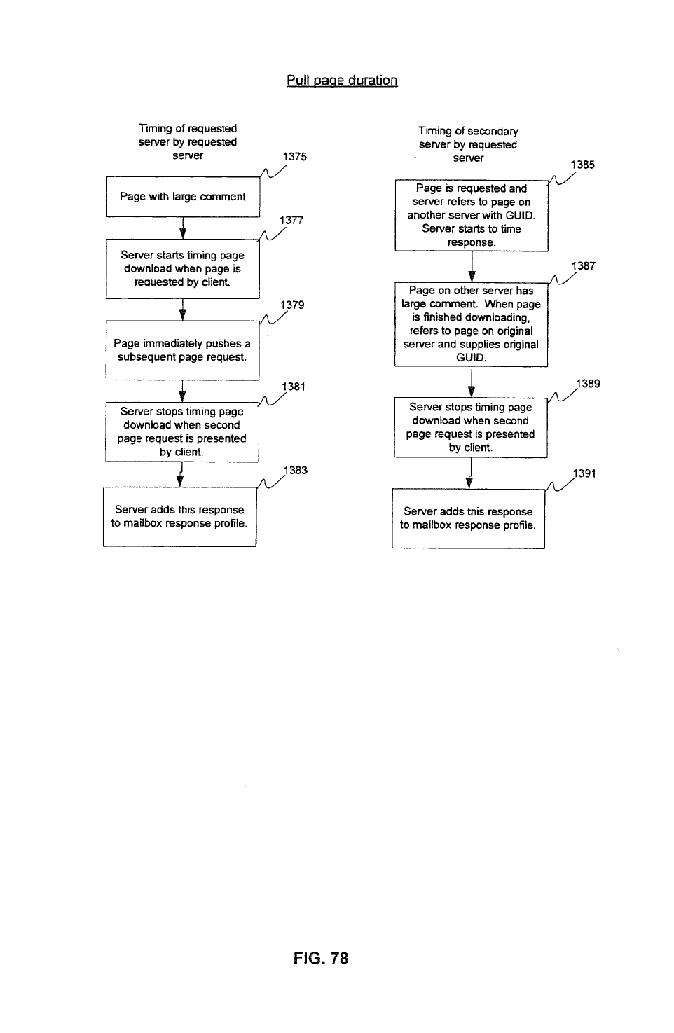

FIG. 78 is a flow diagram of server timing as it times the differential between successive page requests to obtain the server duration required to pull the page from the requested server, or from a remote server, showing steps 1375-1391.

As shown in FIG. 78, the server that serves the mailbox pages can add records to the mailbox response profile by timing the period between two successive page requests, where the first page is sizable and where the first page pushes an immediate request for the second page after downloading the first page. For example, in a webmail system, where the sender logs into an account which permits the composing of mail, and the display of received mail, instead of immediately displaying the mailbox view, the system instead points to a page that contains a large HTML comment and which is designed, after pulling the first page to pull the page with the display of received mail. The server times the duration between the first and second page pull for this user of the system, and records the relevant information in the mailbox response profile. This information does not need to be acquired at every mailbox pull, it can be established by the server that this information will only be pulled where there is insufficient profile information, for instance, for a particular mailbox.

The above builds a mailbox response profile, which is subsequently used in the determination as to whether to move a mailbox.

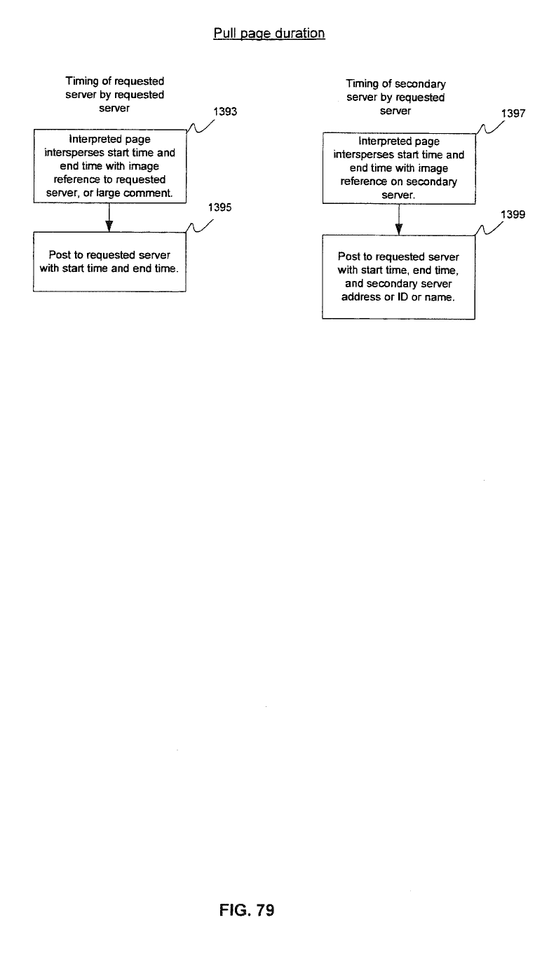

FIG. 79 is a flow diagram of an interpreted program on a web page that is used to obtain the client duration to pull the page from the requested server, or from a remote server, showing steps 1393-1399.

As shown in FIG. 79, an HTML page can be coded to perform the timing of the downloaded page, and to post that information back to the server that stores the mailbox response profile. This is performed with interpreted code within the HTML page (i.e. Javascript, etc.) that determines the initial time before the loading of the entire page, and determines the ending time after the load of the entire page, and posts that information back to the server.

The above builds a mailbox response profile, which is subsequently used in the determination as to whether to move a mailbox.

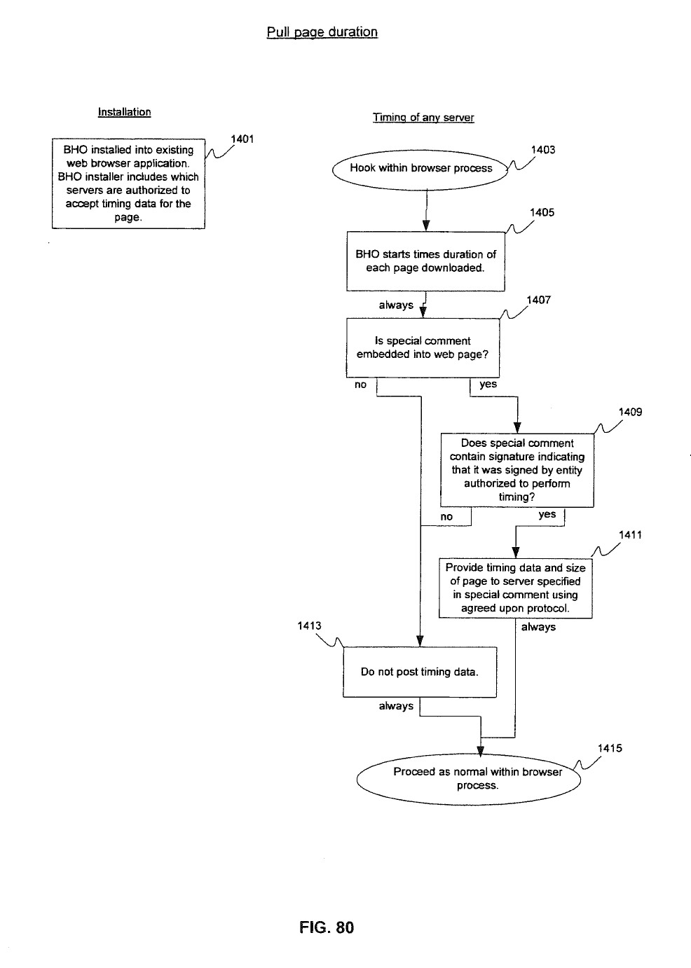

FIG. 80 is a flow diagram of a browser helper object (BHO) that is used to obtain the client duration to pull the page from the requested server, or from a remote server, showing steps 1401-1415.

As shown in FIG. 80, a browser helper object that is installed in the process space of the user's web browser can determine, based on a specially constructed HTML comment located in the page, whether to time the downloaded page or subsequent pages from the domain specified. The authorization for making the timing determination is embedded by way of a signed comment, i.e. the comment containing not only instructions to time pages, but also that the action is authorized by virtue that the comment can be checked as having been signed by the server that is authorized to request the timing data of the BHO.

The above builds a mailbox response profile, which is subsequently used in the determination as to whether to move a mailbox, where the profile information is directed to the authorized server.

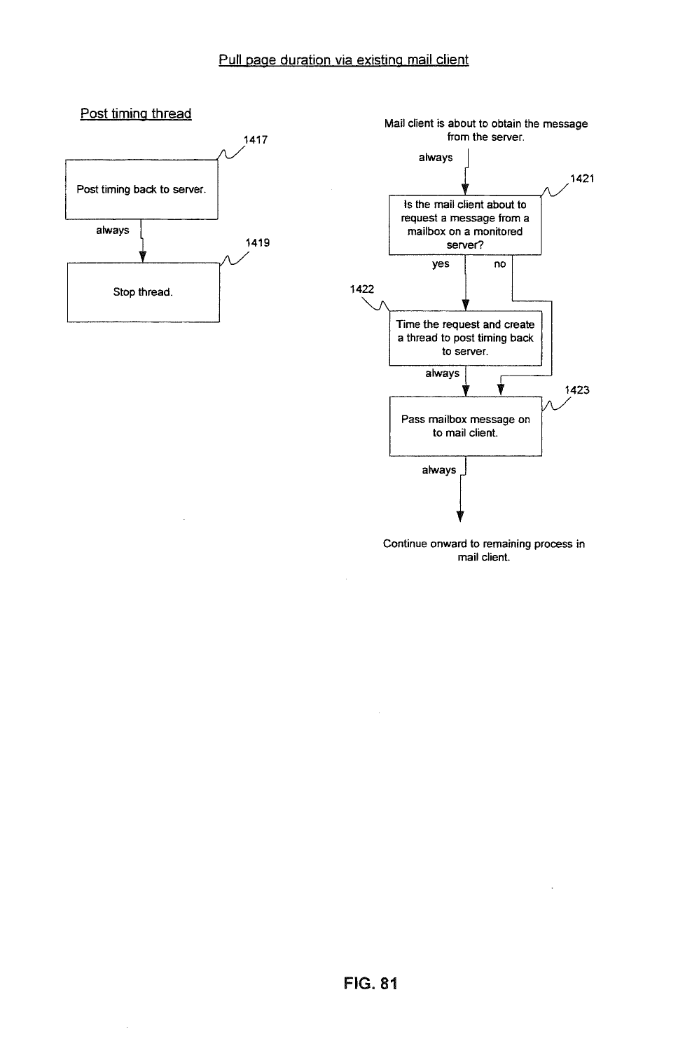

FIG. 81 is a flow diagram of obtaining client pull timing used to build a mailbox response profile, showing steps 1417-1423.

As shown in FIG. 81, an existing mail client times the duration and size of a mail message before posting that information back to the server that records it as part of a mailbox response profile. The hook to this procedure in the existing mail client is at the point where the mail message is about to be retrieved from the server.

The above is a modification to an existing mail client to enable it to obtain information about the responsiveness of mailboxes at an existing mail store, so that the response profile for the existing mail server system can be stored and subsequently used for the purpose of determining whether to move the mailbox.

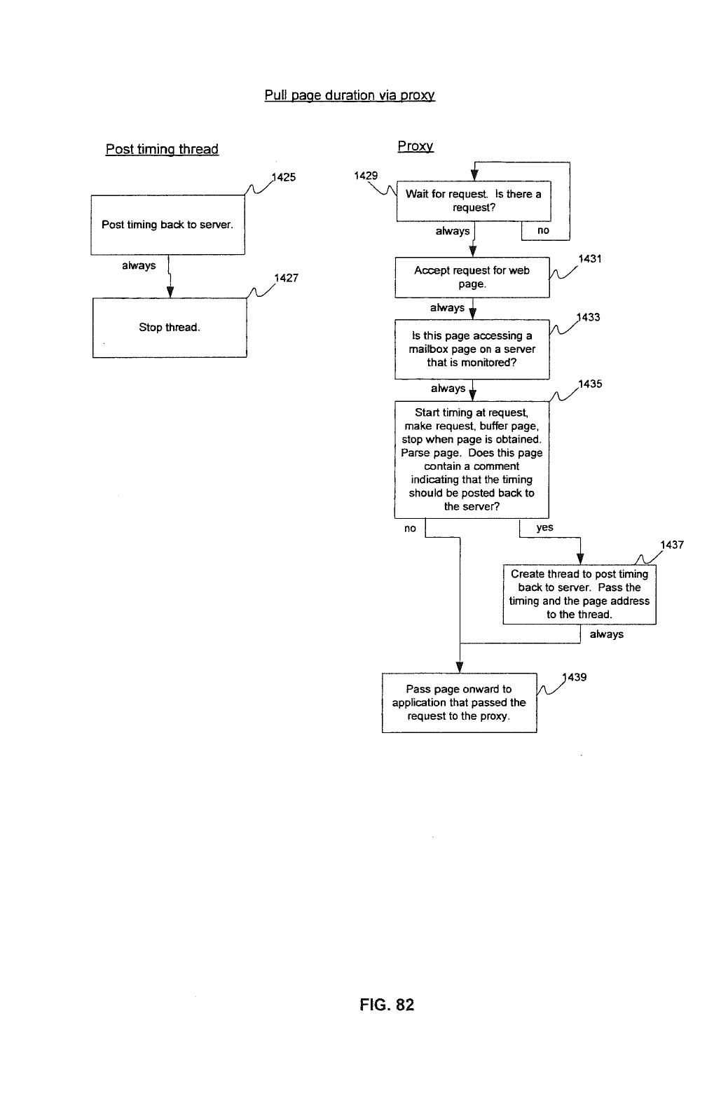

FIG. 82 is a flow diagram of a timing-proxy that pulls data down using typical protocols (HTTP/S, IMAP4, POP3, etc.) and feeds response information to a server, showing steps 1425-1439.

As shown in FIG. 82, a proxy that is installed by the user where the web browser points to the proxy can determine, based on a specially constructed HTML comment located in the page, whether to time the downloaded page or subsequent pages from the domain specified. If so, the timing information is posted back to the server that prepared the proxy.

The above builds a mailbox response profile, which is subsequently used in the determination as to whether to move a mailbox, where the profile information is directed to the authorized server.

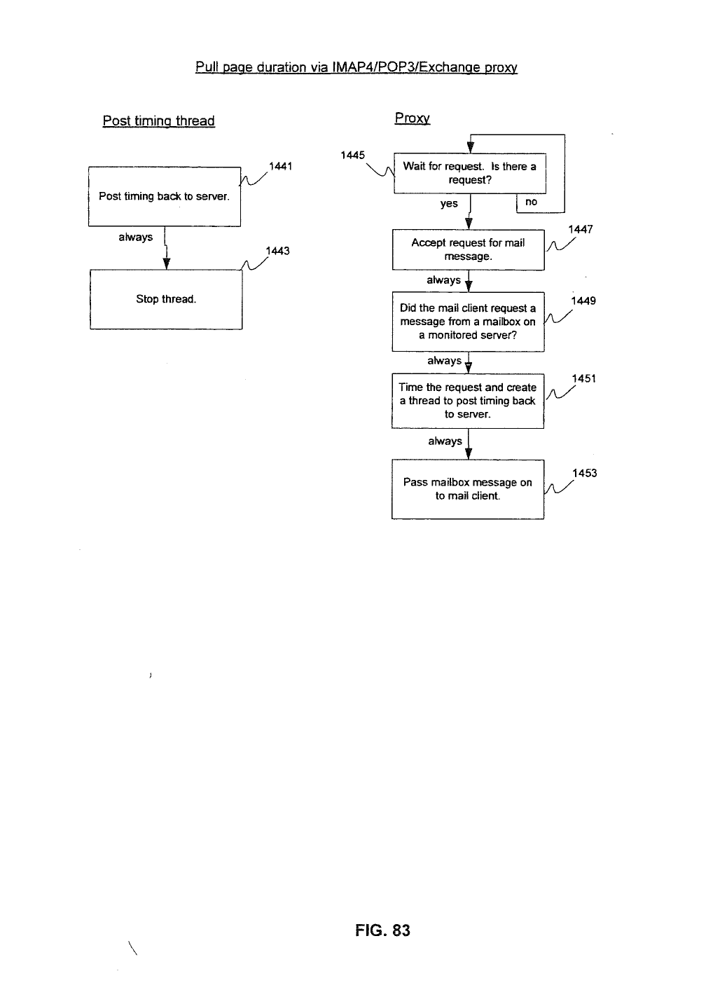

FIG. 83 is a flow diagram of a proxy pull method of populating the mailbox response profile, showing steps 1441-1453.

As shown in FIG. 83, a proxy sits between the requesting client and the server that provides the mailbox data. The proxy is pre-programmed to present timing information back to the server, in order that the server might build a mailbox response profile for the mail server.

The above is a method to obtain information about the responsiveness of mailboxes at an existing mail store, accessed behind the firewall or across the internet to the mail server, so that the response profile for the existing mail server system can be stored and subsequently used for the purpose of determining whether to move the mailbox.

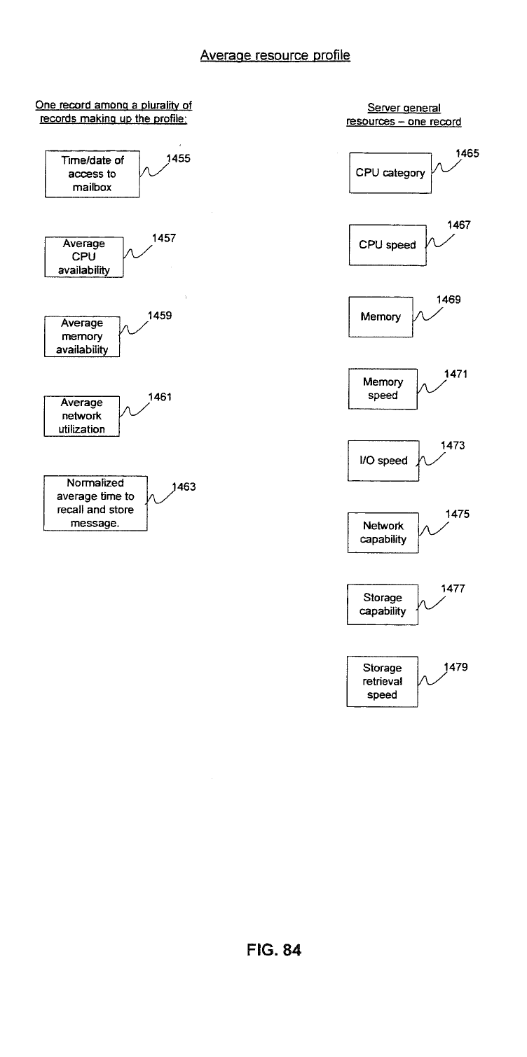

FIG. 84 is a definition of the average resource profile per message store server, where the average profile resource usage (CPU usage, connection resources, etc.) of the server at the time of access to this mailbox is stored (resources in use) by time of day and date, showing steps 1455-1479.

As shown in FIG. 84, a profile is defined for the resource utilization and capability of the server, where the recording of such information takes place during the time that the mailbox is accessed. As also shown in FIG. 84, the system is checked periodically and the server general resources record is changed if a change in system resources occurs (i.e. more memory is added, a substantial decrease in disk availability occurs, etc.).

The above is used to record resource utilization used to determine, in combination with the mailbox response profile, whether to move a mailbox.

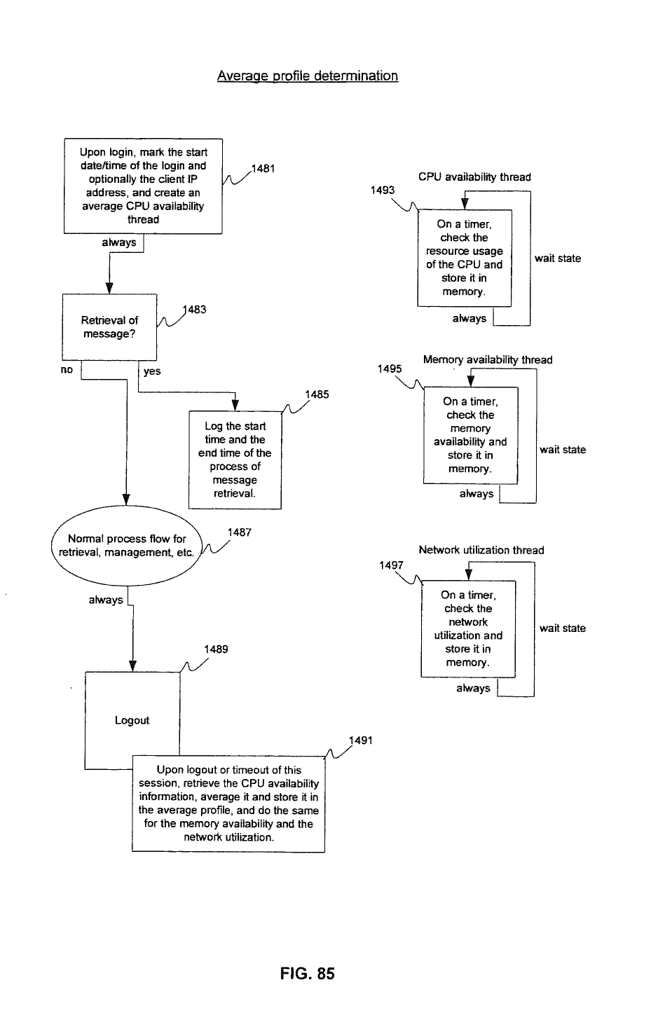

FIG. 85 is a flow diagram of a process that determines multiple average resource profiles, showing steps 1481-1497.

As shown in FIG. 85, the basis for the average resource profile records is recorded by three threads, the CPU availability thread, the memory availability thread and the network utilization thread, that are created and executed in response to a request for mailbox information.

The above is one embodiment of the process of recording the average profile for resource utilization, subsequently used in the determination of whether to move a mailbox.

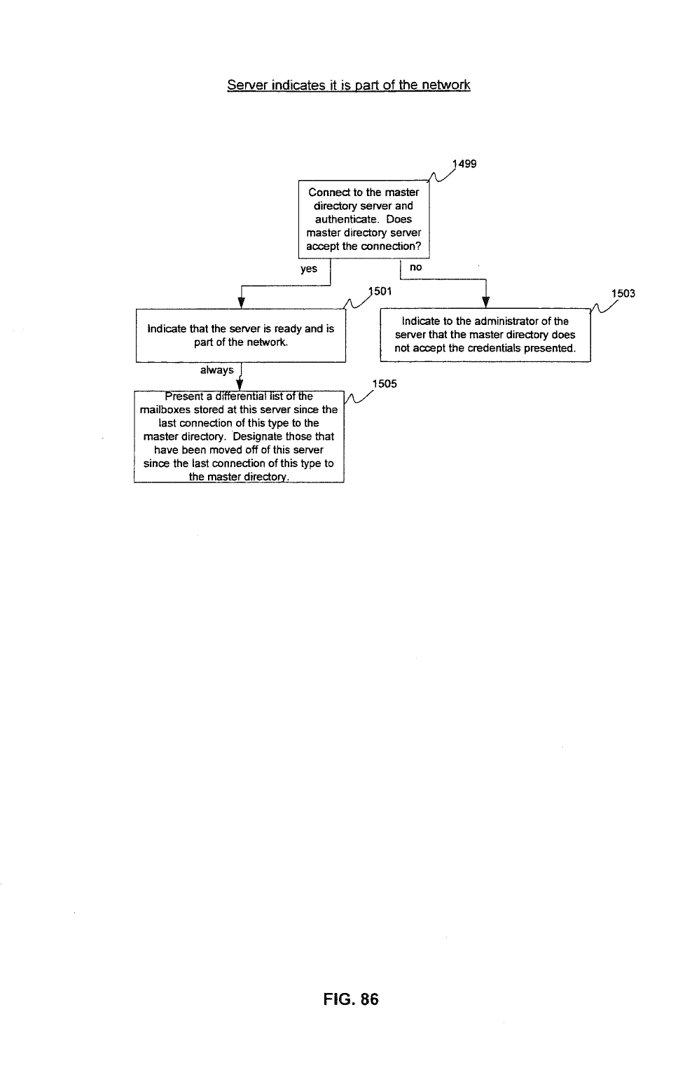

FIG. 86 is a flow diagram of a server that authenticates into a master directory server to indicate its presence as part of the network and to indicate the mailboxes for which it is responsible, showing steps 1499-1505.

As shown in FIG. 86, a server establishes itself as part of a network of servers that serve mailbox information by authenticating into a master directory and presenting a current, or differential list of mailboxes to the master directory.

The purpose of the above is to centralize directory services for the location of mailboxes, so that requests to acquire mailbox data (messages, etc.), can be directed to the appropriate server.

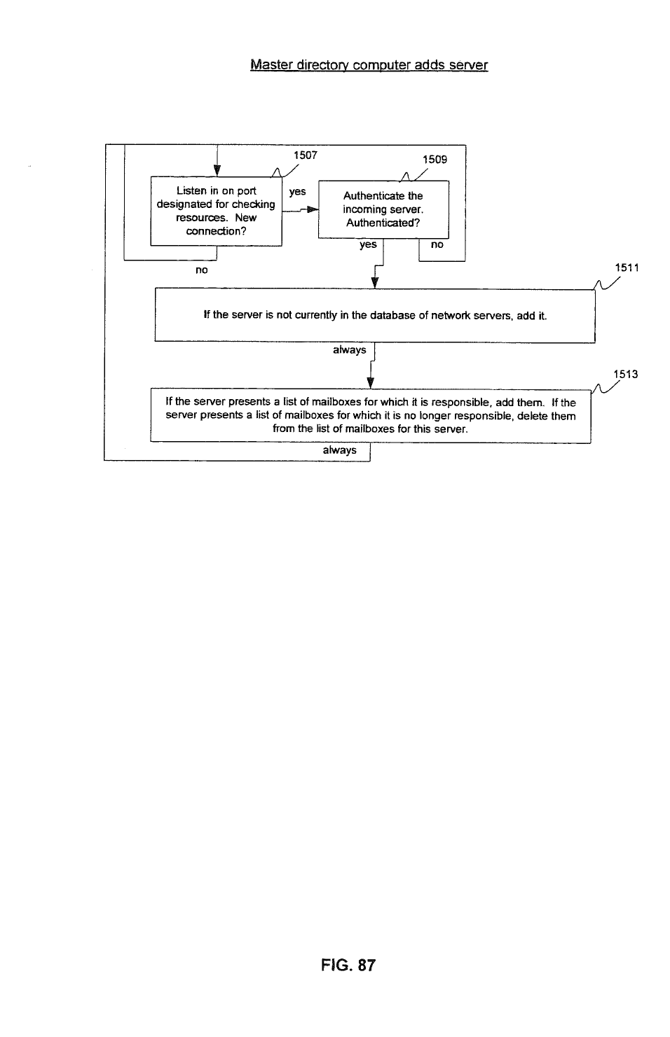

FIG. 87 is a flow diagram of a master directory server that authenticates a server and adds its address to the list of computers in the network, showing steps 1507-1513.

As shown in FIG. 87, a master directory server accepts authenticated connections from servers desiring to be added to the network, and accepts the list of mailboxes for which the authenticating server is responsible.

The purpose of the above is to centralize directory services for the location of mailboxes, so that referrals to acquire mailbox data (messages, etc.), can be directed to the appropriate server.

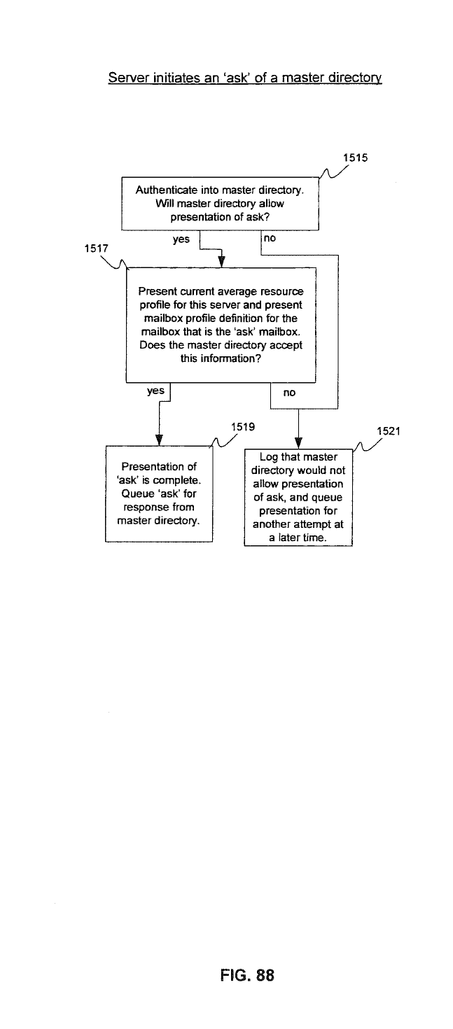

FIG. 88 is a flow diagram of a server as it initiates and presents an ‘ask’, i.e. a request from other servers to bid on a mailbox based on responsiveness, to a master directory, showing steps 1515-1521.

As shown in FIG. 88, a server with a mailbox that has made the determination that the mailbox responsiveness is sufficiently low, or because of limited or reducing resources, requests that the master directory broker a transaction whereby the mailbox may eventually be moved to another server.

As shown in FIG. 88, the server with the mailbox authenticates into the master directory, presents the relevant average resource profiles and the mailbox profile definition to the master directory, and if the master directory accepts the information, the transaction is queued for subsequent action by a thread that communicates that information to other servers that they might bid on the mailbox presented by the authenticated server.

The above is part of the bid/ask mechanism for preparing to move a mailbox from one server to another server where it is better located

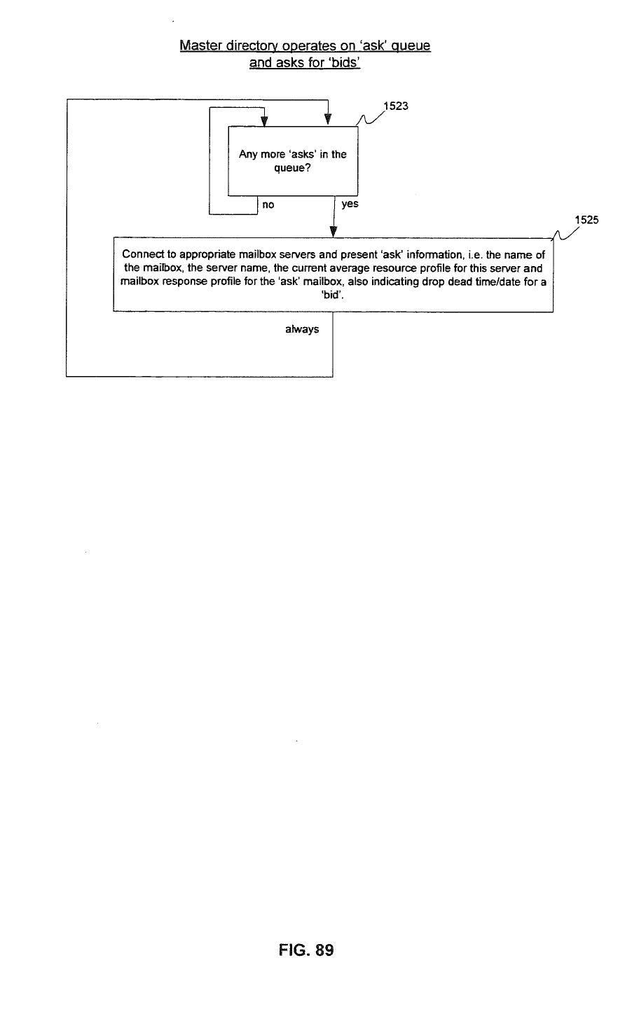

FIG. 89 is a flow diagram of the master directory server as it operates on the ‘ask’ queue, connecting to available servers to provide the ‘ask’ information, accepting the ‘bids’ from the servers, and supplying the best ‘bid’ from available servers, showing steps 1523-1525.

As shown in FIG. 89, in the event that ‘ask’ requests are in the queue, the master directory server may connect to other mailbox servers, depending on the profiles present in the ‘ask’, to indicate that an ‘ask’ is available, the name of the mailbox, the server name, the average resource profile of the server requesting the ‘ask’ transaction, the mailbox response profile for the server that had made the ‘ask’ and the drop dead time and date for a ‘bid’ on the mailbox.

This above is to support the bid/ask mechanism for preparing to move a mailbox from one server to other server where the mailbox is more responsive to the end user, and utilizes available resources more efficiently.

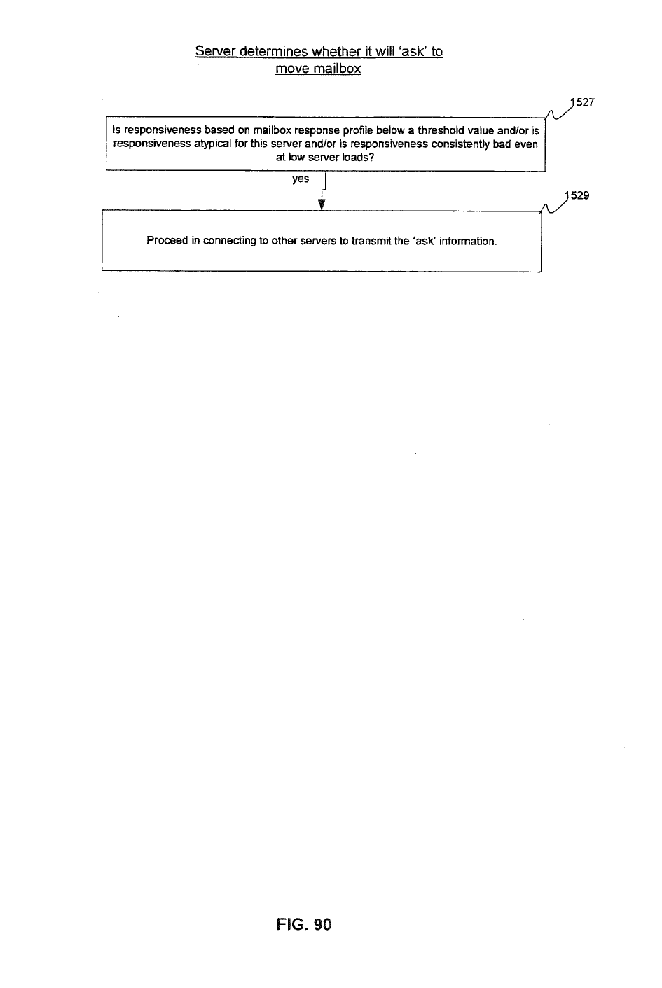

FIG. 90 is a flow diagram of the determination of a server whether to start the process of sending an ‘ask’ request to the master directory, showing steps 1527-1529.

As shown in FIG. 90, a server may make a periodic assessment of its mailboxes, determining if certain mailboxes are consistently showing significantly lower response rates than others, or making a determination that at the current rate the system will continue to incur a reduction in resources as a result in the addition of new mailboxes, and will subsequently request the master directory to broker an ‘ask’.

This above is to support the bid/ask mechanism for preparing to move a mailbox from one server to other server where it is more responsive to the end user, and utilizes available resources more efficiently.

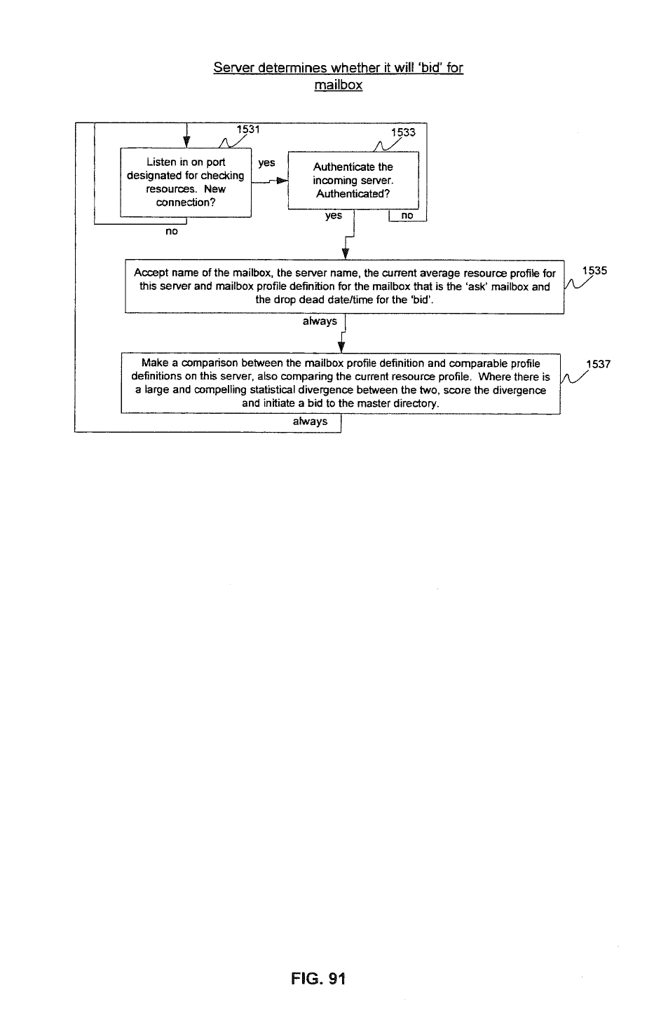

FIG. 91 is a flow diagram of a server making a determination as to whether it will bid on accepting the mailbox, based on usage, time of day profiling, relative response time, client service provider, availability of other servers, and redundancy, showing steps 1531-1537.

As shown in FIG. 91, a server that has accepted an ‘ask’ makes a determination as to whether it will bid on the mailbox by comparing the mailbox profile definition and any comparable profiles on the server, by date and time and optionally by client service provider, and by comparing the server resource profiles given the time of use of the mailbox. Where there is a large, statistically significant divergence, the process quantifies the divergence and bids on the mailbox if the quantified divergence is above a certain threshold. Note that as a result of accepting one or more bids, the existing mailbox resource profiles may be deleted or marked as not used in averages, especially for those time periods where the new mailbox is accessed. Note also that the bid may not take place if the mailbox has already resided previously on this server, this having been noted in a table on each server.

This above is to support the bid/ask mechanism for preparing to move a mailbox from one server to other server where it is more responsive to the end user, and utilizes available resources more efficiently.

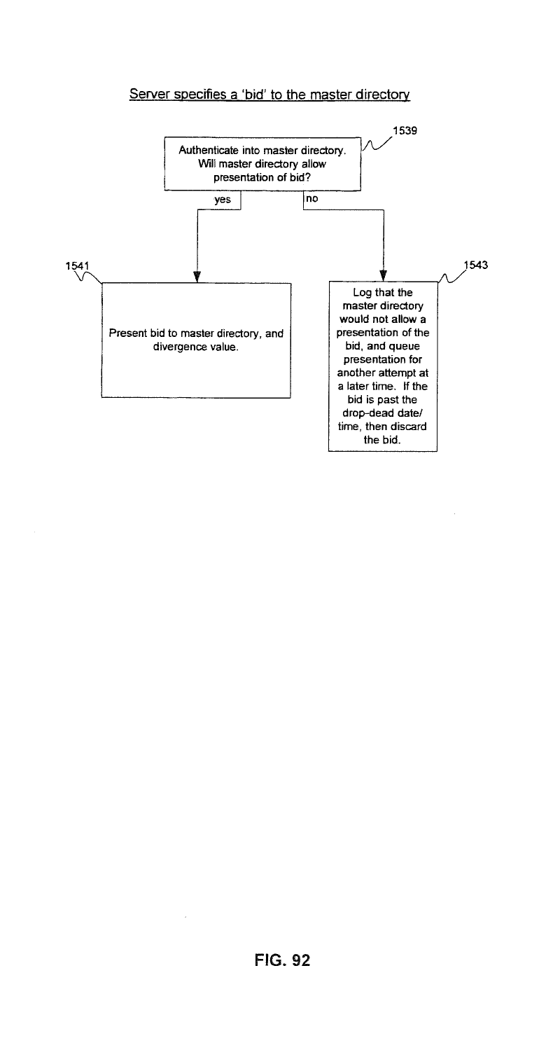

FIG. 92 is a flow diagram of a server as it communicates a ‘bid’ to a master directory, showing steps 1539-1543.

As shown in FIG. 92, once it has been determined by a server that it will bid on a mailbox, the server connects to the master directory and presents the bid. In the event that the master directory will not accept the bid, the bid is queued for presentation at another time, and the bid is expired if it is past the drop-dead date and time.

This above is to support the bid/ask mechanism for preparing to move a mailbox from one server to other server where it is more responsive to the end user, and utilizes available resources more efficiently.

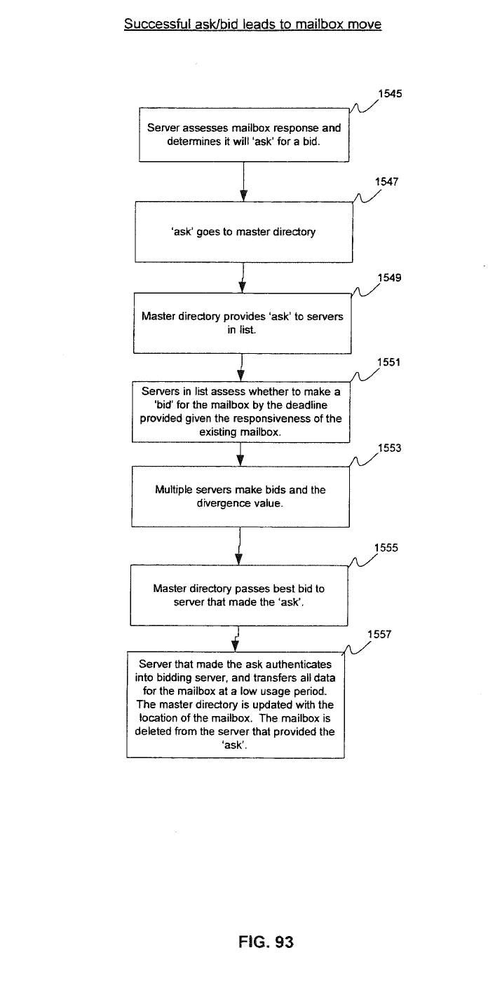

FIG. 93 is a general diagram of a server making an accepted ‘bid’ and the subsequent mailbox moving process that the ‘bid’ initiates, showing steps 1545-1557.

As shown in FIG. 93, the overall mechanism for the bid/ask process is shown, resulting in a mailbox move if the bid/ask process goes to completion. First, the server with the mailbox assesses whether it will ‘ask’ for a bid based on the responsiveness of the mailbox, per the contents of the mailbox response profile. The server resource profile is accounted for in the determination, i.e. if the resource usage is high at the time the mailbox is accessed, then this is taken into consideration in the determination as to whether the mailbox is considered less responsive than ideal, or what is likely to be provided on another server. Subsequently, once it has been determined that an ‘ask’ will be performed, the server with the mailbox authenticates into the master directory, which at its discretion forwards the ‘ask’ to other servers. If these servers historically reject similar bids, or by other criteria, the master directory may not proffer the ask. Those servers that receive the ‘ask’ make an analysis as to whether to bid on the ‘ask’ based on their average resource utilization at the time the ‘ask’ mailbox is historically used, and based on the potential bidding server's resources and based on responsiveness of other mailboxes residing on the server with similar mailbox response profiles. In the event that the server proceeds with the bid, the master directory will initiate a move with a bid and transfer the mailbox from the asking server to the bidding server, and update the master directory's record as to the location of the mailbox.

The above is the mechanism by which a mailbox move occurs based on the responsiveness of the mailbox, and the resource utilization of the mailbox network.

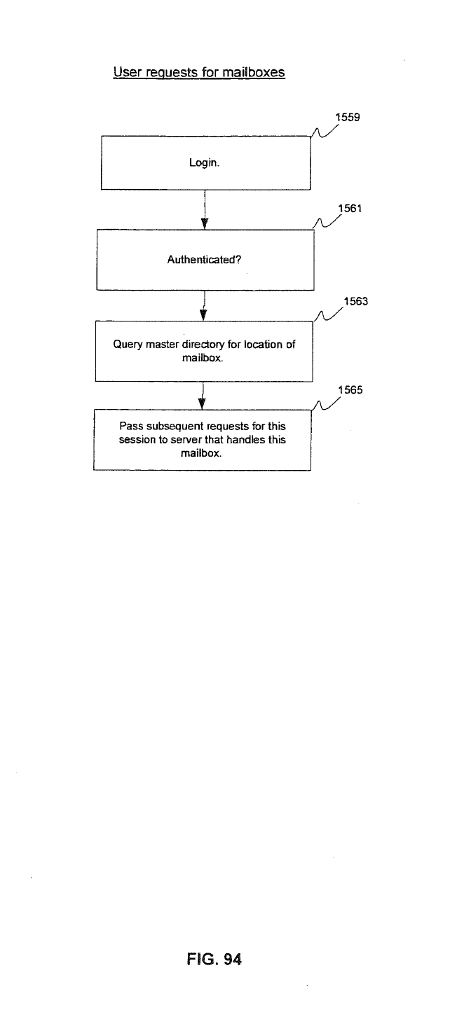

FIG. 94 is a general diagram of forwarding requests from front-end server directly to the back-end server where the mailbox is stored, and where the front-end server performs the authentication and passes it through to the back-end server, showing steps 1559-1565.

As shown in FIG. 94, a user login to a mailbox may be forwarded directly to the system that stores the mailbox, as specified by the master directory.

The purpose of the above is to support user access to a system where user mailboxes are not located on one machine.

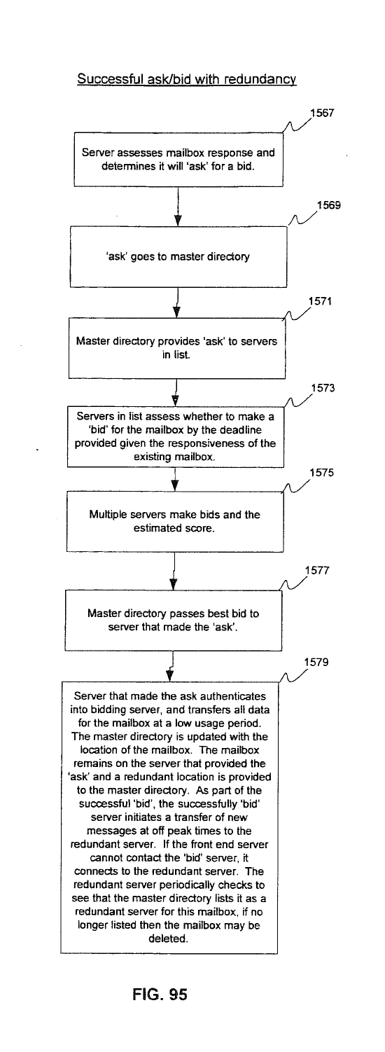

FIG. 95 is a flow diagram of retaining the mailbox subsequent to the determination that the response is better on the new mailbox. The newer mailbox provides messages to the redundant mailbox, showing steps 1567-1579.

As shown in FIG. 95, when the transfer of the mailbox occurs, the original mailbox is retained on the asking server, the master directory is updated to retain an entry for a redundant server. In the event that a redundant server is already listed, the mailbox on the asking server is deleted. In the event that the master directory no longer lists a redundant server, the redundant server deletes the redundant mailbox. In the event that a redundant server is listed, the primary server as listed in the master directory periodically contacts the redundant server and transfers any new messages since the last transfer, or indicates which messages have been deleted by the user or administrator. In the event that the front-end server cannot connect to the primary server through the master directory, the front-end server refers the client to the redundant server.

The above provides for redundancy within the mailbox move framework.

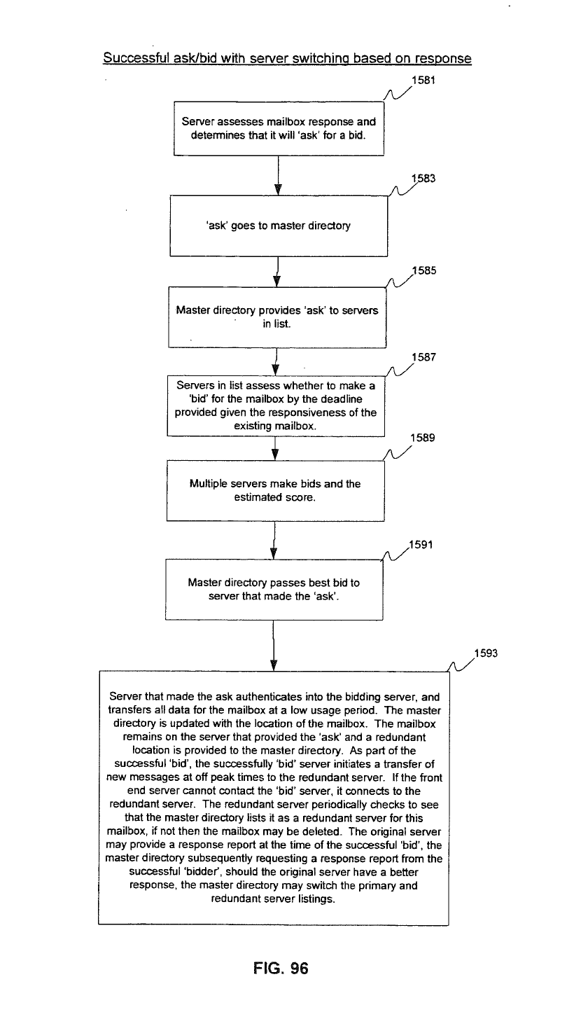

FIG. 96 is a flow diagram of retaining the mailbox on the server where the mailbox is originally located until it is determined that the response is better on the new mailbox, and shows the subsequent deletion process, showing steps 1581-1593.

As shown in FIG. 96, as part of the ‘bid-ask’ process, the master directory may switch the primary and redundant server listings for the mailbox and request mailbox response profiles from both servers to determine which one is more responsive.

The above provides a mechanism whereby it is possible to determine whether the primary or redundant server is generally better suited for responding to client requests.

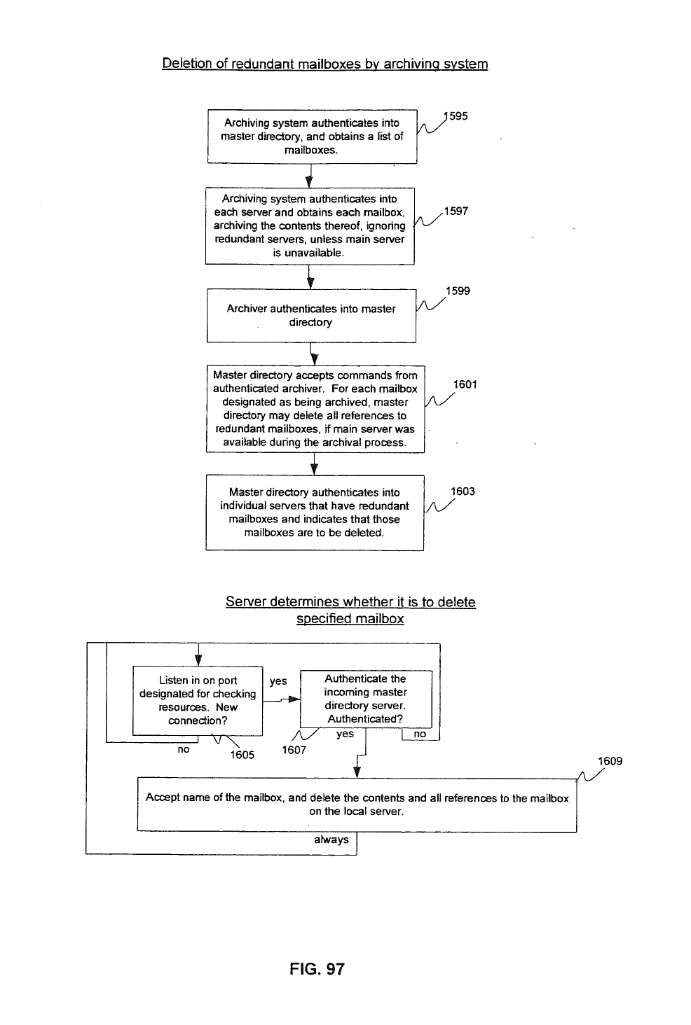

FIG. 97 is a general diagram of an archiver that can backup up the mailboxes present in the mailbox move system and a flow diagram of redundant mailboxes removed at the instruction of the archiver, showing steps 1595-1609.

As shown in FIG. 97, an archiving system can authenticate into the master directory to obtain a list of mailboxes, authenticating into each mailbox to obtain the messages (ignoring the redundant servers unless the primary server is unavailable), causing the master directory to indicate to servers that have been archived to remove all instances of the redundant mailboxes. Also shown in FIG. 97 is the thread at the server that listens for the master directory instruction to delete the redundant mailboxes.

The above is to provide a mechanism where existing messages can be archived across multiple servers that store mailboxes on each server, and where the redundant mailboxes are deleted during this process. The purpose is to archive the mail messages and reduce storage requirements of the system because of existing redundancies.

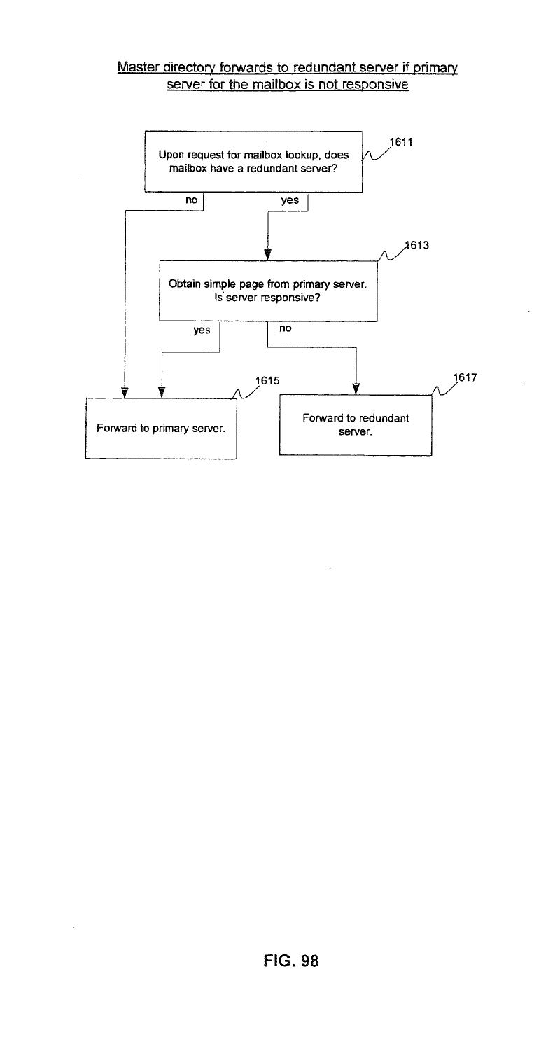

FIG. 98 is a flow diagram of the front-end server detecting the availability of the primary mailbox server, if the primary server is not online the front-end server redirects the client to the redundant mailbox, showing steps 1611-1617.

As shown in FIG. 98, the master directory server can be configured to forward the front-end server to the redundant server in the event that the master directory server cannot contact the primary server.

The above enables the front-end server to forward requests to a responsive server, regardless of whether the primary server is unresponsive.

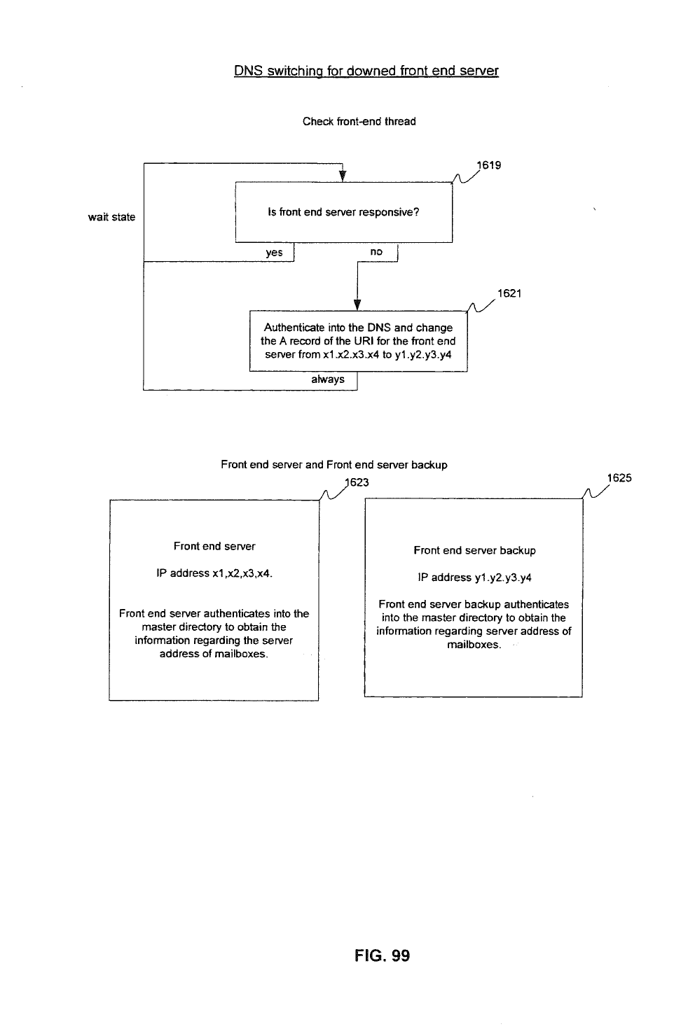

FIG. 99 is a flow diagram of a DNS switcher used to circumvent a non-responsive front-end server, showing steps 1619-1625.

As shown in FIG. 99, one thread operating on any server can determine whether the front-end server is responsive, and change the DNS record to another server that, as a backup, performs the same functions as the unresponsive front-end server.

The above is for the purpose of establishing redundancy in the front-end server of the system, so that even if the primary front-end server becomes unresponsive, the system will still function properly.

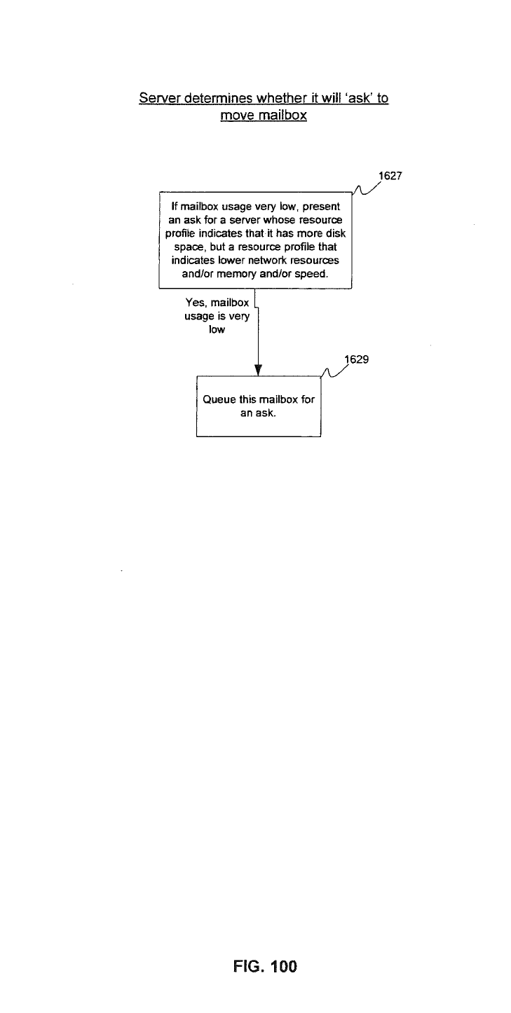

FIG. 100 is a flow diagram where mailbox usage is very low, the ‘ask’ is therefore constructed for a ‘bid’ from a server with lesser resources but more disk space, showing steps 1627-1629.

As shown in FIG. 100, an additional criterion is used where in the event that mailbox usage on a particular server is very low, the server presents a special ask that asks for a server with high storage capability, but not necessarily high responsiveness. This request is then forwarded to the master directory that hands it off to multiple servers that may respond with a ‘bid’ on the basis that their server's resource capability profiles that meet this description. There is no comparison of mailbox response profiles.

The above is so that storage resources can be better used among mailboxes that are infrequently used.

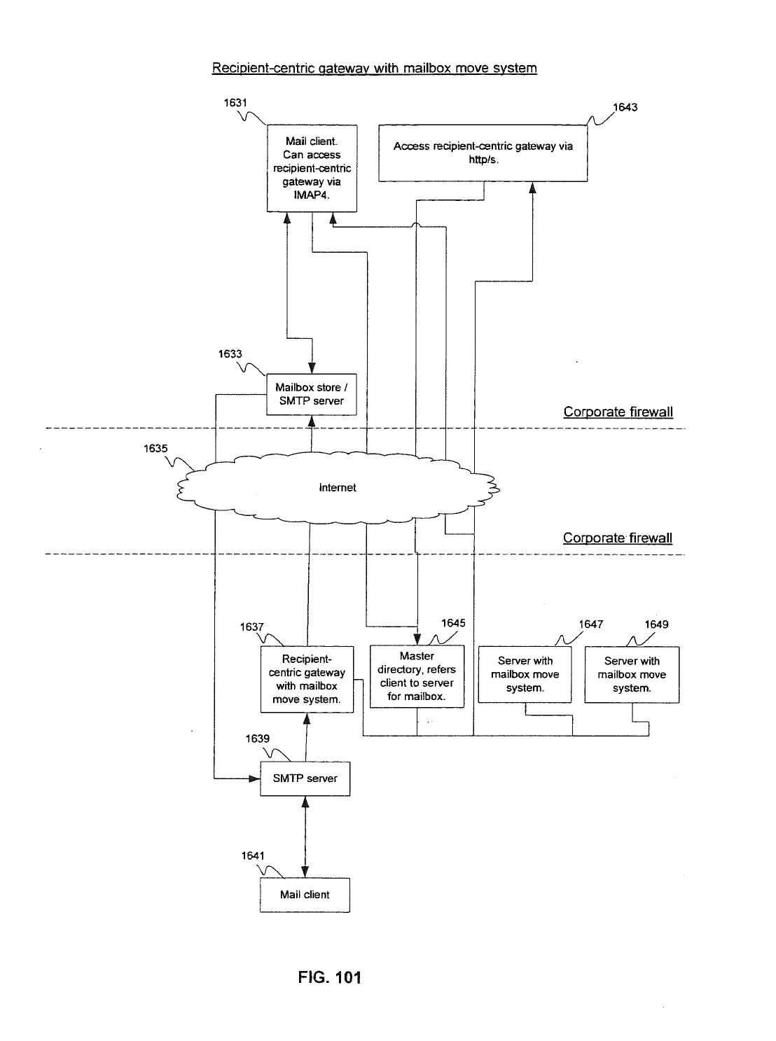

FIG. 101 is a general diagram of the recipient-centric mailbox system with the mailbox move system, showing steps 1631-1649.

As shown in FIG. 101, the mailbox move system is coupled with the recipient-centric mailbox system. The recipient-centric mailbox mailboxes are subsequently moved off of the recipient-centric server to additional servers.

This provides greater responsiveness to the recipient-centric mailbox system, scalability and redundancy.

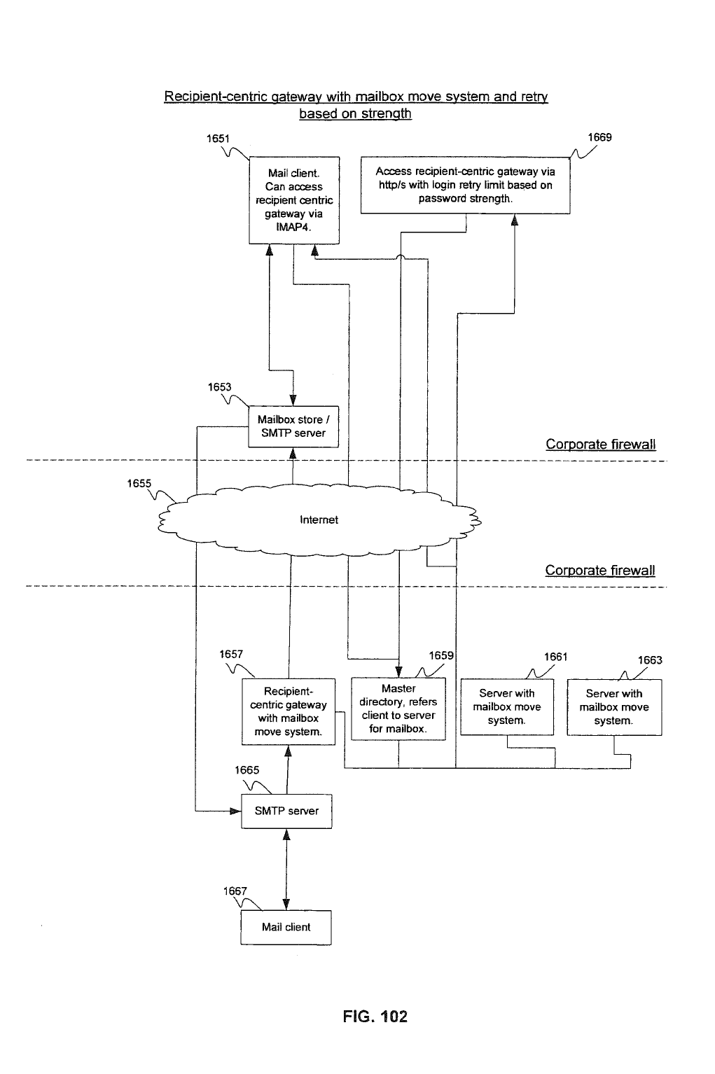

FIG. 102 is a general diagram of the recipient-centric mailbox system with the mailbox move system, and retry system based on password strength, showing steps 1651-1669.

As shown in FIG. 102, the mailbox move system is coupled with the recipient-centric gateway system utilizing the retry limit based on password strength.

This provides lowered costs due to password resets, lowered costs due to the ability to provide a larger number of lower cost servers while maintaining responsiveness (as opposed to providing one large recipient-centric gateway), and provides redundancy in the mailbox network.

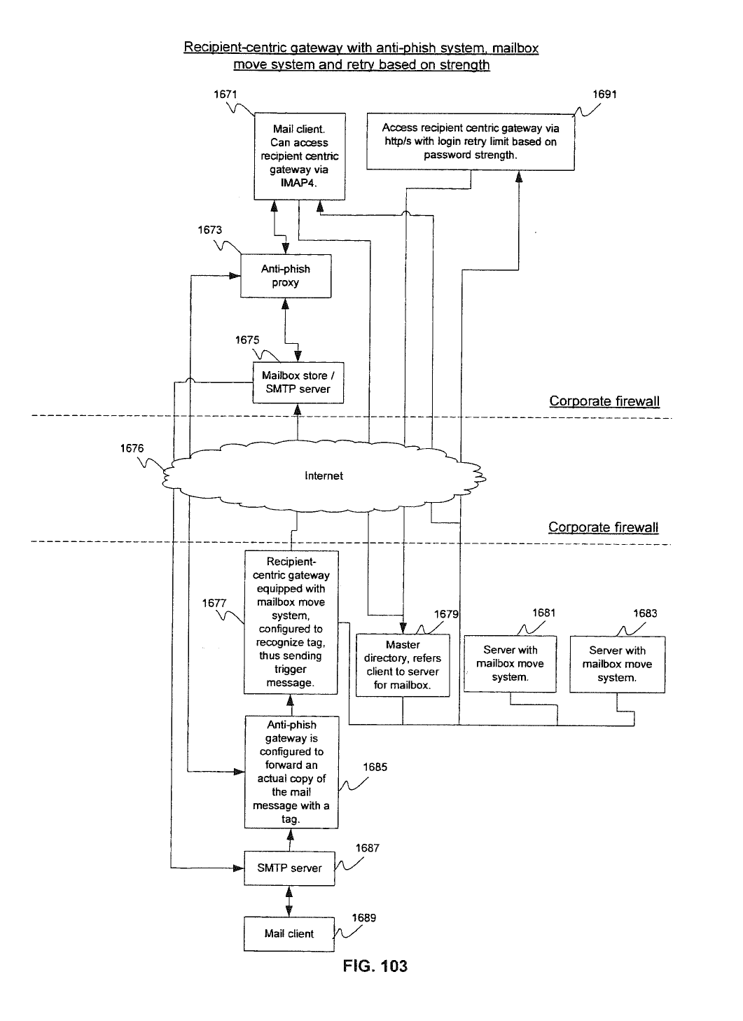

FIG. 103 is a general diagram of the recipient-centric mailbox system with the anti-phish proxy, mailbox move system, and retry system based on password strength, showing steps 1671-1691.

As shown in FIG. 103, the recipient-centric mailbox system is coupled with the mailbox move system, the anti-phish proxy and gateway and the password reset based on password strength system are included.

The above provides that senders can guarantee that recipients are not phished to their mail client inbox by senders purporting to be from the domain of the sender, provides senders behind the firewall the ability to view correspondence to recipients as seen from the perspective of recipients, and provides a more responsive mailbox network while minimizing costs.

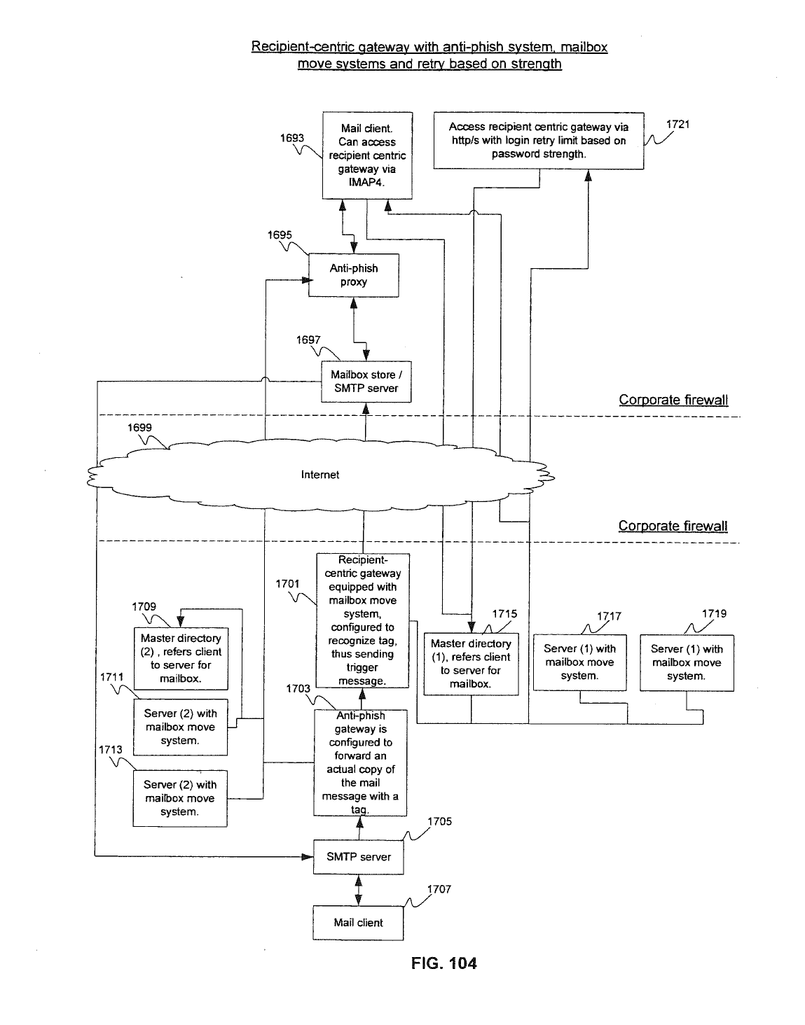

FIG. 104 is a general diagram of the recipient-centric mailbox system with the anti-phish proxy, mailbox move system, and retry system based on password strength, showing steps 1693-1721.

As shown in FIG. 104, the recipient-centric mailbox system is coupled with the mailbox move system labeled (1), the anti-phish proxy and gateway system are coupled with a different mailbox move system labeled (2), and the password reset based on password strength system is included.

The above provides that senders can guarantee that recipients are not phished to their mail client inbox by senders purporting to be from the domain of the sender, provides senders behind the firewall the ability to view correspondence to recipients as seen from the perspective of the recipients from all senders behind the corporate firewall, and provides a more responsive mailbox network while minimizing costs.

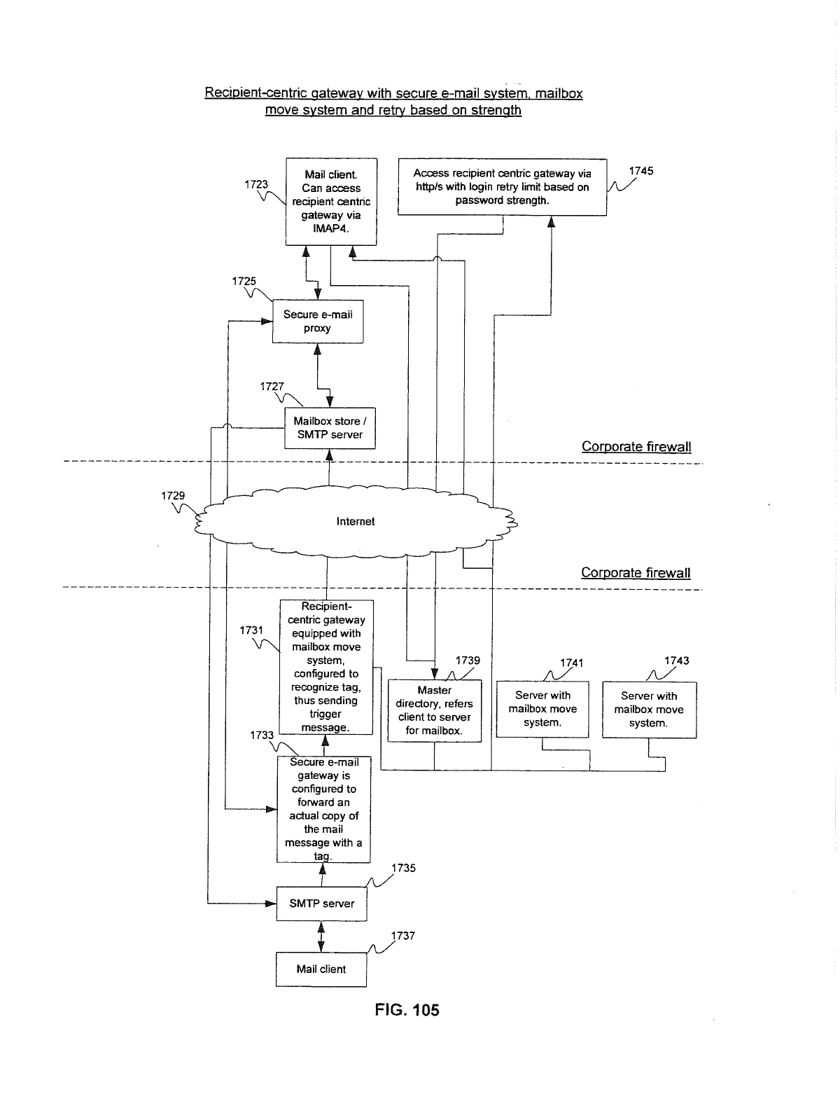

FIG. 105 is a general diagram of the recipient-centric mailbox system with the secure e-mail proxy, mailbox move system, and retry system based on password strength, showing steps 1723-1745.

As shown in FIG. 105, the recipient-centric mailbox system is coupled with the mailbox move system, the secure e-mail proxy and gateway, and the password reset based on password strength system.

The above provides senders behind the firewall the ability to view correspondence to recipients as seen from the perspective of the recipients from all senders behind the corporate firewall, provides that recipients receive mail securely, and provides a more responsive mailbox network while minimizing costs.

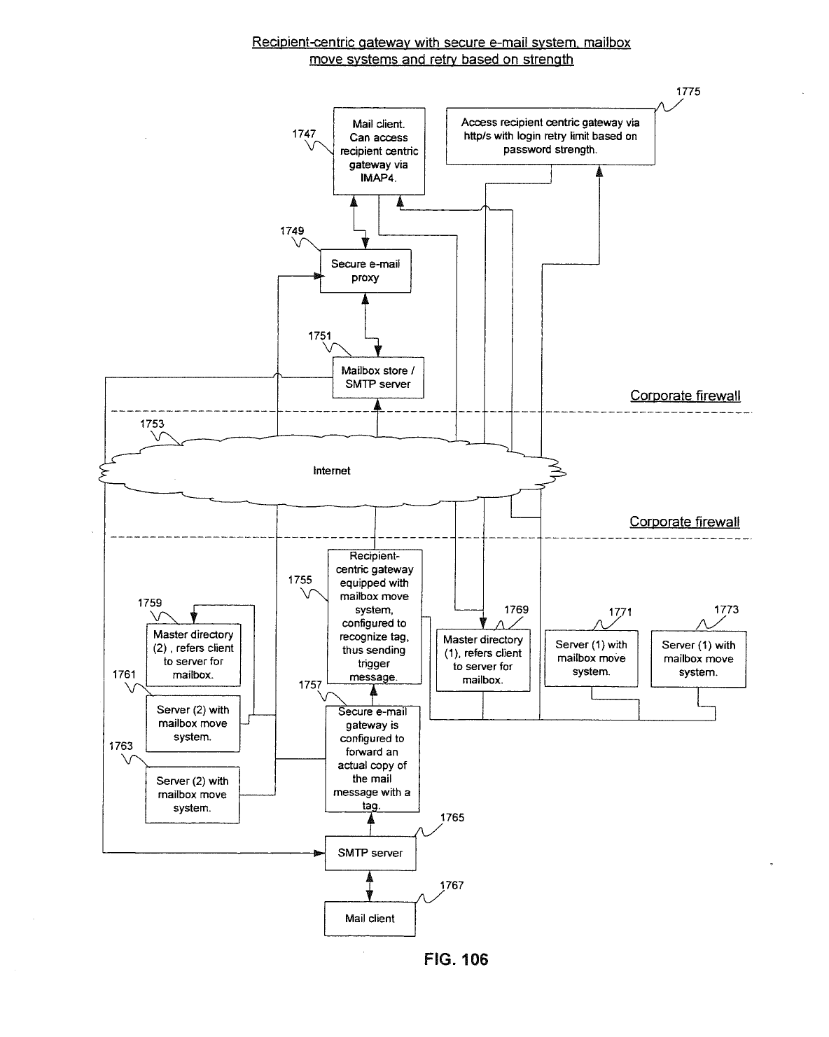

FIG. 106 is a general diagram of the recipient-centric mailbox system with the secure e-mail proxy and the mailbox move systems, and the retry system based on password strength, showing steps 1747-1775.

As shown in FIG. 106, the recipient-centric mailbox system is coupled with two mailbox move systems, one for the recipient-centric mailbox system and one for the secure e-mail proxy and gateway, and includes the password reset based on password strength system.

The above provides senders behind the firewall the ability to view correspondence to recipients as seen from the perspective of the recipients from all senders behind the corporate firewall, provides that recipients receive mail securely, and provides a more responsive mailbox network while minimizing costs due to password resets.

Having illustrated and described the principles of the present invention in preferred embodiments thereof, it should be readily apparent to those skilled in the art that the invention can be modified in arrangement and detail without departing from such principles. For instance, the term ‘encrypt with encrypting key’ can be used in an embodiment in lieu thereof where ‘generate a random symmetric key, encrypt the document with the symmetric key and encrypt the symmetric key with the public key’ is within the scope of this document, and ‘decrypt with the decrypting key’ can similarly mean ‘using the private key decrypt the encrypted symmetric key and use the symmetric key to decrypt the remainder of the document’. Similarly, whereas in the above the proxy that resides between the mail client and the mail server is described as a ‘proxy’, it can also be implemented as a network device driver. We claim all modifications coming within the spirit and scope of the accompanying claims.

I claim:

1. A method of presenting received e-mail messages of a recipient for viewing by at least one user other than the recipient comprising the steps of:
a) providing a gateway in communication with a mail server and mail client that each service one or more senders of e-mails;
b) making and storing a copy of at least one outgoing e-mail message to a recipient that is derived from one or more senders on the gateway;
c) authorizing one or more users to view the copy of the at least one outgoing e-mail message.

2. The method of claim 1, further comprising the step of a user accessing the gateway and viewing all copies of all outgoing e-mail messages sent to the recipient regardless of the sender.

3. The method of claim 1, wherein a plurality of users are authorized to view copies of outgoing e-mail messages.

4. The method of claim 1, wherein an alert is provided to a user that the recipient has received a new message.

5. The method of claim 4, wherein the alert is either digitally signed or the user employs a browser helper object to allow the user to verify that the alert is authentic.

6. The method of claim 4, wherein content in the outgoing e-mail message is either compared to a template, compared to a fixed string, or analyzed using a program to determine whether the alert should be sent.

7. The method of claim 1, wherein the user can still view the copy although the recipient has deleted a copy of a received outgoing e-mail message.

8. The method of claim 1, further comprising the step of the sender deleting or altering an outgoing e-mail message that is unread by a recipient.

9. The method of claim 1, further comprising the step of a recipient contacting the sender of an outgoing message or a third party via the gateway and a mail server.

10. The method of claim 1, wherein a plurality of gateways and a master directory of recipient addresses are provided, each recipient linked to one of the plurality of gateways, and determining which gateway an outgoing e-mail message for a given recipient should be stored on using the master directory.

11. The method of claim 1, wherein the gateway is a gateway proxy that services a number of user mail clients, outgoing e-mail messages being forwarded to the gateway proxy from the mail clients prior to being sent using the mail server.

12. The method of claim 1, wherein the gateway services a number of user mail clients, outgoing e-mail messages from the user mail clients passing through a mail server and then the gateway to the recipient, the gateway allowing viewing of the copy of the outgoing e-mail message by the user mail clients.

13. The method of claim 1, wherein the outgoing e-mail message originates from a mail server, the gateway linked to the mail server via the Internet.

14. A system for presenting a recipient's mailbox for viewing by a user other than the recipient comprising a gateway in communication with a mail server and mail client, each servicing one or more senders of e-mails, the gateway adapted to make and store a copy of an outgoing e-mail message sent by a sender to a recipient on the gateway, the gateway authorizing one or more users to view the copy of the outgoing e-mail message.

15. A method of improving security relating to entry of passwords to gain access to an account comprising the steps of:
a) providing a table of passwords;
b) providing a password strength algorithm;
c) determining the strength of a password using either the table of passwords or the password strength algorithm, and
d) assigning a retry count for an entered password based on the password strength, the retry count governing the number of times password entry can be attempted before the user is locked out of the account.

16. The method of claim 15, further comprising:
i) receiving a login password input by a user to access an account, each receipt of the login password establishing a count;
ii) comparing the login password or a hash thereof to either a stored password or a hash thereof or a stored blank password or a hash thereof; and either
allowing access to the account if the login password or hash thereof match the stored password or the stored password hash, or
if the login password or hash thereof do not match the stored password or the stored password hash, lock out the user when the number of counts exceeds the retry count, or
if the login password matches the stored blank password or hash thereof, allow the user to create a password for access to the account, or
if the stored password is blank or is a hash thereof, allow the user to create a login password for access to the account.

17. A method of preventing an e-mail recipient from being phished with an e-mail message comprising the steps of:
a) providing an anti-phishing proxy that communicates with a recipient's mail client;
b) providing at least one server on a network having a domain name, the server capable of sending a trigger e-mail, and a trigger related e-mail message;
c) receiving an e-mail message at the anti-phishing proxy;
d) using the anti-phishing proxy, checking to determine whether the e-mail message is a trigger e-mail; and
i) if the e-mail message is a trigger e-mail, performing an authentication using the at least one server, and deleting the trigger e-mail and passing the trigger-related e-mail message to the recipient; or
ii) if the e-mail message is not a trigger e-mail and does not contain the domain name, passing the e-mail message to the recipient; or
iii) if the e-mail message is not a trigger e-mail and contains the domain name, deleting the message.

18. The method of claim 17, wherein the trigger e-mail includes a link to allow the recipient to obtain the anti-phishing proxy for the checking steps.

19. The method of claim 17, wherein e-mail messages received that are not trigger messages and not containing the domain name are grouped with e-mail containing the domain name for viewing together.

20. The method of claim 17, wherein a plurality of servers are provided, and the anti-phishing proxy is adapted to check e-mail messages from the plurality of servers.

21. The method of claim 17, wherein a gateway on the server is provided, the gateway checking e-mail messages being sent from the server to determine if an e-mail message is destined for a recipient having the anti-phishing proxy, with the gateway either passing the e-mail message to recipients without the anti-phishing proxy, or storing the e-mail message and creating a trigger related message, and allowing access by the recipient to the e-mail message upon authentication of the recipient's anti-phishing proxy.

22. The method of claim 17, wherein the anti-phishing proxy deletes any e-mail messages having the domain name that do not contain a validated signature.

23. The method of claim 21, wherein the gateway receives outgoing e-mails, the gateway adapted to make and store a copy of the outgoing e-mail messages sent by a sender to a recipient, the gateway authorizing one or more users to view the copy of the outgoing e-mail message.

24. A system for preventing an e-mail recipient from being phished with an e-mail comprising an anti-phishing proxy disposed between a mail client and a mail server, the anti-phishing proxy adapted to check incoming e-mail messages for a domain name and a trigger message from a server for the domain name, the anti-phishing proxy either accepting the e-mail if the domain name or trigger message is not present, or deleting the e-mail if the domain name is present without the trigger message, or performing an authentication and passing the trigger-related e-mail message to the recipient if the domain name is present.

25. A method of sending a secure e-mail to a recipient comprising the steps of:
a) providing a secure e-mail proxy ahead of a recipient's mail client;
b) providing at least one server on a network, the server capable of sending a trigger e-mail and a trigger-related e-mail message;
c) receiving an e-mail message at the secure e-mail proxy;
d) using the secure e-mail proxy, checking to determine whether the e-mail message is a trigger e-mail from the server; and
i) if the e-mail message is a trigger e-mail, performing an authentication using the at least one server, deleting the trigger e-mail and passing the trigger related e-mail message using either a secure protocol or encryption to the recipient; or
ii) if the e-mail message is not a trigger e-mail, passing the e-mail message to the recipient.

26. The method of claim 25, wherein the trigger e-mail includes a link to allow the recipient to obtain the secure e-mail proxy for the checking step.

27. The method of claim 25, wherein e-mail messages received that are not trigger messages are grouped with trigger-related e-mail.

28. The method of claim 25, wherein a plurality of servers are provided, and the secure e-mail proxy is adapted to check e-mail messages from the plurality of servers.

29. The method of claim 25, wherein a gateway on the server is provided, the gateway checking e-mail messages being sent from the server to determine if an e-mail message has a predetermined condition, with the gateway passing the e-mail message to recipients if the predetermined condition is not met, or storing the e-mail message and creating the trigger related message if the predetermined condition is met, and allowing access by the recipient to the e-mail message upon authentication of the recipient's secure e-mail proxy.

30. The method of claim 29, wherein the predetermined condition is one of:
a) an e-mail message for a recipient that has the secure e-mail proxy;
b) an e-mail message that has a tag associated with it;
c) content of the e-mail message matches a template;
d) content of the e-mail message matches a fixed string; and
e) content of the e-mail message meets criteria established by a programmed analysis.

31. The method of claim 25, wherein a gateway associated with the secure e-mail proxy is provided, the gateway permitting a recipient to send a reply e-mail to the sender of the e-mail message in a secure manner.

32. The method of claim 31, wherein the secure e-mail proxy authenticates to the gateway servicing the secure e-mail proxy prior to sending the reply.

33. The method of claim 31, wherein the reply e-mail is encrypted by the secure e-mail proxy, and the gateway determines that the reply e-mail is from a recipient assigned a secure e-mail proxy and uses a decrypting key associated with the assigned secure e-mail proxy to read the reply e-mail.

34. The method of claim 31, wherein e-mail messages securely received by the recipient and/or securely sent by the recipient are displayed to the recipient and/or sender.

35. The method of claim 31, wherein the recipient sends a reply e-mail to a sender of the e-mail message, and the secure e-mail proxy, after determining that the sender is part of the service providing the secure e-mail proxy, encrypts the reply e-mail, the gateway decrypting the reply e-mail based on a decrypting key of the secure e-mail proxy of the recipient.

36. The method of claim 25, wherein the server comprises a mail server and a virtual server, the virtual server determining if the e-mail message should be either sent by the gateway or sent by the mail server.

37. The method of claim 29, wherein a trigger proxy is provided for a server, the trigger proxy determining if the e-mail message should be either sent to the gateway or sent to the mail server.

38. The method of claim 29, wherein the gateway receives outgoing e-mails, the gateway adapted to make and store a copy of the outgoing e-mail messages sent by a sender to a recipient, the gateway authorizing one or more users to view the copy of the outgoing e-mail message.

39. The method of claim 25, further comprising installing a number of secure e-mail proxies at different locations but maintaining the same view of e-mail messages from each of the installed secure e-mail proxies.

40. The method of claim 25, further comprising examining a record of the checking of e-mail messages and sending an encrypted trigger related e-mail message with the trigger e-mail based on the record examining step.

41. A system for sending secure e-mails to a recipient comprising a secure e-mail proxy disposed between a mail client and a mail server, the secure e-mail proxy adapted to check incoming e-mail messages for a trigger e-mail from a server, the secure e-mail proxy either accepting the e-mail message if the trigger e-mail is not present, or if the trigger e-mail is present, obtaining a trigger-related e-mail message from the server upon authentication.

42. A method of managing mailbox locations on a plurality of mailbox servers on a network, each mailbox server containing at least one mailbox, the method comprising the steps of:
a) determining a mailbox response profile for each mailbox, the response profile containing data related to the mailbox indicating a responsiveness of a mailbox from a mailbox user perspective;
b) determining an average resource profile for each mailbox server, the average resource profile containing data related to the mailbox server indicating the resource utilization of the mailbox server;
c) identifying a candidate mailbox and server for moving a mailbox based on a level of the mailbox response profile and average resource profile;
d) comparing the mailbox response profile and average resource profile of a candidate mailbox and server with the mailbox response profile and average resource profile of at least one other mailbox and server to determine if the other mailbox and server is best suited to receive the content of the candidate mailbox; and
e) transferring the content of the candidate mailbox to a recipient mailbox and server based on the comparing step.

43. The method of claim 42, wherein the candidate mailbox and server is compared to a threshold for the mailbox response and average resource profiles as part of the identifying step to determine whether to proceed with the comparing step.

44. The method of claim 43, wherein the comparing step further comprises receiving bids to accept the candidate mailbox from one or more of the mailboxes and servers, and accepting one bid for the transferring step based on the comparing step.

45. The method of claim 43, further comprising the step of retaining the content of the candidate mailbox on the candidate mailbox to provide a redundant source of the content.

46. The method of claim 43, wherein, after the transferring step is completed, the mailbox response profile and average resource profile of the candidate mailbox and its server is compared with the mailbox response profile and average resource profiles of the one other mailbox and its server to determine if the content of the recipient mailbox should be transferred back to the candidate mailbox.

47. The method of claim 43, wherein the identifying step is based on a candidate mailbox having overloaded resources or underutilized resources.

48. A system for moving mailboxes based on mailbox responsiveness and server resource utilization comprising:
a) a plurality of mailboxes, each mailbox located on a mail server;
b) one or more databases for storing a mailbox response profiles and server average resource profiles for each mailbox and mail server;
c) each server adapted to seek a bidder for a mailbox or to bid on a mailbox, the seeking or bidding based on the mailbox response profiles and server average resource profile of the server, and to transfer contents of a mailbox to another server or accept contents of a mailbox from another server.

49. The system of claim 48, further comprising a recipient-centric system for presenting a recipient's mailbox for viewing by a user other than the recipient, the recipient-centric system comprising a gateway in communication with a mail server and mail client, each servicing one or more senders of e-mails, the gateway adapted to make and store a copy of an outgoing e-mail message sent by a sender to a recipient on the gateway, the gateway authorizing one or more users to view the copy of the outgoing e-mail message.

50. The system of claim 49, further comprising an anti-phishing proxy disposed between a mail client and a mail server, the anti-phishing proxy adapted to check incoming e-mail messages for a domain name and a trigger message from a server for the domain name, the anti-phishing proxy either accepting the e-mail if the domain name or trigger message is not present, or deleting the e-mail if the domain name is present without the trigger message, or performing an authentication and passing the trigger-related e-mail message to the recipient if the domain name is present.

51. The system of claim 49, further comprising a secure e-mail proxy disposed between a mail client and a mail server, the secure e-mail proxy adapted to check incoming e-mail messages for a trigger e-mail from a server, the secure e-mail proxy either accepting the e-mail message if the trigger e-mail is not present, or if the trigger e-mail is present, obtaining a trigger-related e-mail message from the server upon authentication.
